(19) United States
(12) Patent Application Publication
(10) Pub. No.: US 2024/0329371 A1
(43) Pub. Date: Oct. 3, 2024

(54) IMAGING LENS AND IMAGING DEVICE

(71) Applicant: SONY SEMICONDUCTOR SOLUTIONS CORPORATION, Kanagawa (JP)

(72) Inventors: Kensuke Suzuki, Kanagawa (JP); Keiji Matsusaka, Kanagawa (JP)

(73) Assignee: SONY SEMICONDUCTOR SOLUTIONS CORPORATION, Kanagawa (JP)

(21) Appl. No.: 18/605,338

(22) Filed: Mar. 14, 2024

Related U.S. Application Data
(60) Provisional application No. 63/456,124, filed on Mar. 31, 2023.

(51) Int. Cl. G02B 13/18

(52) U.S. Cl. CPC G02B 13/18

(57) ABSTRACT

To curb deterioration in image quality due to ghost light caused by reflection. An imaging lens includes a lens group with at least one aspherical lens that forms an optical image of an object on an imaging surface curved concavely toward an object side. The lens surface closest to an imaging surface side in the lens group, is aspherical, and a sign of surface power is not inverted with increasing distance from an optical axis. The final surface tilts toward an object side with increasing distance from the optical axis. The imaging lens satisfies 0.1<BF/f<0.3 when a distance on the optical axis from a vertex on the optical axis of the final surface to a position of a maximum image height of the imaging surface is denoted by BF, and a focal length of the entire imaging lens is denoted by f.

### CROSS REFERENCE TO RELATED APPLICATIONS

This application claims the benefit of U.S. Provisional Patent Application Ser. No. 63/456,124, filed Mar. 31, 2023, the entire disclosure of which is hereby incorporated herein by reference.

### TECHNICAL FIELD

The present technology relates to an imaging lens and an imaging device, and more particularly to an imaging lens and an imaging device capable of curbing image quality deterioration of a captured image due to ghost light caused by reflection between a final surface of the imaging lens and a curved imaging surface.

### BACKGROUND ART

An imaging lens of a mobile terminal is required to improve lens performance. As a result, the number of lenses included in the imaging lens increases, and the height of the imaging lens tends to increase. Therefore, it has been devised to curb an increase in height of an imaging lens by frequently using aspherical lenses in the imaging lens.

As such an imaging lens, for example, there is an imaging lens having a five-lens configuration in which a shape of a final surface that is a surface on the imaging surface side of a lens closest to the imaging surface side is a gull shape, and the imaging surface is curved to tilt to an object side at any cross section toward a screen peripheral portion (see, for example, PTL 1). Note that the gull shape is a shape in which a central portion near the optical axis and a peripheral portion away from the optical axis have different curvatures, and the central portion has a concave shape. In a case where the shape of the final surface is a gull shape, the imaging lens has an effect of curbing, for example, off-axis aberration and chief ray angle (CRA).

### CITATION LIST

### Patent Literature

### PTL 1

WO 2013/027641 A

### SUMMARY

### Technical Problem

By curving an imaging surface, aberration correction can be more easily performed and lens performance can be improved. However, in a case where a shape of a final surface is a gull shape, ghost light caused by reflection between the final surface and the curved imaging surface becomes converging light. As a result, there is a possibility that the ghost light will be collected on the imaging surface with high intensity, and the image quality of a captured image will deteriorate.

Therefore, there is a demand for providing a method for curbing deterioration in the image quality of a captured image due to ghost light caused by reflection between the final surface of the imaging lens and the curved imaging surface, but such a demand has not been sufficiently met.

The present technology has been made in view of such circumstances, and it is desirable is to curb image quality deterioration of a captured image due to ghost light caused by reflection between a final surface of an imaging lens and a curved imaging surface.

### Solution to Problem

An imaging lens according to a first aspect of the present technology has a lens group including six or more lenses including at least one aspherical lens that forms an optical image of an object on an imaging surface curved concavely toward an object side, in which a final surface that is a surface on an imaging surface side of a final lens that is a lens closest to the imaging surface side in the lens group is a spherical surface or an aspherical surface in which a sign of surface power is not inverted with increasing distance from an optical axis, a shape of the final surface is a shape that tilts toward the object side with increasing distance from the optical axis, and, when a distance on the optical axis from a vertex on the optical axis of the final surface to a position of a maximum image height of the imaging surface is denoted by BF, and a focal length of the entire imaging lens is denoted by f, 0.1<BF/f<0.3 is satisfied.

According to the first aspect of the present technology, there is provided the lens group including six or more lenses including at least one aspherical lens that forms an optical image of an object on the imaging surface curved concavely on the object side. The final surface that is a surface on the imaging surface side of the final lens that is a lens closest to the imaging surface side in the lens group is a spherical surface or an aspherical surface in which a sign of surface power is not inverted with increasing distance from an optical axis, a shape of the final surface is a shape that tilts toward the object side with increasing distance from the optical axis, and, when a distance on the optical axis from a vertex on the optical axis of the final surface to a position of a maximum image height of the imaging surface is denoted by BF, and a focal length of the entire imaging lens is denoted by f, 0.1<BF/f<0.3 is satisfied.

An imaging device according to a second aspect of the present technology includes an imaging lens that has a lens group including six or more lenses including at least one aspherical lens that forms an optical image of an object on an imaging surface curved concavely toward an object side; and an imaging element that has the imaging surface and converts the optical image formed on the imaging surface into an electric signal, in which a final surface that is a surface on an imaging surface side of a final lens that is a lens closest to the imaging surface side in the lens group is a spherical surface or an aspherical surface in which a sign of surface power is not inverted with increasing distance from an optical axis, a shape of the final surface is a shape that tilts toward the object side with increasing distance from the optical axis, and, when a distance on the optical axis from a vertex on the optical axis of the final surface to a position of a maximum image height of the imaging surface is denoted by BF, and a focal length of the entire imaging lens is denoted by f, 0.1<BF/f<0.3 is satisfied.

According to the second aspect of the present technology, there is provided the imaging device including the imaging lens that has a lens group including six or more lenses including at least one aspherical lens that forms an optical image of an object on an imaging surface curved concavely toward an object side; and an imaging element that has the imaging surface and converts the optical image formed on the imaging surface into an electric signal, in which a final surface that is a surface on an imaging surface side of a final lens that is a lens closest to the imaging surface side in the lens group is a spherical surface or an aspherical surface in which a sign of surface power is not inverted with increasing distance from an optical axis, a shape of the final surface is a shape that tilts toward the object side with increasing distance from the optical axis, and, when a distance on the optical axis from a vertex on the optical axis of the final surface to a position of a maximum image height of the imaging surface is denoted by BF, and a focal length of the entire imaging lens is denoted by f, 0.1<BF/f<0.3 is satisfied.

### BRIEF DESCRIPTION OF DRAWINGS

FIG. 1 is a cross-sectional view illustrating an example of an imaging lens.

FIG. 2 is a diagram illustrating a configuration example of a first embodiment of an imaging device to which the present technology is applied.

FIG. 3 is a cross-sectional view illustrating a configuration example of the imaging lens in FIG. 2.

FIG. 4 is a table illustrating examples of various setting values of the entire imaging lens in FIG. 3.

FIG. 5 is a table illustrating examples of various setting values of a lens, an aperture stop, an infrared cut filter, and an imaging surface in FIG. 3.

FIG. 6 is a table illustrating an example of aspherical data of each surface of the lens in FIG. 3.

FIG. 7 is a graph illustrating examples of spherical aberration, field curvature, and distortion aberration generated in the imaging lens in FIG. 3.

FIG. 8 is a graph illustrating an example of lateral aberration generated in the imaging lens in FIG. 3.

FIG. 9 is a cross-sectional view illustrating a configuration example of an imaging lens in a second embodiment of an imaging device to which the present technology is applied.

FIG. 10 is a table illustrating examples of various setting values of the entire imaging lens in FIG. 9.

FIG. 11 is a table illustrating examples of various setting values of a lens, an aperture stop, an infrared cut filter, and an imaging surface in FIG. 9.

FIG. 12 is a table illustrating an example of aspherical data of each surface of the lens in FIG. 9.

FIG. 13 is a graph illustrating examples of spherical aberration, field curvature, and distortion aberration generated in the imaging lens in FIG. 9.

FIG. 14 is a graph illustrating an example of lateral aberration generated in the imaging lens in FIG. 9.

FIG. 15 is a cross-sectional view illustrating a configuration example of an imaging lens in a third embodiment of an imaging device to which the present technology is applied.

FIG. 16 is a table illustrating examples of various setting values of the entire imaging lens in FIG. 15.

FIG. 17 is a table illustrating examples of various setting values of a lens, an aperture stop, an infrared cut filter, and an imaging surface in FIG. 15.

FIG. 18 is a table illustrating an example of aspherical data of each surface of the lens in FIG. 15.

FIG. 19 is a graph illustrating examples of spherical aberration, field curvature, and distortion aberration generated in the imaging lens in FIG. 15.

FIG. 20 is a graph illustrating an example of lateral aberration generated in the imaging lens in FIG. 15.

FIG. 21 is a cross-sectional view illustrating a configuration example of an imaging lens in a fourth embodiment of an imaging device to which the present technology is applied.

FIG. 22 is a table illustrating examples of various setting values of the entire imaging lens in FIG. 21.

FIG. 23 is a table illustrating examples of various setting values of a lens, an aperture stop, an infrared cut filter, and an imaging surface in FIG. 21.

FIG. 24 is a table illustrating an example of aspherical data of each surface and an imaging surface of the lens in FIG. 21.

FIG. 25 is a graph illustrating examples of spherical aberration, field curvature, and distortion aberration generated in the imaging lens in FIG. 21.

FIG. 26 is a graph illustrating an example of lateral aberration generated in the imaging lens in FIG. 21.

FIG. 27 is a cross-sectional view illustrating a configuration example of an imaging lens in a fifth embodiment of an imaging device to which the present technology is applied.

FIG. 28 is a table illustrating examples of various setting values of the entire imaging lens in FIG. 27.

FIG. 29 is a table illustrating examples of various setting values of a lens, an aperture stop, an infrared cut filter, and an imaging surface in FIG. 27.

FIG. 30 is a table illustrating an example of aspherical data of each surface of the lens in FIG. 27.

FIG. 31 is a graph illustrating examples of spherical aberration, field curvature, and distortion aberration generated in the imaging lens in FIG. 27.

FIG. 32 is a graph illustrating an example of lateral aberration generated in the imaging lens in FIG. 27.

FIG. 33 is a cross-sectional view illustrating a configuration example of an imaging lens in a sixth embodiment of an imaging device to which the present technology is applied.

FIG. 34 is a table illustrating examples of various setting values of the entire imaging lens in FIG. 33.

FIG. 35 is a table illustrating examples of various setting values of a lens, an aperture stop, an infrared cut filter, and an imaging surface in FIG. 33.

FIG. 36 is a table illustrating an example of aspherical data of each surface of the lens in FIG. 33.

FIG. 37 is a graph illustrating examples of spherical aberration, field curvature, and distortion aberration generated in the imaging lens in FIG. 33.

FIG. 38 is a graph illustrating an example of lateral aberration generated in the imaging lens in FIG. 33.

FIG. 39 is a cross-sectional view illustrating a configuration example of an imaging lens in a seventh embodiment of an imaging device to which the present technology is applied.

FIG. 40 is a table illustrating examples of various setting values of the entire imaging lens in FIG. 39.

FIG. 41 is a table illustrating examples of various setting values of a lens, an aperture stop, an infrared cut filter, and an imaging surface in FIG. 39.

FIG. 42 is a table illustrating an example of aspherical data of each surface of the lens in FIG. 39.

FIG. 43 is a graph illustrating examples of spherical aberration, field curvature, and distortion aberration generated in the imaging lens in FIG. 39.

FIG. 44 is a graph illustrating an example of lateral aberration generated in the imaging lens in FIG. 39.

FIG. 45 is a cross-sectional view illustrating a configuration example of an imaging lens in an eighth embodiment of an imaging device to which the present technology is applied.

FIG. 46 is a table illustrating examples of various setting values of the entire imaging lens in FIG. 45.

FIG. 47 is a table illustrating examples of various setting values of a lens, an aperture stop, an infrared cut filter, and an imaging surface in FIG. 45.

FIG. 48 is a table illustrating an example of aspherical data of each surface and an imaging surface of the lens in FIG. 45.

FIG. 49 is a graph illustrating examples of spherical aberration, field curvature, and distortion aberration generated in the imaging lens in FIG. 45.

FIG. 50 is a graph illustrating an example of lateral aberration generated in the imaging lens in FIG. 45.

FIG. 51 is a table illustrating values of various parameters in the imaging lens.

FIG. 52 is a block diagram illustrating a hardware configuration example of a smartphone as an electronic apparatus to which the present technology is applied.

FIG. 53 is a diagram illustrating a usage example of the imaging device.

FIG. 54 is a diagram illustrating an example of a schematic configuration of an endoscopic surgery system.

FIG. 55 is a block diagram illustrating an example of a functional configuration of a camera head and a CCU.

FIG. 56 is a block diagram illustrating an example of a schematic configuration of a vehicle control system.

FIG. 57 is an explanatory diagram illustrating an example of an installation position of an imaging section.

### DESCRIPTION OF EMBODIMENTS

Hereinafter, modes for carrying out the present technology (hereinafter, referred to as embodiments) will be described. Note that the description will be made in the following order.
0. Example of imaging lens
1. First embodiment (imaging device including seven lenses)
2. Second embodiment (imaging device including seven lenses)
3. Third embodiment (imaging device including seven lenses)
4. Fourth embodiment (imaging device including seven lenses)
5. Fifth embodiment (imaging device including six lenses)
6. Sixth embodiment (imaging device including seven lenses)
7. Seventh embodiment (imaging device including seven lenses)
8. Eighth embodiment (imaging device including seven lenses)
9. Parameter
10. Application example to electronic apparatus
11. Usage example of imaging device
12. Application example to endoscopic surgery system
13. Application example to mobile object

Note that in the drawings referred to in the following description, the same or similar parts are denoted by the same or similar reference numerals. However, the drawings are schematic, and the relationship between the thickness and the planar dimension, the ratio of the thickness of each layer, and the like are different from the actual ones. Furthermore, the drawings may include portions having different dimensional relationships and ratios.

Furthermore, definitions of directions such as up and down in the following description are merely definitions for convenience of description, and do not limit the technical idea of the present disclosure. For example, when an object is observed by rotating the object by 90°, the upper and lower sides are read by converting into left and right, and when an object is observed by rotating the object by 180°, the upper and lower sides are read by inverting.

### 0. Example of Imaging Lens

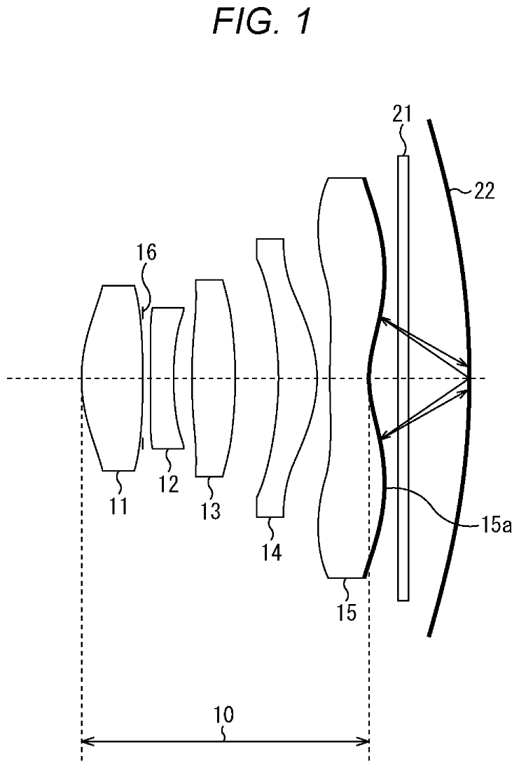

FIG. 1 is a cross-sectional view illustrating an example of an imaging lens.

An imaging lens 10 in FIG. 1 includes five lenses 11 to 15 and an aperture stop 16. The five lenses 11 to 15 are disposed in order from an object side toward an imaging surface side, and the aperture stop 16 is disposed between the lenses 11 and 12. A shape of a surface 15a of the lens 15 on the imaging surface side closest to the imaging surface side is a gull shape.

The imaging lens 10 collects light incident from an object (subject) and forms an optical image of the object on an imaging surface 22 of an imaging element via an infrared cut filter 21. The imaging surface 22 is curved concavely toward the object side to incline (tilt) toward the object side from the optical axis center toward the peripheral portion.

As described above, in a case where the shape of the surface 15a is a gull shape and the imaging surface 22 is curved concavely toward the object side, ghost light caused by reflection between the surface 15a and the imaging surface 22 becomes converging light. As a result, there is a possibility that the ghost light will be collected on the imaging surface 22 with high intensity, and the image quality of a captured image will deteriorate.

Therefore, the imaging lens to which the present technology is applied diverges the ghost light by making the final surface a spherical surface or an aspherical surface in which a sign of the surface power is not inverted with increasing distance from the optical axis and that has a shape tilting toward the object side with increasing distance from the optical axis. As a result, the intensity of the ghost light can be curbed. Note that, the aspherical surface in which the sign of the surface power is not inverted with increasing distance from the optical axis is an aspherical surface in which a sign of a first derivative value (gradient of the surface shape) is not inverted, that is, an aspherical surface having no folding.

### 1. First Embodiment

### <Configuration Example of Imaging Device>

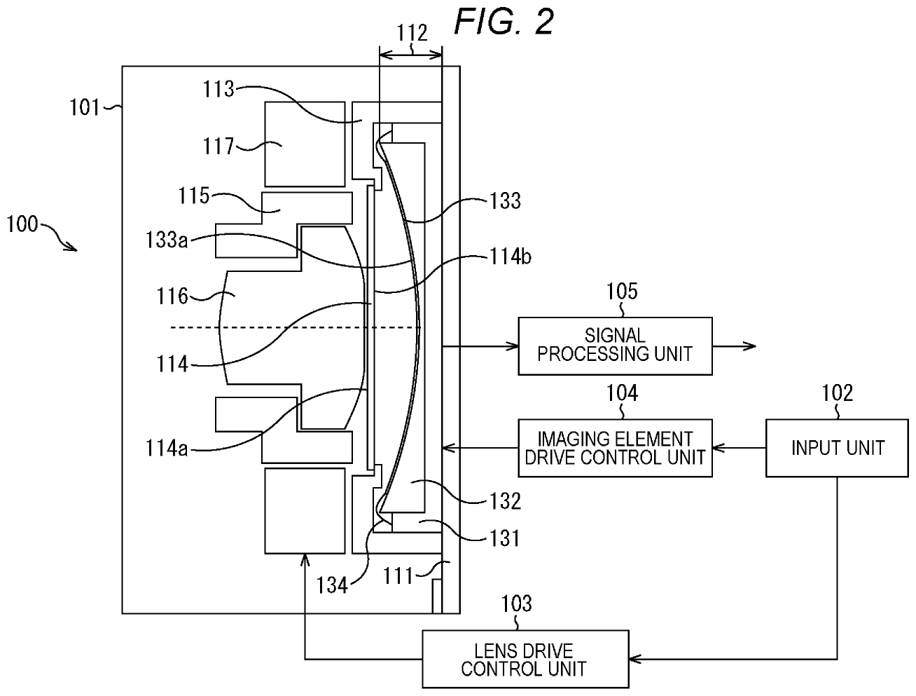

FIG. 2 is a diagram illustrating a configuration example of a first embodiment of an imaging device to which the present technology is applied.

An imaging device 100 in FIG. 2 includes an imaging section 101, an input unit 102, a lens drive control unit 103, an imaging element drive control unit 104, and a signal processing unit 105. In FIG. 2, in order to describe a configuration of the imaging section 101, a side cross section including an optical axis of the imaging section 101 is illustrated. A dotted line in FIG. 2 is the optical axis.

The imaging section 101 includes a circuit board 111, an imaging element portion 112, a filter holder 113, an infrared cut filter 114, a lens holder 115, an imaging lens 116, and an actuator 117.

The circuit board 111 is a flexible printed board. The imaging element portion 112 is provided on the circuit board 111. The imaging element portion 112 includes a circuit board 131, a pedestal 132, an imaging element 133, and a wire 134.

The circuit board 131 is provided on the circuit board 111 and is electrically connected to the circuit board 111. The pedestal 132 is provided on the circuit board 131 in order to hold the shape of the imaging element 133 in a concave shape curved toward the object side. A surface of the pedestal 132 on the object side is curved concavely toward the object side in accordance with the shape of the imaging element 133. The imaging element 133 is bonded to the surface of the pedestal 132 on the object side. Therefore, both the surface on the object side and the surface on the pedestal 132 side of the imaging element 133 are curved concavely toward the object side.

The imaging element 133 is a charge-coupled device (CCD) sensor or a complementary metal oxide semiconductor (CMOS) image sensor, and captures an image of an object.

Specifically, an imaging surface 133a is provided on the object-side surface of the imaging element 133.

Therefore, the imaging surface 133a is curved concavely toward the object side, that is, to tilt to the object side from the optical center at any position. On the imaging surface 133a, an optical image of an object is formed by light incident from the object via the imaging lens 116. On the imaging surface 133a, for example, a pixel array portion including a plurality of pixels arranged in a two-dimensional lattice shape is formed.

In the pixel array portion, a photoelectric converter of each pixel converts light received by the pixel into an electric signal, and thus the optical image of the object is converted into the electric signal. This electric signal is read in units of pixels, and an AD converter of the imaging element 133 performs AD conversion or the like on the electric signal of each pixel to generate an image signal that is a digital signal.

The imaging element 133 is electrically connected to the circuit board 131 according to wire bonding using the wire 134. The image signal generated by the imaging element 133 is supplied to the signal processing unit 105 via the circuit board 131, the circuit board 111, and the like. The imaging element 133 is driven on the basis of an imaging element drive control signal supplied from the imaging element drive control unit 104 via the circuit board 111, the circuit board 131, and the like.

The filter holder 113 is formed to surround the periphery of the imaging element portion 112, and holds the infrared cut filter 114. The filter holder 113 fixes the actuator 117.

The infrared cut filter 114 is a parallel flat filter having a surface 114a on the object side and a surface 114b on the imaging surface 133a side. The infrared cut filter 114 transmits light other than infrared light among pieces of light emitted from the imaging lens 116 and does not have optical power. The light transmitted through the infrared cut filter 114 is emitted to the imaging surface 133a.

Note that the infrared cut filter 114 may not be provided, or a band pass filter or the like may be provided instead of the infrared cut filter 114. A position of the infrared cut filter 114 may be set to any position that can be easily formed at the time of manufacturing.

The infrared cut filter 114 may be integrated with the lens or the imaging element 133 by performing multi-layer coating, addition, or surface application of an infrared absorbent or the like on the lens configuring the imaging lens 116 or the imaging element 133. The infrared cut filter 114 has a film shape, and may be integrated with a lens configuring the imaging lens 116 or the imaging element 133 by being bonded to the lens or the imaging element 133. In a case where the infrared cut filter 114 is integrated with the lens or the imaging element 133, it is possible to effectively utilize a back focus space or to shorten the overall optical length of the imaging lens 116.

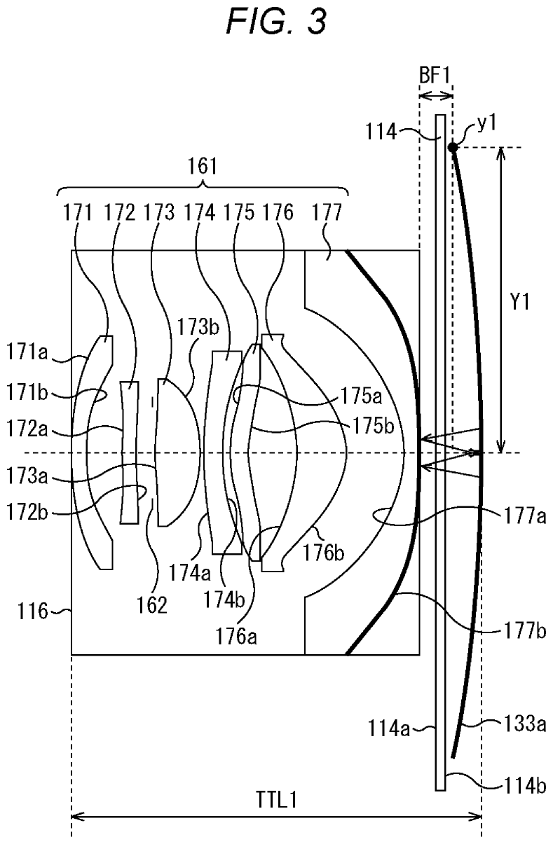

The lens holder 115 holds the imaging lens 116. The configuration of the imaging lens 116 will be described in detail with reference to FIG. 3 that will be described later. The imaging lens 116 collects light from an object and forms an optical image on the imaging surface 133a. The actuator 117 drives a predetermined lens included in the imaging lens 116 in accordance with a lens drive control signal supplied from the lens drive control unit 103.

In the imaging section 101 configured as described above, light from an object enters the imaging surface 133a via the imaging lens 116 and the infrared cut filter 114, and an optical image is formed on the imaging surface 133a.

This optical image is converted into an electric signal by the imaging element 133 and captured.

The input unit 102 receives an input from a user or the like, and supplies an instruction corresponding to the input to the lens drive control unit 103 and the imaging element drive control unit 104.

The lens drive control unit 103 generates a lens drive control signal in response to an instruction from the input unit 102 and supplies the lens drive control signal to the actuator 117 to drive a predetermined lens included in the imaging lens 116. For example, the lens drive control unit 103 generates a lens drive control signal in response to an instruction for an angle of view or the like supplied from the input unit 102, thereby driving a predetermined lens included in the imaging lens 116 such that an optical image at the angle of view is formed on the imaging surface 133a.

The imaging element drive control unit 104 generates an imaging element drive control signal in response to an instruction from the input unit 102 and supplies the imaging element drive control signal to the imaging element 133 to drive the imaging element 133. For example, the imaging element drive control unit 104 generates an imaging element drive control signal in response to an imaging start instruction or the like supplied from the input unit 102, and supplies the imaging element drive control signal to the imaging element 133 to start reading of the electric signal.

The signal processing unit 105 stores the image signal output from the imaging element 133 in a built-in memory as necessary. The signal processing unit 105 performs signal processing such as various types of image processing on the image signal and outputs the image signal as a captured image.

The input unit 102, the lens drive control unit 103, the imaging element drive control unit 104, and the signal processing unit 105 may be disposed on the circuit board 111 or the circuit board 131, or may be disposed on another board. A substrate of the signal processing unit 105 and a semiconductor substrate configuring the imaging element 133 may be stacked.

In the example in FIG. 2, the circuit board 131 and the imaging element 133 are electrically connected according to wire bonding, but may be electrically connected via a through-electrode.

### <Configuration Example of Imaging Lens>

FIG. 3 is a cross-sectional view illustrating a configuration example of the imaging lens 116.

The imaging lens 116 in FIG. 3 includes a lens group 161 having optical power and an aperture stop 162.

The lens group 161 includes lenses 171 to 177, which are seven aspherical lenses The seven lenses 171 to 177 are disposed in order from the object side (left side in FIG. 3) toward the imaging surface 133a side (right side in FIG. 3). The lens 171 has a surface 171a on the object side and a surface 171b on the imaging surface 133a side. Similarly to the lens 171, the lenses 172 to 177 also have surfaces 172a and 172b, surfaces 173a and 173b, surfaces 174a and 174b, surfaces 175a and 175b, surfaces 176a and 176b, and surfaces 177a and 177b, respectively. The surfaces 171a to 177a and 171b to 176b are aspherical surfaces. The surface 177b (final surface) on the imaging surface 133a side of the lens 177 closest to the imaging surface 133a among the lenses 171 to 177 is an aspherical surface in which a sign of surface power is not inverted with increasing distance from the optical axis, and has a shape that tilts toward the object side with increasing distance from the optical axis. The aperture stop 162 is disposed between the lenses 172 and 173, and limits light incident to the lens 173 from the lens 172.

The light incident to the imaging lens 116 from the object is emitted via the lenses 171 to 177 and the infrared cut filter 114, and is collected on the imaging surface 133a.

Note that, hereinafter, the overall optical length of the imaging lens 116, which is a distance on the optical axis from the surface 171a (foremost surface) closest to the object side of the lens 171 closest to the object side among the lenses 171 to 177 to the imaging surface 133a, will be referred to as TTL1. A distance on the optical axis from a vertex on the optical axis of the surface 177b to a position y1 of the maximum image height Y1 of the imaging surface 133a, that is, a back focus of the imaging lens 116, will be referred to as BF1.

### <Example of Various Setting Values of Entire Imaging Lens>

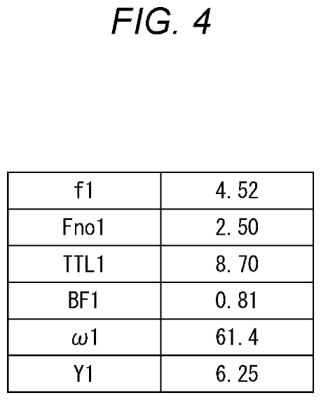

FIG. 4 is a table illustrating examples of various setting values of the entire imaging lens 116.

As illustrated in FIG. 4, a focal length f1 of the entire imaging lens 116 is 4.52 mm. An F value Fno1 of the imaging lens 116 is 2.50 and is 2.5 or less. The overall optical length TTL1 is 8.70 mm, and the back focus BF1 is 0.81 mm. A maximum half angle of view ω1, which is a half value of the maximum angle of view of the imaging lens 116, is 61.4 degrees. That is, the maximum angle of view 2ω1 of the imaging lens 116 is 122.8 degrees and is 90 degrees or more. The maximum image height Y1 is 6.25 mm.

### <Examples of Various Setting Values of Each Lens, Aperture Stop, Imaging Surface, and Infrared Cut Filter>

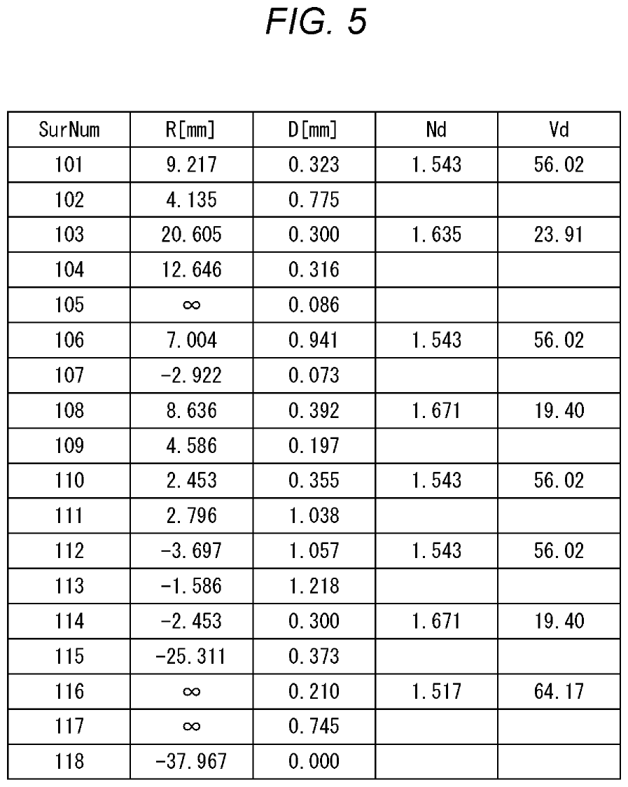

FIG. 5 is a table illustrating examples of various setting values of the lenses 171 to 177, the aperture stop 162, the infrared cut filter 114, and the imaging surface 133a.

The second and subsequent rows from the top in the table of FIG. 5 correspond to the surfaces 171a to 177a and the surfaces 171b to 177b, the surface of the aperture stop 162, the surfaces 114a and 114b, and the imaging surface 133a, respectively. Each column corresponds to, in order from the left, a surface number SurNum, a curvature radius R [mm] of the center of the surface, a surface interval D [mm] which is an interval on the optical axis with the surface of the next surface number SurNum+1, a refractive index Nd with respect to the d line (wavelength 587.6 nm), and an Abbe number Vd at the d line.

The surface number SurNum is a number assigned to each surface of the imaging lens 116. In the present specification, it is assumed that surface numbers from 101 to 104 are sequentially assigned to the surfaces 171a, 171b, 172a, and 172b. It is assumed that surface numbers from 105 to 118 are sequentially assigned to the surface of the aperture stop 162, the surfaces 173a, 173b, 174a, 174b, 175a, 175b, 176a, 176b, 177a, 177b, 114a, and 114b, and the imaging surface 133a.

As illustrated in FIG. 5, the curvature radius R of the surface 171a having the surface number SurNum of 101 is 9.217, and the surface interval D with the surface 171b having the surface number SurNum of 102 is 0.323. The refractive index Nd of the surface 171a is 1.543, and the Abbe number Vd is 56.02. The curvature radius R of the surface 171b having the surface number SurNum of 102 is 4.135, and the surface interval D with the surface of the surface 172a having the surface number SurNum of 103 is 0.775.

Note that, although not described, the curvature radius R, the surface interval D, the refractive index Nd, and the Abbe number Vd of each of the surfaces 172a to 177a are respective values illustrated in the table of FIG. 5.

The curvature radius R and the surface interval D of each of the surfaces 172b to 177b are values illustrated in the table of FIG. 5.

Since the surface of the aperture stop 162 and the surfaces 114a and 114b are planar, the curvature radius R corresponding to the surface numbers SurNum of 105, 116, and 117 is infinite. Note that, although not described, the surface interval D between the surface of the aperture stop 162 and the surface 114b, and the surface interval D, the refractive index Nd, and the Abbe number Vd of the surface 114a are respective values illustrated in the table of FIG. 5.

The curvature radius R of the imaging surface 133a having the surface number SurNum of 118 is −37.967. Since there is no surface to which the surface number SurNum of 119 is assigned after 118, the surface interval D is 0.

### <Example of Aspherical Data of Each Surface of Lens>

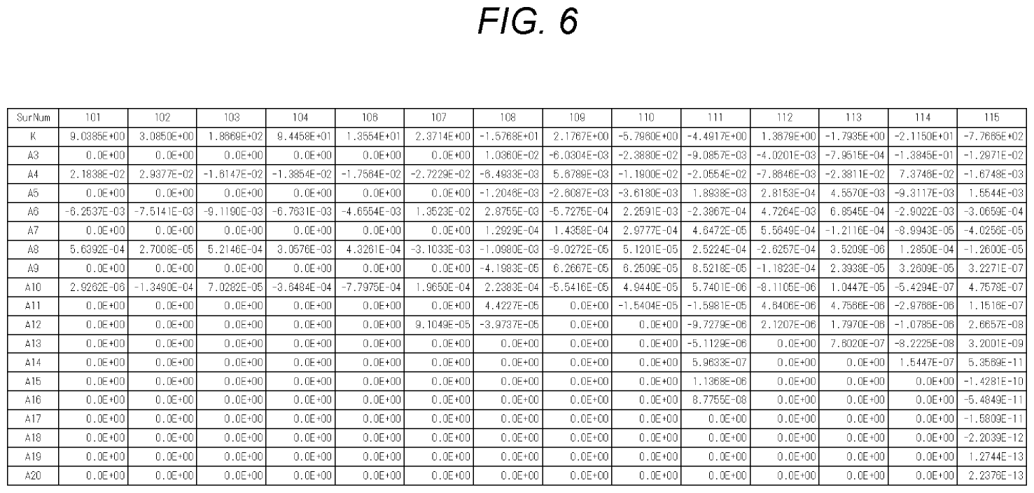

FIG. 6 is a table illustrating an example of aspherical data of the surfaces 171a to 177a and the surfaces 171b to 177b.

Each row in the table of FIG. 6 corresponds to the surface number SurNum, a conic coefficient K, and a third-order aspherical coefficient A3 to a 20th-order aspherical coefficient A20. The respective columns correspond to the surfaces 171a, 171b, 172a, 172b, 173a, 173b, 174a, 174b, 175a, 175b, 176a, 176b, 177a, and 177b in order from the second from the left.

Note that the conic coefficient K and the nth-order aspherical coefficient An are coefficients used when the sag amount of the aspherical surface expressed by the following Expression (a) is obtained.

### [Math. 1]

In Expression (a), z is a sag amount in a direction parallel to the optical axis, r is a distance in the radial direction, and c is a curvature, that is, a reciprocal of the curvature radius R. K is a conic coefficient (conic constant), and An is a coefficient of rⁿ, that is, an nth-order aspherical coefficient. n is an integer of 1 or more and 30 or less.

As illustrated in FIG. 6, the conic coefficient K of the surface 171a having surface number SurNum of 101 is 9.0385. The third-order aspherical coefficient A3 to the tenth-order aspherical coefficient A10 are 0, 2.1838×10⁻², 0, −6.2537×10⁻³, 0, 5.6392×10⁻⁴, 0, and 2.9262×10⁻⁶, respectively. The 11th-order aspherical coefficient A11 to the 20th-order aspherical coefficient A20 are all 0.

Note that, although not described, the conic coefficient K and the third-order aspherical coefficient A3 to the 20th-order aspherical coefficient A20 of each of the surfaces 172a to 177a and the surfaces 171b to 177b are values illustrated in the table of FIG. 6.

### <Examples of Spherical Aberration, Field Curvature, and Distortion Aberration>

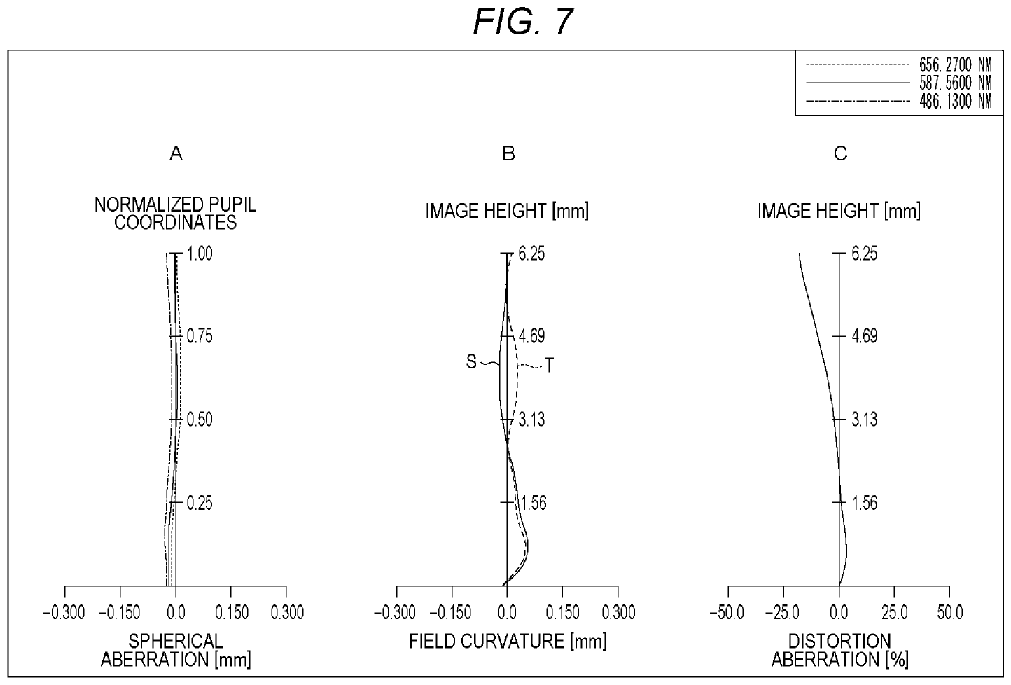

FIG. 7 is a graph illustrating an example of spherical aberration, field curvature, and distortion aberration generated in the imaging lens 116.

A of FIG. 7 is a graph illustrating spherical aberration for each wavelength of light having wavelengths of 486.1300 nm, 587.5600 nm, and 656.2700 nm, generated in the imaging lens 116. In the graph A of FIG. 7, the horizontal axis represents spherical aberration [mm], and the vertical axis represents normalized pupil coordinates that are a ratio of a distance from the optical axis to a pupil diameter at an incident position of a light beam.

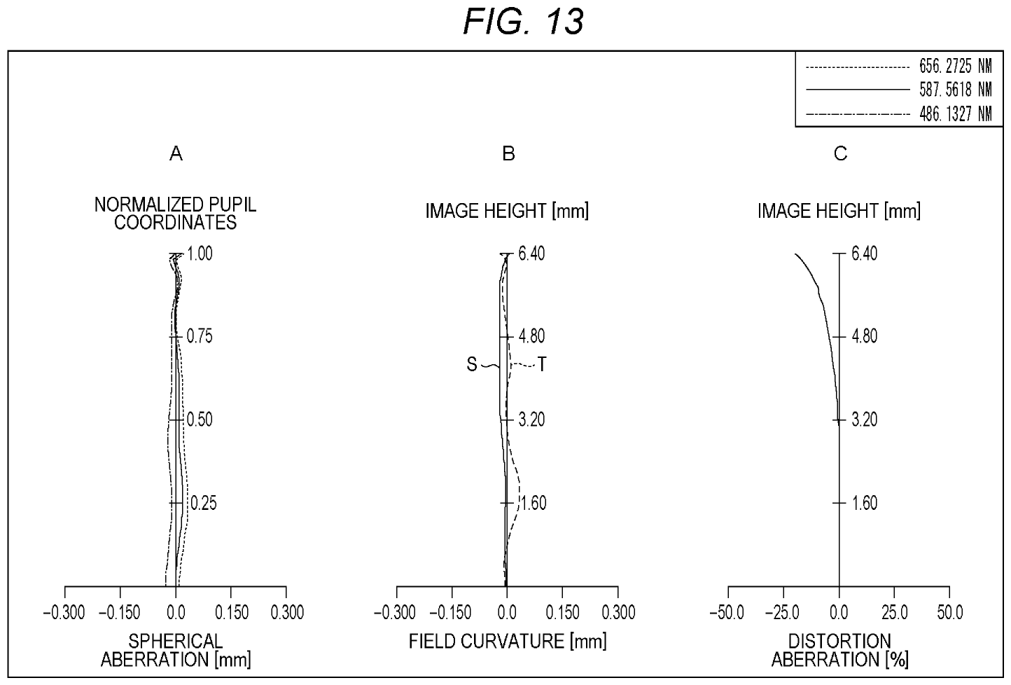

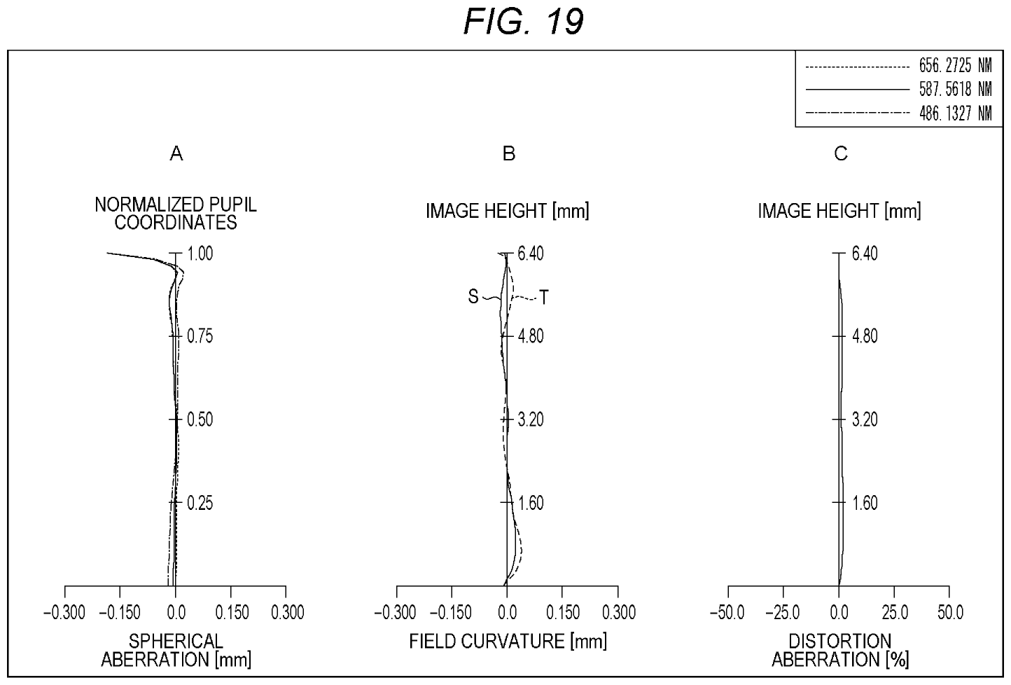

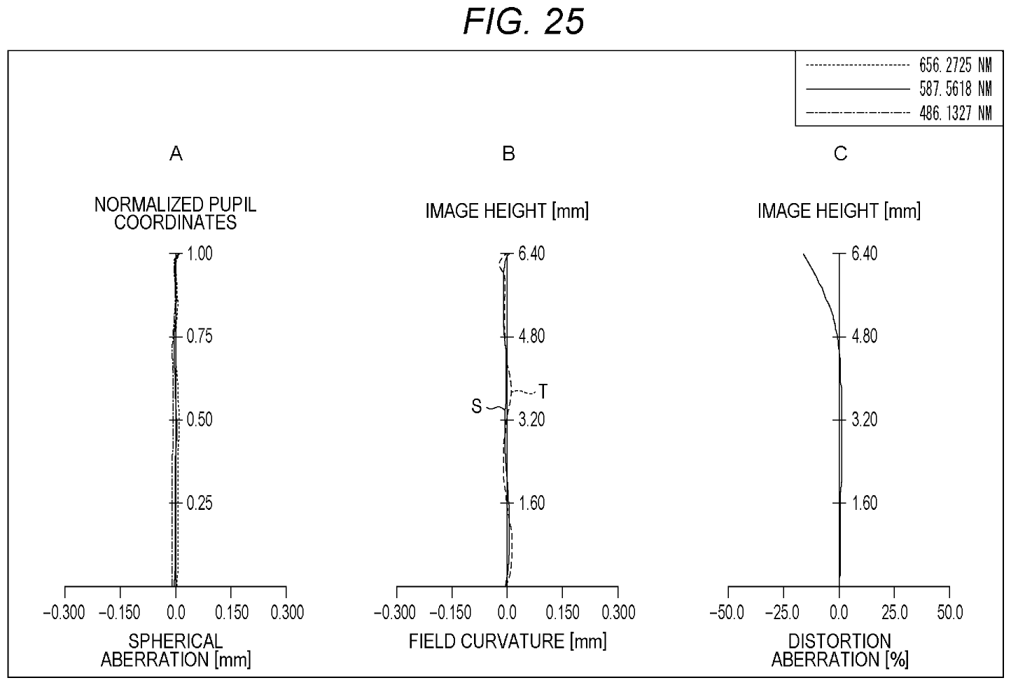

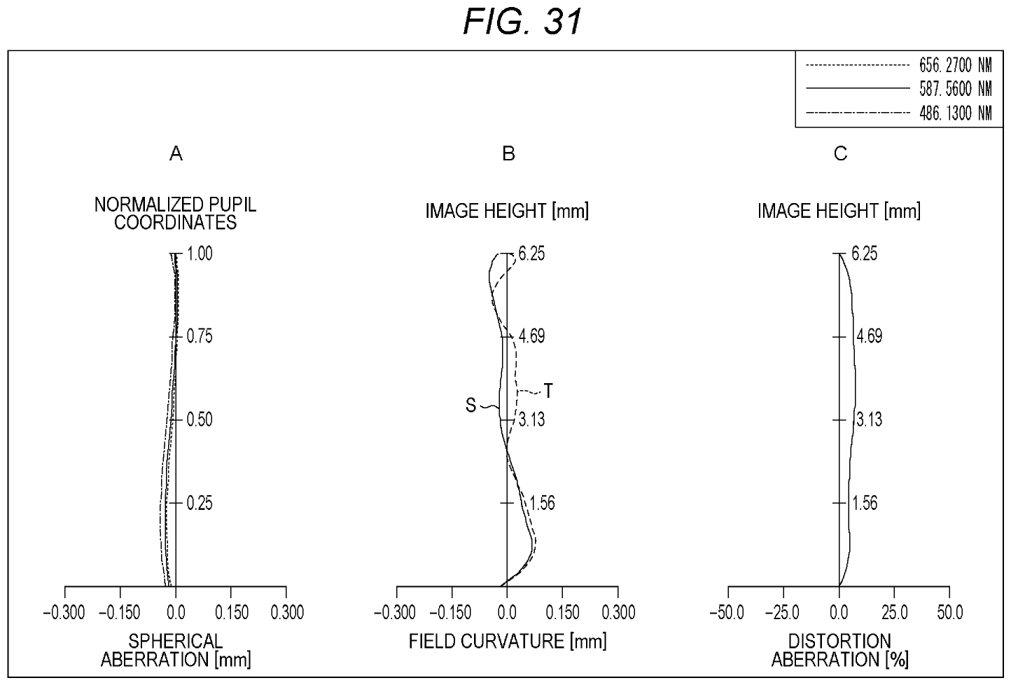

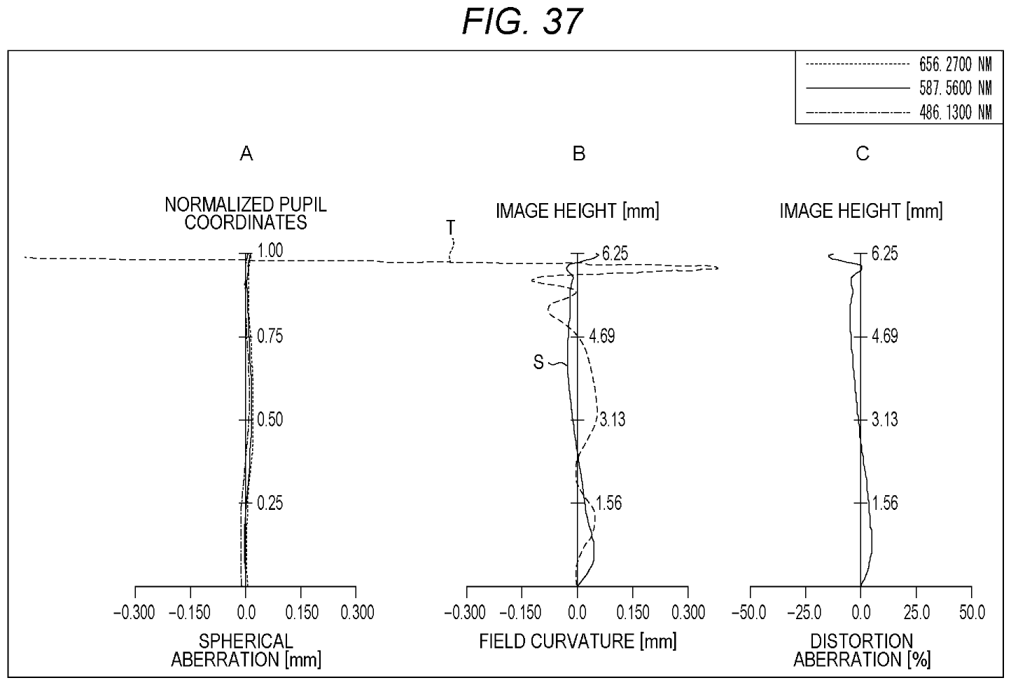

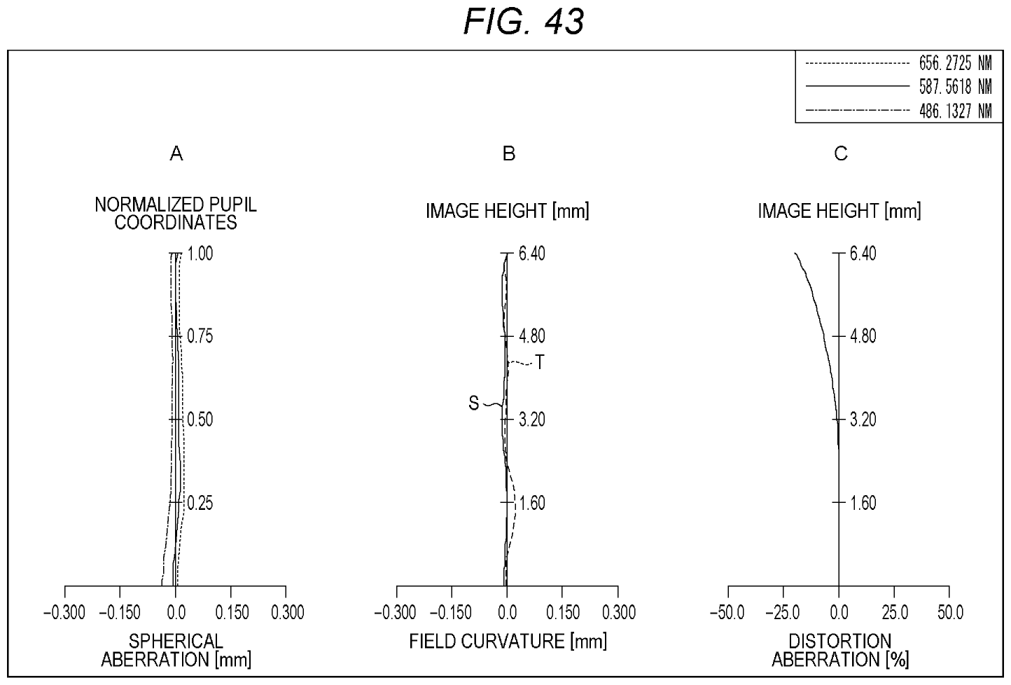

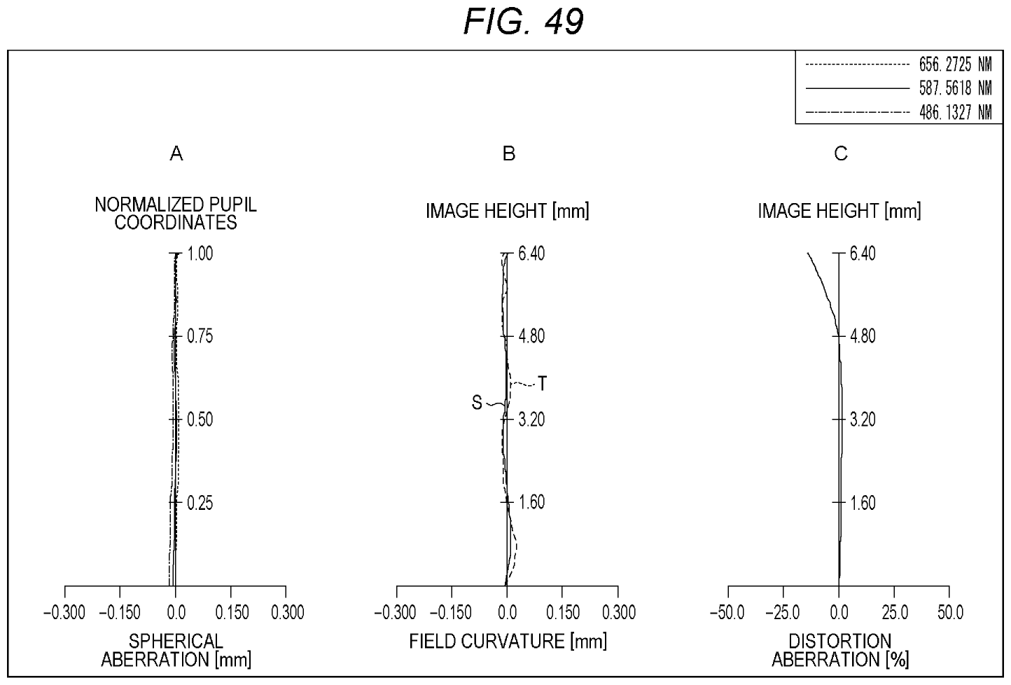

The same applies to A of FIG. 13, A of FIG. 19, A of FIG. 25, A of FIG. 31, A of FIG. 37, A of FIG. 43, and A of FIG. 49 that will be described later.

B of FIG. 7 is a graph illustrating a field curvature of light having the wavelength of 587.5600 nm, generated in the imaging lens 116. In the graph B of FIG. 7, the horizontal axis represents a field curvature [mm] in the sagittal direction or the tangential direction, and the vertical axis represents an image height [mm]. In B of FIG. 7, a solid line represents a relationship between the field curvature and the image height in the tangential direction, and a dotted line represents a relationship between the field curvature and the image height in the sagittal direction. The same applies to B of FIG. 13, B of FIG. 19, B of FIG. 25, B of FIG. 31, B of FIG. 37, B of FIG. 43, and B of FIG. 49 that will be described later.

C of FIG. 7 is a graph illustrating distortion aberration of light having the wavelength of 587.5600 nm, generated in the imaging lens 116. In the graph C of FIG. 7, the horizontal axis represents distortion aberration [%], and the vertical axis represents an image height [mm]. The same applies to C of FIG. 13, C of FIG. 19, C of FIG. 25, C of FIG. 31, C of FIG. 37, C of FIG. 43, and C of FIG. 49 that will be described later.

### <Example of Lateral Aberration>

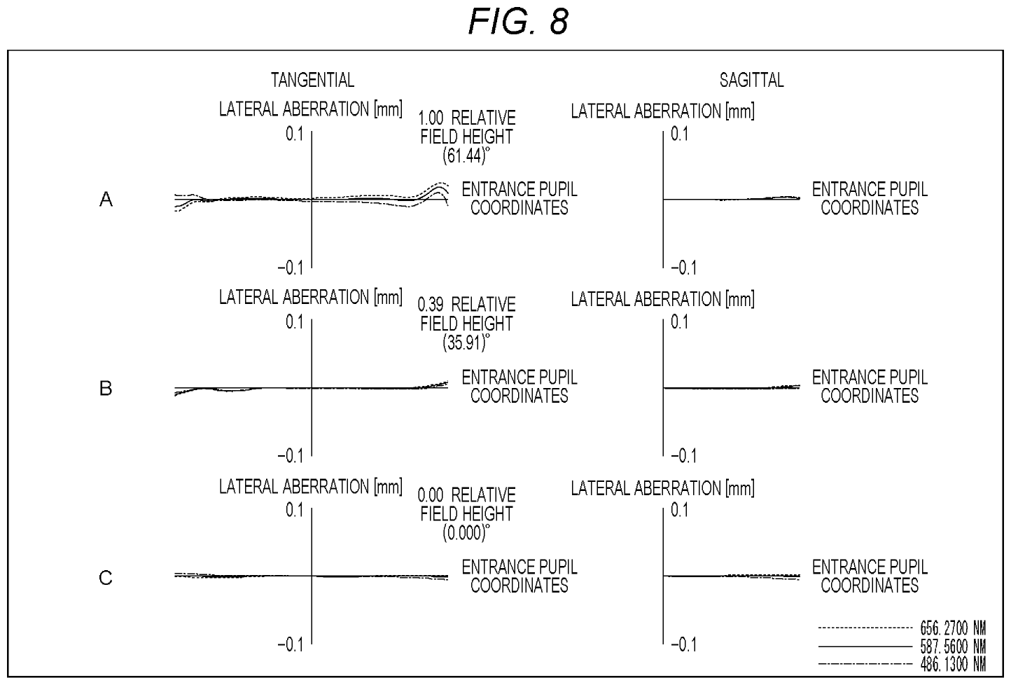

FIG. 8 is a graph illustrating an example of lateral aberration generated in the imaging lens 116.

FIG. 8 is a graph illustrating lateral aberration for each wavelength of light having wavelengths of 486.1300 nm, 587.5600 nm, and 656.2700 nm, generated in the imaging lens 116.

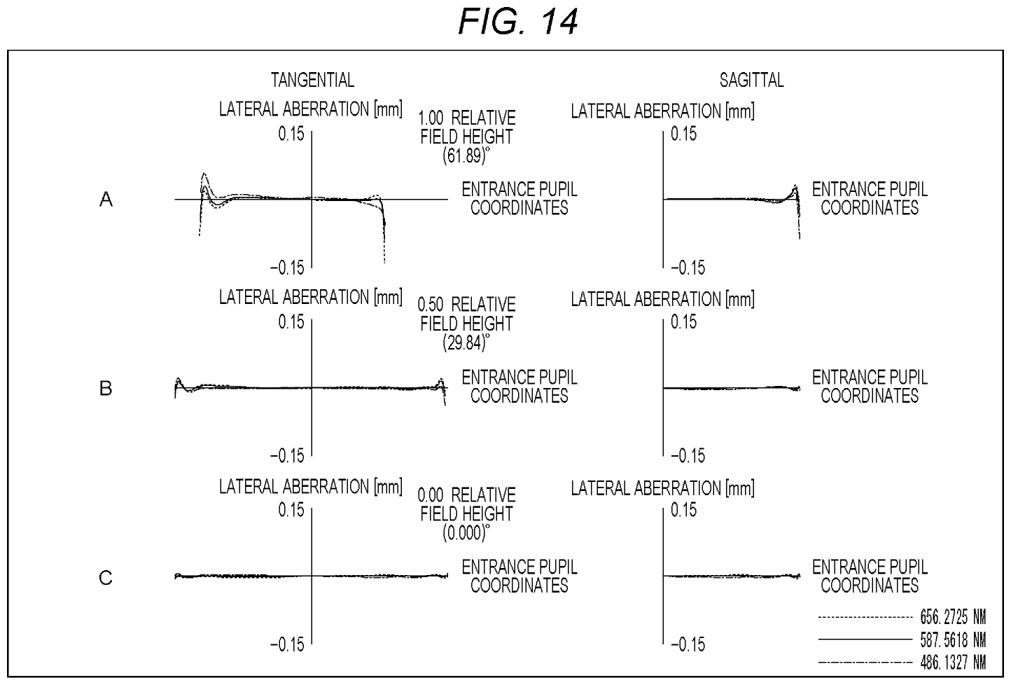

Specifically, the graphs on the left side in A to C of FIG. 8 represent the lateral aberration in the tangential direction at positions (positions of image heights in a case where half angles of view are 61.44°, 35.91°, and) 0° where the image heights are 1.00 mm, 0.39 mm, and 0.00 mm, respectively. The graphs on the right side in A to C of FIG. 8 represent the lateral aberration in the sagittal direction at the positions where the image heights are 1.00 mm, 0.39 mm, and 0.00 mm, respectively. In the graphs A to C of FIG. 8, the vertical axis represents the lateral aberration [mm], and the horizontal axis represents entrance pupil coordinates which are coordinates representing a position of an incident light beam in the direction perpendicular to the optical axis with the optical axis set to 0 as a ratio to the pupil diameter. The same applies to A to C of FIGS. 14, 20, 26, 32, 38, 44, and 50 that will be described later.

As illustrated in FIGS. 7 and 8, favorable aberration correction is performed in the imaging lens 116, and thus the imaging lens 116 has high imaging quality.

### 2. Second Embodiment

### <Configuration Example of Imaging Lens>

A second embodiment of an imaging device to which the present technology is applied is different from the imaging device 100 in FIG. 2 in terms of an imaging lens and an imaging surface, and the other configurations are similar to those of the imaging device 100. Therefore, the following description focuses on the imaging lens and the imaging surface.

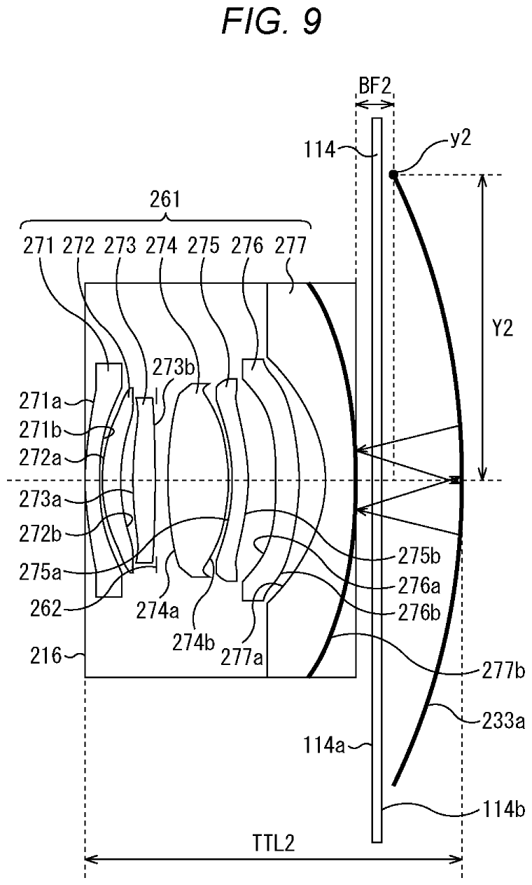

FIG. 9 is a cross-sectional view illustrating a configuration example of an imaging lens in a second embodiment of an imaging device to which the present technology is applied.

An imaging lens 216 in FIG. 9 includes a lens group 261 and an aperture stop 262.

The lens group 261 includes seven aspherical lenses 271 to 277. The seven lenses 271 to 277 are disposed in order from the object side toward the imaging surface 233a side. The lens 271 has a surface 271a on the object side and a surface 271b on the imaging surface 233a side. Similarly to the lens 271, the lenses 272 to 277 also have surfaces 272a and 272b, surfaces 273a and 273b, surfaces 274a and 274b, surfaces 275a and 275b, surfaces 276a and 276b, and surfaces 277a and 277b, respectively. The surfaces 271a to 277a and 271b to 277b are aspherical surfaces. The surface 277b (final surface) on the imaging surface 233a side of the lens 277 closest to the imaging surface 233a among the lenses 271 to 277 is an aspherical surface in which a sign of surface power is not inverted with increasing distance from the optical axis, and has a shape that tilts toward the object side with increasing distance from the optical axis. The aperture stop 262 is disposed between the lenses 273 and 274, and limits light incident to the lens 274 from the lens 273. Similarly to the imaging surface 133a, the imaging surface 233a is curved concavely toward the object side.

The light incident to the imaging lens 216 from an object is emitted via the lenses 271 to 277 and the infrared cut filter 114, and is collected on the imaging surface 233a.

Note that, hereinafter, the overall optical length of the imaging lens 216, which is a distance on the optical axis from the surface 271a (foremost surface) closest to the object side of the lens 271 closest to the object side among the lenses 271 to 277 to the imaging surface 233a, will be referred to as TTL2. A distance on the optical axis from a vertex on the optical axis of the surface 277b to a position y2 of the maximum image height Y2 of the imaging surface 233a, that is, a back focus of the imaging lens 216, will be referred to as BF2.

### <Example of Various Setting Values of Entire Imaging Lens>

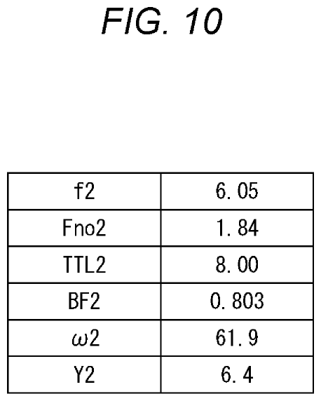

FIG. 10 is a table illustrating examples of various setting values of the entire imaging lens 216.

As illustrated in FIG. 10, a focal length f2 of the entire imaging lens 216 is 6.05 mm. An F value Fno2 of the imaging lens 216 is 1.84 and is 2.5 or less. The overall optical length TTL2 is 8.00 mm and the back focus BF2 is 0.803 mm. A maximum half angle of view ω2 of the imaging lens 216 is 61.9 degrees. That is, the maximum angle of view 2ω2 of the imaging lens 216 is 123.8 degrees and is 90 degrees or more. The maximum image height Y2 is 6.4 mm.

### <Examples of Various Setting Values of Each Lens, Aperture Stop, Imaging Surface, and Infrared Cut Filter>

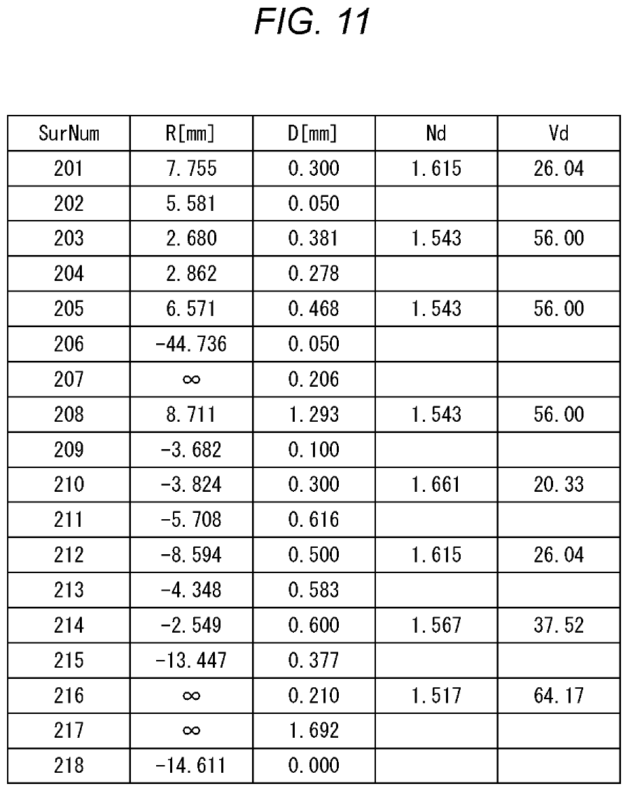

FIG. 11 is a table illustrating examples of various setting values of the lenses 271 to 277, the aperture stop 262, the infrared cut filter 114, and the imaging surface 233a.

The second and subsequent rows from the top in the table of FIG. 11 correspond to the surfaces 271a to 277a and the surfaces 271b to 277b, the surface of the aperture stop 262, the surfaces 114a and 114b, and the imaging surface 233a, respectively. The respective columns are similar to the columns in FIG. 5.

In the present specification, it is assumed that surface numbers from 201 to 206 are sequentially assigned to the surfaces 271a, 271b, 272a, 272b, 273a, and 273b. It is assumed that surface numbers from 207 to 218 are sequentially assigned to the surface of the aperture stop 262, the surfaces 274a, 274b, 275a, 275b, 276a, 276b, 277a, 277b, 114a, and 114b, and the imaging surface 233a.

Note that, although not described, the curvature radius R, the surface interval D, the refractive index Nd, and the Abbe number Vd of each of the surfaces 271a to 277a are values illustrated in the table of FIG. 11. The curvature radius R and the surface interval D of each of the surfaces 271b to 277b are values illustrated in the table of FIG. 11.

Since the surface of the aperture stop 262 and the surfaces 114a and 114b are planar, the curvature radius R corresponding to the surface numbers SurNum of 207, 216, and 217 is infinite. Note that, although not described, the surface interval D between the surface of the aperture stop 262 and the surface 114b, and the surface interval D, the refractive index Nd, and the Abbe number Vd of the surface 114a are respective values illustrated in the table of FIG. 11.

The curvature radius R of the imaging surface 233a having the surface number SurNum of 218 is −14.611. Since there is no surface to which the surface number SurNum of 219 is assigned after 218, the surface interval D is 0.

### <Example of Aspherical Data of Each Surface of Lens>

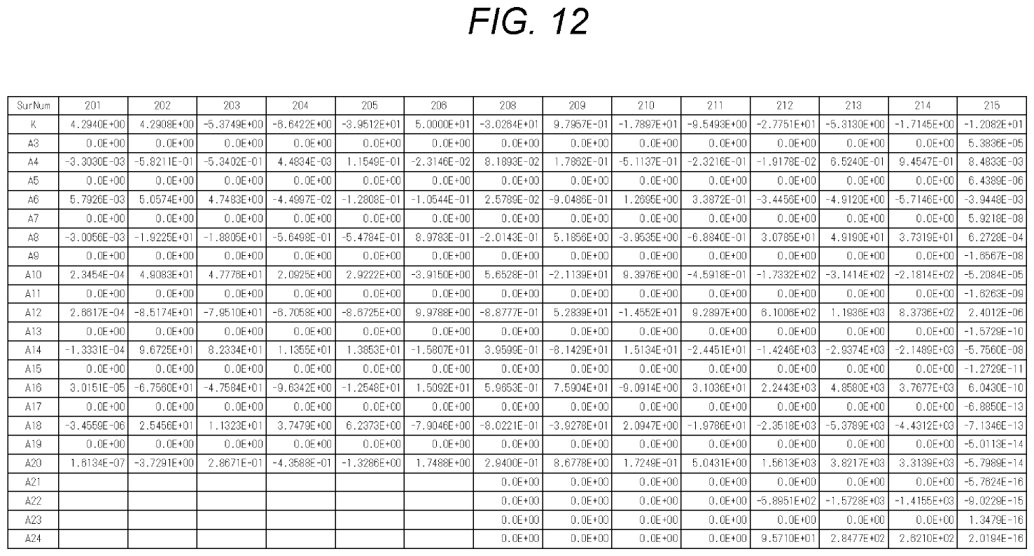

FIG. 12 is a table illustrating an example of aspherical data of the surfaces 271a to 277a and the surfaces 271b to 277b.

Each row in the table of FIG. 12 corresponds to the surface number SurNum, the conic coefficient K, and the third-order aspherical coefficient A3 to 24th-order aspherical coefficient A24. The respective columns correspond to the surfaces 271a, 271b, 272a, 272b, 273a, 273b, 274a, 274b, 275a, 275b, 276a, 276b, 277a, and 277b in order from the second from the left.

Note that, although not described, the conic coefficient K and the third-order aspherical coefficient A3 to the 20th-order aspherical coefficient A20 of each of the surfaces 271a to 273a and the surfaces 271b to 273b are values illustrated in the table of FIG. 12. The conic coefficient K and the third-order aspherical coefficient A3 to 24th-order aspherical coefficient A24 of each of the surfaces 274a to 277a and the surfaces 274b to 277b are values illustrated in the table of FIG. 12.

### <Examples of Spherical Aberration, Field Curvature, and Distortion Aberration>

FIG. 13 is a graph illustrating an example of spherical aberration, field curvature, and distortion aberration generated in the imaging lens 216.

A of FIG. 13 is a graph illustrating spherical aberration for each wavelength of light having wavelengths of 486.1327 nm, 587.5618 nm, and 656.2725 nm, generated in the imaging lens 216. B of FIG. 13 is a graph illustrating a field curvature of light having the wavelength of 587.5618 nm, generated in the imaging lens 216. C of FIG. 13 is a graph illustrating distortion aberration of light having the wavelength of 587.5618 nm, generated in the imaging lens 216.

### <Example of Lateral Aberration>

FIG. 14 is a graph illustrating an example of lateral aberration generated in the imaging lens 216.

FIG. 14 is a graph illustrating lateral aberration for each wavelength of light having wavelengths of 486.1327 nm, 587.5618 nm, and 656.2725 nm, generated in the imaging lens 216.

Specifically, the graphs on the left side in A to C of FIG. 14 represent the lateral aberration in the tangential direction at positions (positions of image heights in a case where half angles of view are 61.89°, 29.84°, and) 0° where the image heights are 1.00 mm, 0.50 mm, and 0.00 mm, respectively. The graphs on the right side in A to C of FIG. 14 represent lateral aberration in the sagittal direction at positions where the image heights are 1.00 mm, 0.50 mm, and 0.00 mm, respectively.

As illustrated in FIGS. 13 and 14, favorable aberration correction is performed in the imaging lens 216, and thus the imaging lens 216 has favorable imaging quality.

### 3. Third Embodiment

### <Configuration Example of Imaging Lens>

A third embodiment of an imaging device to which the present technology is applied is different from the imaging device 100 in FIG. 2 in terms of an imaging lens and an imaging surface, and the other configurations are similar to those of the imaging device 100. Therefore, the following description focuses on the imaging lens and the imaging surface.

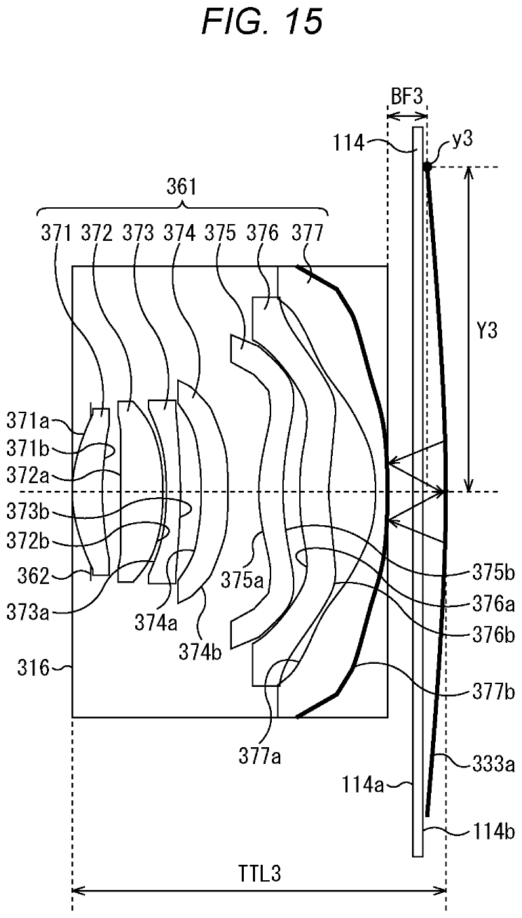

FIG. 15 is a cross-sectional view illustrating a configuration example of an imaging lens in a third embodiment of an imaging device to which the present technology is applied.

An imaging lens 316 in FIG. 15 includes a lens group 361 and an aperture stop 362.

The lens group 361 includes seven aspherical lenses 371 to 377. The seven lenses 371 to 377 are disposed in order from the object side toward the imaging surface 333a side. The lens 371 has a surface 371a on the object side and a surface 371b on the imaging surface 333a side.

Similarly to the lens 371, the lenses 372 to 377 also have surfaces 372a and 372b, surfaces 373a and 373b, surfaces 374a and 374b, surfaces 375a and 375b, surfaces 376a and 376b, and surfaces 377a and 377b, respectively.

The surfaces 371a to 377a and 371b to 377b are aspherical surfaces. The surface 377b (final surface) on the imaging surface 333a side of the lens 377 closest to the imaging surface 333a among the lenses 371 to 377 is an aspherical surface in which a sign of surface power is not inverted with increasing distance from the optical axis, and has a shape that tilts toward the object side with increasing distance from the optical axis. The aperture stop 362 is disposed closer to the object side than the lens 371, and limits light incident to the lens 371. Similarly to the imaging surface 133a, the imaging surface 333a is curved concavely toward the object side.

The light incident to the imaging lens 316 from an object is emitted via the lenses 371 to 377 and the infrared cut filter 114, and is collected on the imaging surface 333a.

Note that, hereinafter, the overall optical length of the imaging lens 316, which is a distance on the optical axis from the surface 371a (foremost surface) closest to the object side of the lens 371 closest to the object side among the lenses 371 to 377 to the imaging surface 333a, will be referred to as TTL3. A distance on the optical axis from a vertex on the optical axis of the surface 377b to a position y3 of the maximum image height Y3 of the imaging surface 333a, that is, a back focus of the imaging lens 316, will be referred to as BF3.

### <Example of Various Setting Values of Entire Imaging Lens>

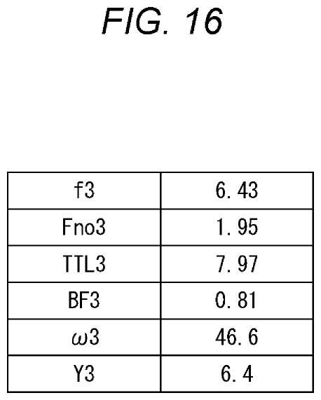

FIG. 16 is a table illustrating examples of various setting values of the entire imaging lens 316.

As illustrated in FIG. 16, a focal length f3 of the entire imaging lens 316 is 6.43 mm. An F value Fno3 of the imaging lens 316 is 1.95 and is 2.5 or less. The overall optical length TTL3 is 7.97 mm, and the back focus BF3 is 0.81 mm. A maximum half angle of view ω3 of the imaging lens 316 is 46.6 degrees. That is, the maximum angle of view 2ω3 of the imaging lens 316 is 93.2 degrees and is 90 degrees or more. The maximum image height Y3 is 6.4 mm.

### <Examples of Various Setting Values of Each Lens, Aperture Stop, Imaging Surface, and Infrared Cut Filter>

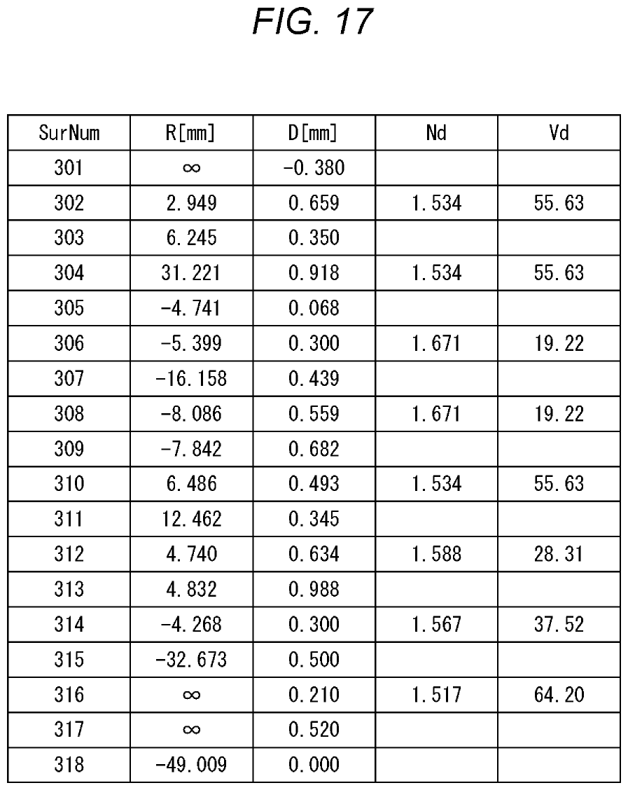

FIG. 17 is a table illustrating examples of various setting values of the lenses 371 to 377, the aperture stop 362, the infrared cut filter 114, and the imaging surface 333a.

The second and subsequent rows from the top in the table of FIG. 17 correspond to the surface of the aperture stop 362, the surfaces 371a to 377a, the surfaces 371b to 377b, the surfaces 114a and 114b, and the imaging surface 333a, respectively. The respective columns are similar to the columns in FIG. 5.

In the present specification, it is assumed that 301 is assigned as a surface number to the surface of the aperture stop 362. It is assumed that surface numbers from 302 to 315 are sequentially assigned to the surfaces 371a, 371b, 372a, 372b, 373a, 373b, 374a, 374b, 375a, 375b, 376a, 376b, 377a, and 377b. It is assumed that surface numbers from 316 to 318 are sequentially assigned to the surfaces 114a and 114b and the imaging surface 333a.

Note that, although not described, the curvature radius R, the surface interval D, the refractive index Nd, and the Abbe number Vd of each of the surfaces 371a to 377a are values illustrated in the table of FIG. 17. The curvature radius R and the surface interval D of each of the surfaces 371b to 377b are values illustrated in the table of FIG. 17.

Since the surface of the aperture stop 362 and the surfaces 114a and 114b are planar, the curvature radius R corresponding to the surface numbers SurNum of 301, 316, and 317 is infinite. Note that, although not described, the surface interval D between the surface of the aperture stop 362 and the surface 114b, and the surface interval D, the refractive index Nd, and the Abbe number Vd of the surface 114a are respective values illustrated in the table of FIG. 17.

The curvature radius R of the imaging surface 333a having the surface number SurNum of 318 is −49.009. Since there is no surface to which the surface number SurNum of 319 is assigned after 318, the surface interval D is 0.

### <Example of Aspherical Data of Each Surface of Lens>

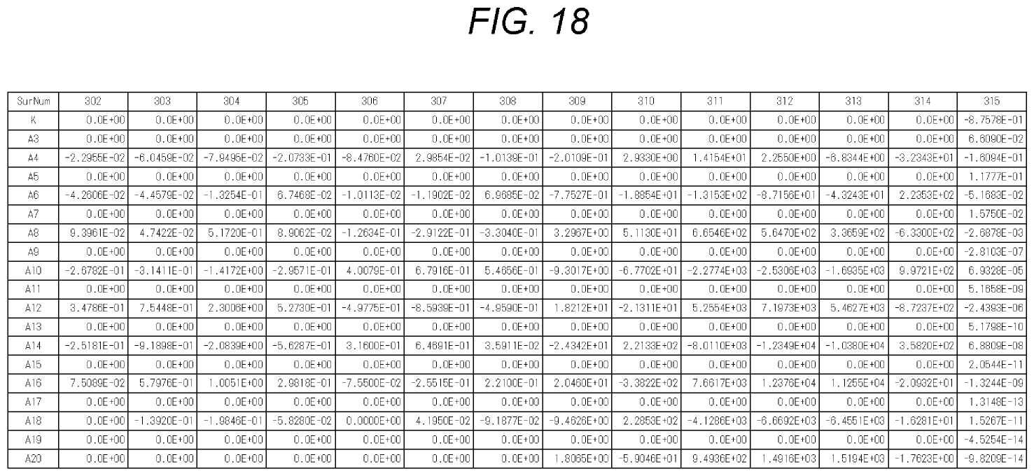

FIG. 18 is a table illustrating an example of aspherical data of the surfaces 371a to 377a and the surfaces 371b to 377b.

Rows in the table of FIG. 18 are respectively similar to the rows in the table of FIG. 6. The respective columns correspond to the surfaces 371a, 371b, 372a, 372b, 373a, 373b, 374a, 374b, 375a, 375b, 376a, 376b, 377a, and 377b in order from the left.

Note that, although not described, the conic coefficient K and the third-order aspherical coefficient A3 to the 20th-order aspherical coefficient A20 of each of the surfaces 371a to 377a and the surfaces 371b to 377b are values illustrated in the table of FIG. 18.

### <Examples of Spherical Aberration, Field Curvature, and Distortion Aberration>

FIG. 19 is a graph illustrating an example of spherical aberration, field curvature, and distortion aberration generated in the imaging lens 316.

A of FIG. 19 is a graph illustrating spherical aberration for each wavelength of light having wavelengths of 486.1327 nm, 587.5618 nm, and 656.2725 nm, generated in the imaging lens 316. B of FIG. 19 is a graph illustrating a field curvature of light having the wavelength of 587.5618 nm, generated in the imaging lens 316. C of FIG. 19 is a graph illustrating distortion aberration of light having the wavelength of 587.5618 nm, generated in the imaging lens 316.

### <Example of Lateral Aberration>

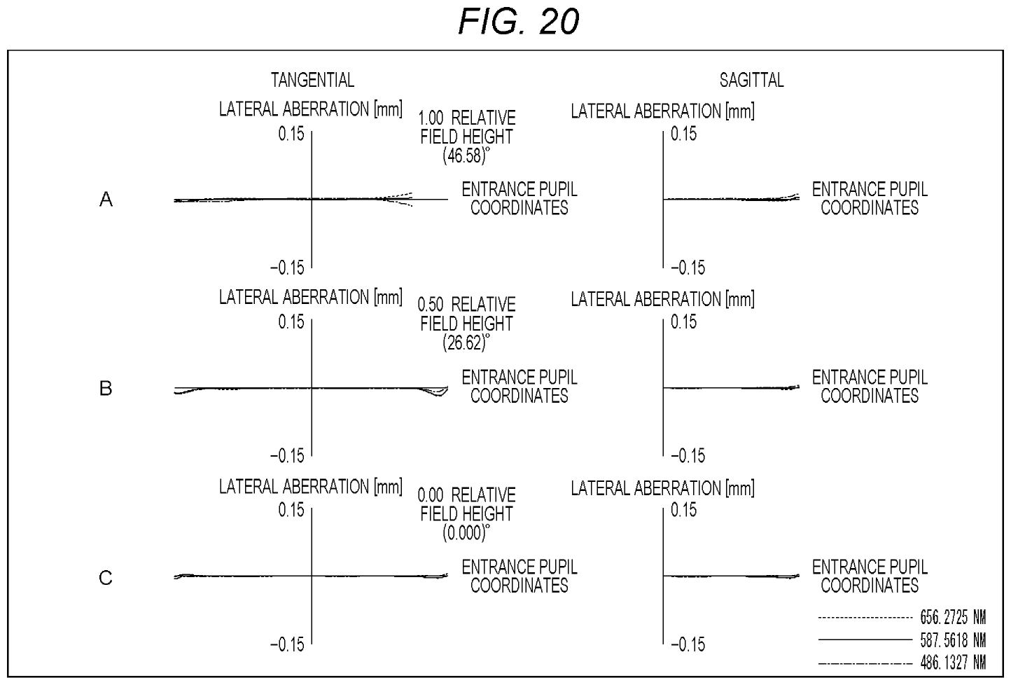

FIG. 20 is a graph illustrating an example of lateral aberration generated in the imaging lens 316.

FIG. 20 is a graph illustrating lateral aberration for each wavelength of light having wavelengths of 486.1327 nm, 587.5618 nm, and 656.2725 nm, generated in the imaging lens 316.

Specifically, the graphs on the left side in A to C of FIG. 20 represent the lateral aberration in the tangential direction at positions (positions of image heights in a case where half angles of view are 46.58°, 26.62°, and) 0° where the image heights are 1.00 mm, 0.50 mm, and 0.00 mm, respectively. The graphs on the right side in A to C of FIG. 20 represent lateral aberration in the sagittal direction at positions where the image heights are 1.00 mm, 0.50 mm, and 0.00 mm, respectively.

As illustrated in FIGS. 19 and 20, favorable aberration correction is performed in the imaging lens 316, and thus the imaging lens 316 has favorable imaging quality.

### 4. Fourth Embodiment

### <Configuration Example of Imaging Lens>

A fourth embodiment of an imaging device to which the present technology is applied is different from the imaging device 100 in FIG. 2 in terms of an imaging lens and an imaging surface, and the other configurations are similar to those of the imaging device 100. Therefore, the following description focuses on the imaging lens and the imaging surface.

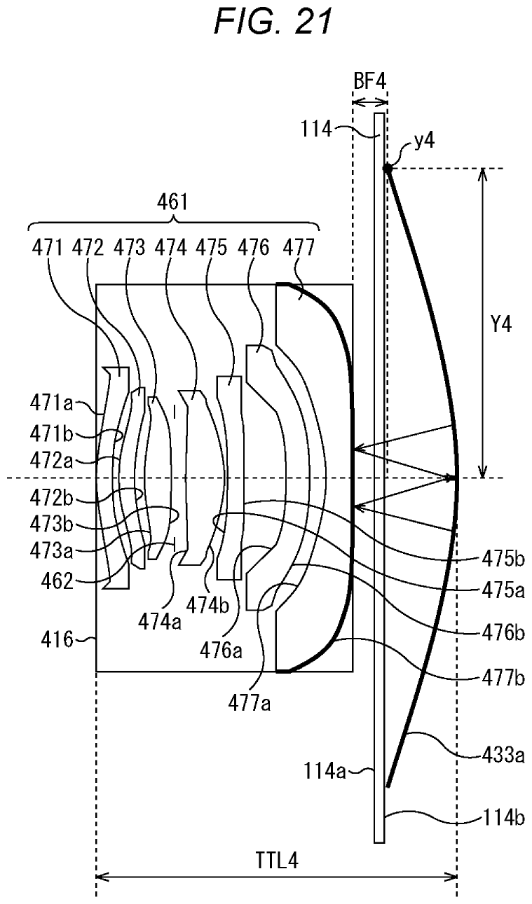

FIG. 21 is a cross-sectional view illustrating a configuration example of an imaging lens in a fourth embodiment of an imaging device to which the present technology is applied.

An imaging lens 416 in FIG. 21 includes a lens group 461 and an aperture stop 462.

The lens group 461 includes seven aspherical lenses 471 to 477. The seven lenses 471 to 477 are disposed in order from the object side toward the imaging surface 433a side. The lens 471 has a surface 471a on the object side and a surface 471b on the imaging surface 433a side.

Similarly to the lens 471, the lenses 472 to 477 also have surfaces 472a and 472b, surfaces 473a and 473b, surfaces 474a and 474b, surfaces 475a and 475b, surfaces 476a and 476b, and surfaces 477a and 477b, respectively.

The surfaces 471a to 477a and 471b to 477b are aspherical surfaces. The surface 477b (final surface) on the imaging surface 433a side of the lens 477 closest to the imaging surface 433a among the lenses 471 to 477 is an aspherical surface in which a sign of surface power is not inverted with increasing distance from the optical axis, and has a shape that tilts toward the object side with increasing distance from the optical axis. The aperture stop 462 is disposed between the lenses 473 and 474, and limits light incident to the lens 474 from the lens 473. The imaging surface 433a is an aspherical surface curved concavely toward the object side.

The light incident to the imaging lens 416 from an object is emitted via the lenses 471 to 477 and the infrared cut filter 114, and is collected on the imaging surface 433a.

Note that, hereinafter, the overall optical length of the imaging lens 416, which is a distance on the optical axis from the surface 471a (foremost surface) closest to the object side of the lens 471 closest to the object side among the lenses 471 to 477 to the imaging surface 433a, will be referred to as TTL4. A distance on the optical axis from a vertex on the optical axis of the surface 477b to a position y4 of the maximum image height Y4 of the imaging surface 433a, that is, a back focus of the imaging lens 416, will be referred to as BF4.

### <Example of Various Setting Values of Entire Imaging Lens>

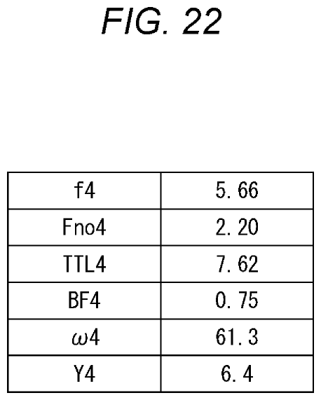

FIG. 22 is a table illustrating examples of various setting values of the entire imaging lens 416.

As illustrated in FIG. 22, a focal length f4 of the entire imaging lens 416 is 5.66 mm. An F value Fno4 of the imaging lens 416 is 2.20 and is 2.5 or less. The overall optical length TTL4 is 7.62 mm and the back focus BF4 is 0.75 mm. A maximum half angle of view ω4 of the imaging lens 416 is 61.3 degrees. That is, the maximum angle of view 2ω4 of the imaging lens 416 is 122.6 degrees and is 90 degrees or more. The maximum image height Y4 is 6.4 mm.

### <Examples of Various Setting Values of Each Lens, Aperture Stop, Imaging Surface, and Infrared Cut Filter>

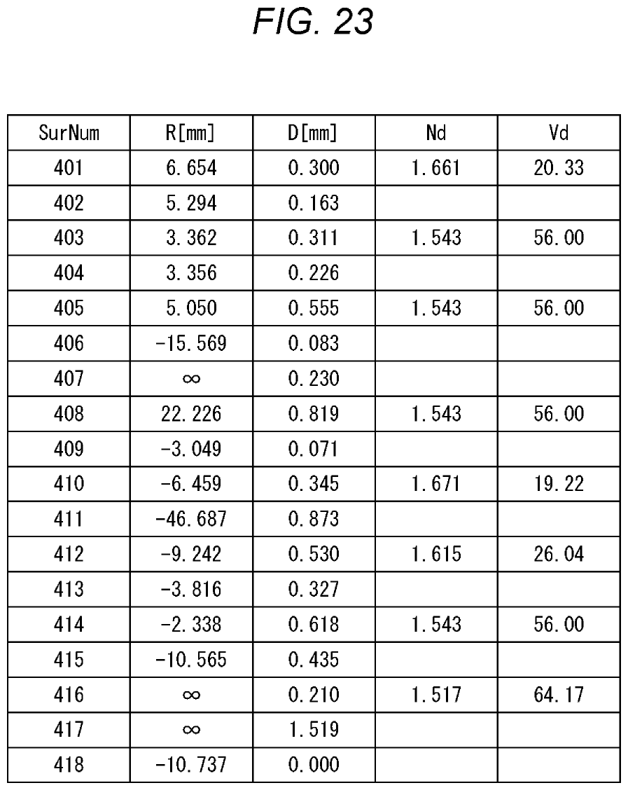

FIG. 23 is a table illustrating examples of various setting values of the lenses 471 to 477, the aperture stop 462, the infrared cut filter 114, and the imaging surface 433a.

The second and subsequent rows from the top in the table of FIG. 23 correspond to the surfaces 471a to 477a, the surfaces 471b to 477b, the surface of the aperture stop 462, the surfaces 114a and 114b, and the imaging surface 433a, respectively. The respective columns are similar to the columns in FIG. 5.

In the present specification, it is assumed that surface numbers from 401 to 406 are sequentially assigned to the surfaces 471a, 471b, 472a, 472b, 473a, and 473b. It is assumed that surface numbers from 407 to 418 are sequentially assigned to the surface of the aperture stop 462, the surfaces 474a, 474b, 475a, 475b, 476a, 476b, 477a, 477b, 114a, and 114b, and the imaging surface 433a.

Note that, although not described, the curvature radius R, the surface interval D, the refractive index Nd, and the Abbe number Vd of each of the surfaces 471a to 477a are values illustrated in the table of FIG. 23. The curvature radius R and the surface interval D of each of the surfaces 471b to 477b are values illustrated in the table of FIG. 23.

Since the surface of the aperture stop 462 and the surfaces 114a and 114b are planar, the curvature radius R corresponding to the surface numbers SurNum of 407, 416, and 417 is infinite. Note that, although not described, the surface interval D between the surface of the aperture stop 462 and the surface 114b, and the surface interval D, the refractive index Nd, and the Abbe number Vd of the surface 114a are respective values illustrated in the table of FIG. 23.

The curvature radius R of the imaging surface 433a having the surface number SurNum of 418 is −10.137. Since there is no surface to which the surface number SurNum of 419 is assigned after 418, the surface interval D is 0.

### <Example of Aspherical Data of Each Surface of Lens and Imaging Surface>

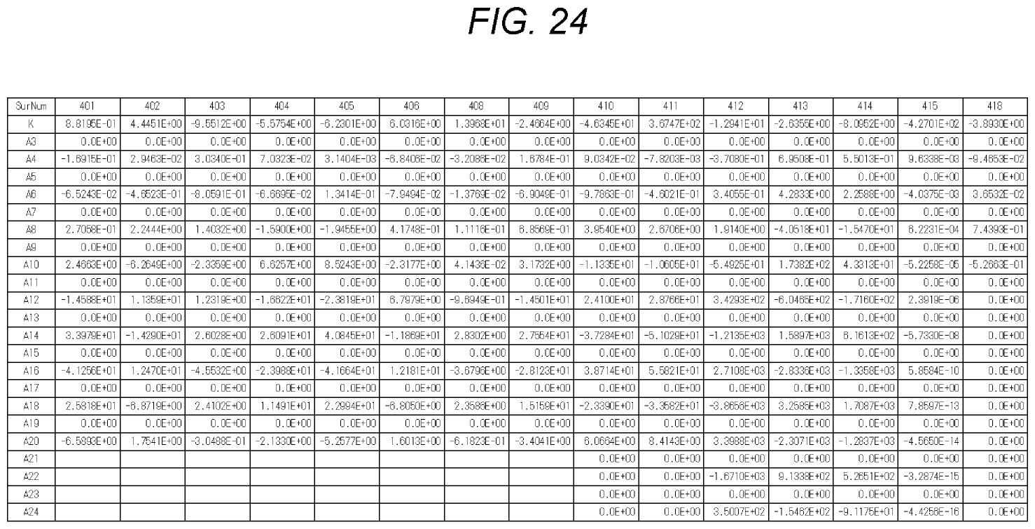

FIG. 24 is a table illustrating an example of aspherical data of the surfaces 471a to 477a, the surfaces 471b to 477b, and the imaging surface 433a.

Rows in the table of FIG. 24 are respectively similar to the rows in the table of FIG. 12. The respective columns correspond to the surfaces 471a, 471b, 472a, 472b, 473a, 473b, 474a, 474b, 475a, 475b, 476a, 476b, 477a, and 477b, and the imaging surface 433a in order from the left.

Note that, although not described, the conic coefficient K and the third-order aspherical coefficient A3 to 20th-order aspherical coefficient A20 of each of the surfaces 471a to 474a and the surfaces 471b to 474b are values illustrated in the table of FIG. 24. The conic coefficient K and the third-order aspherical coefficient A3 to 24th-order aspherical coefficient A24 of each of the surfaces 475a to 477a and the surfaces 475b to 477b and the imaging surface 433a are values illustrated in the table of FIG. 24.

### <Examples of Spherical Aberration, Field Curvature, and Distortion Aberration>

FIG. 25 is a graph illustrating an example of spherical aberration, field curvature, and distortion aberration generated in the imaging lens 416.

A of FIG. 25 is a graph illustrating spherical aberration for each wavelength of light having wavelengths of 486.1327 nm, 587.5618 nm, and 656.2725 nm, generated in the imaging lens 416. B of FIG. 25 is a graph illustrating a field curvature of light having the wavelength of 587.5618 nm, generated in the imaging lens 416. C of FIG. 25 is a graph illustrating distortion aberration of light having the wavelength of 587.5618 nm, generated in the imaging lens 416.

### <Example of Lateral Aberration>

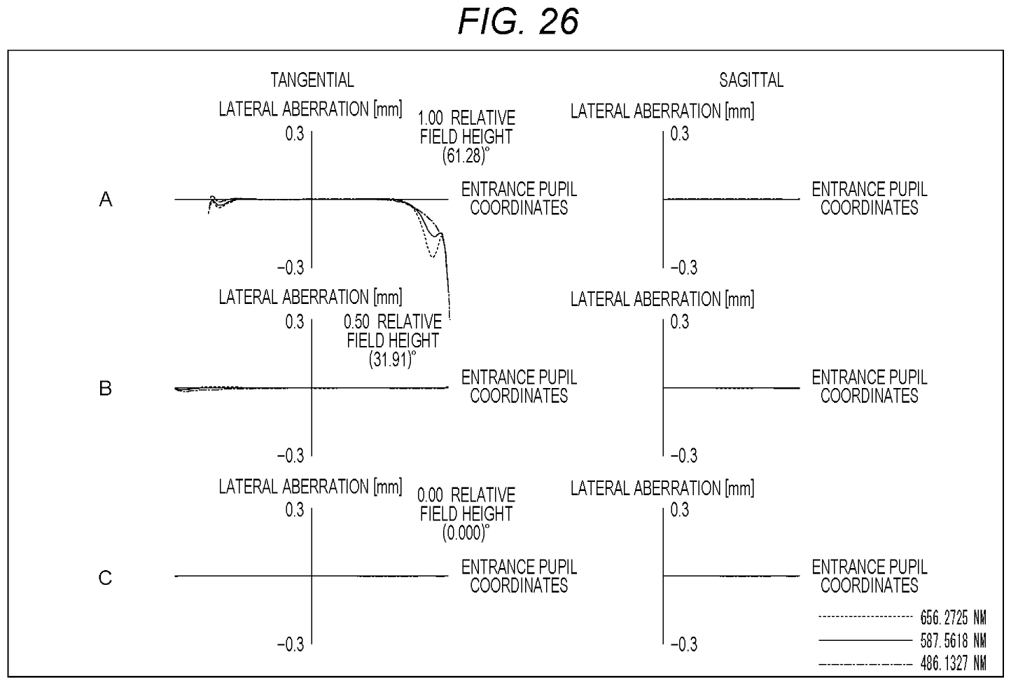

FIG. 26 is a graph illustrating an example of lateral aberration generated in the imaging lens 416.

FIG. 26 is a graph illustrating lateral aberration for each wavelength of light having wavelengths of 486.1327 nm, 587.5618 nm, and 656.2725 nm, generated in the imaging lens 416.

Specifically, the graphs on the left side in A to C of FIG. 26 represent the lateral aberration in the tangential direction at positions (positions of image heights in a case where half angles of view are 61.28°, 31.91°, and) 0° where the image heights are 1.00 mm, 0.50 mm, and 0.00 mm, respectively. The graphs on the right side in A to C of FIG. 26 represent lateral aberration in the sagittal direction at positions where the image heights are 1.00 mm, 0.50 mm, and 0.00 mm, respectively.

As illustrated in FIGS. 25 and 26, favorable aberration correction is performed in the imaging lens 416, and thus the imaging lens 416 has favorable imaging quality.

### 5. Fifth Embodiment

### <Configuration Example of Imaging Lens>

A fifth embodiment of an imaging device to which the present technology is applied is different from the imaging device 100 in FIG. 2 in terms of an imaging lens and an imaging surface, and the other configurations are similar to those of the imaging device 100. Therefore, the following description focuses on the imaging lens and the imaging surface.

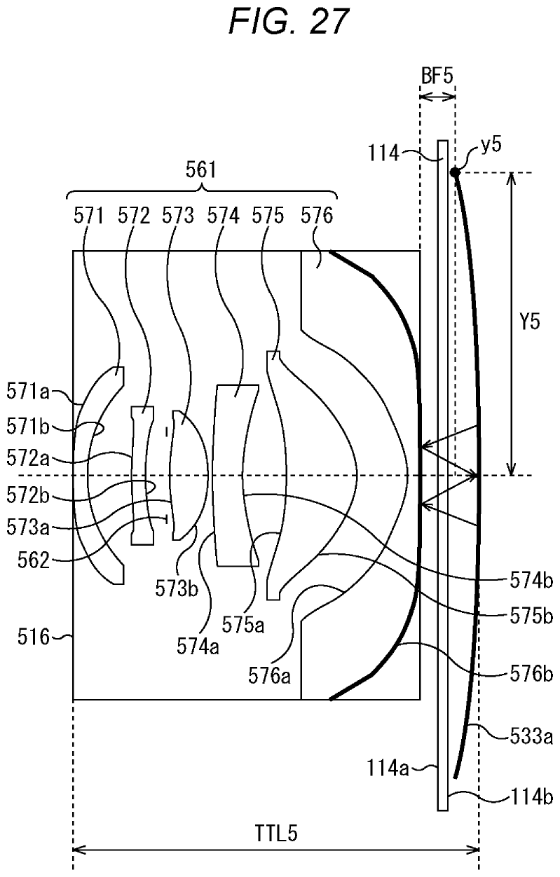

FIG. 27 is a cross-sectional view illustrating a configuration example of an imaging lens in a fifth embodiment of an imaging device to which the present technology is applied.

An imaging lens 516 in FIG. 27 includes a lens group 561 and an aperture stop 562.

The lens group 561 includes six aspherical lenses 571 to 576. The six lenses 571 to 576 are disposed in order from the object side toward the imaging surface 533a side.

The lens 571 has a surface 571a on the object side and a surface 571b on the imaging surface 533a side. Similarly to the lens 571, the lenses 572 to 576 also have surfaces 572a and 572b, surfaces 573a and 573b, surfaces 574a and 574b, surfaces 575a and 575b, and surfaces 576a and 576b, respectively.

The surfaces 571a to 576a and 571b to 576b are aspherical surfaces. The surface 576b (final surface) on the imaging surface 533a side of the lens 576 closest to the imaging surface 533a among the lenses 571 to 576 is an aspherical surface in which a sign of surface power is not inverted with increasing distance from the optical axis, and has a shape that tilts toward the object side with increasing distance from the optical axis. The aperture stop 562 is disposed between the lenses 572 and 573, and limits light incident to the lens 573 from the lens 572. Similarly to the imaging surface 133a, the imaging surface 533a is curved concavely toward the object side.

The light incident to the imaging lens 516 from an object is emitted via the lenses 571 to 576 and the infrared cut filter 114, and is collected on the imaging surface 533a.

Note that, hereinafter, an overall optical length of the imaging lens 516, which is a distance on the optical axis from the surface 571a (foremost surface) closest to the object side of the lens 571 closest to the object side among the lenses 571 to 576 to the imaging surface 533a, will be referred to as TTL5. A distance on the optical axis from a vertex on the optical axis of the surface 576b to a position y5 of the maximum image height Y5 of the imaging surface 533a, that is, a back focus of the imaging lens 516, will be referred to as BF5.

### <Example of Various Setting Values of Entire Imaging Lens>

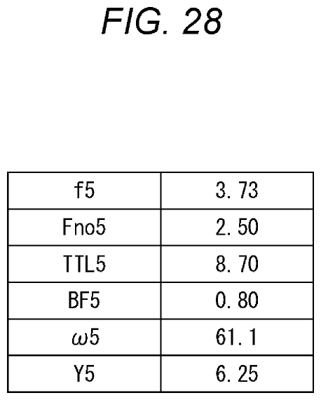

FIG. 28 is a table illustrating examples of various setting values of the entire imaging lens 516.

As illustrated in FIG. 28, a focal length f5 of the entire imaging lens 516 is 3.73 mm. An F value Fno5 of the imaging lens 516 is 2.50 and is 2.5 or less. The overall optical length TTL5 is 8.70 mm and the back focus BF5 is 0.80 mm. A maximum half angle of view ω5 of the imaging lens 516 is 61.1 degrees. That is, the maximum angle of view 2ω5 of the imaging lens 516 is 122.2 degrees and is 90 degrees or more. The maximum image height Y5 is 6.25 mm.

### <Examples of Various Setting Values of Each Lens, Aperture Stop, Imaging Surface, and Infrared Cut Filter>

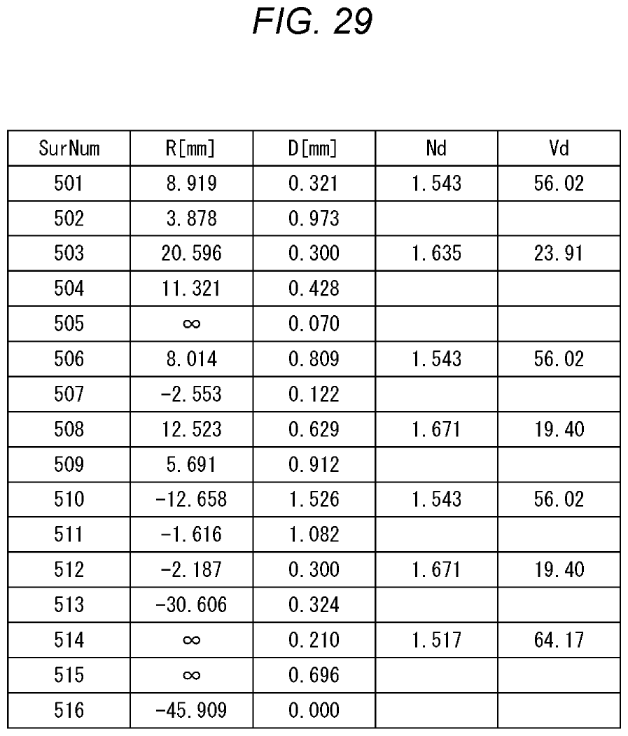

FIG. 29 is a table illustrating examples of various setting values of the lenses 571 to 576, the aperture stop 562, the infrared cut filter 114, and the imaging surface 533a.

The second and subsequent rows from the top in the table of FIG. 29 correspond to the surfaces 571a to 576a, the surfaces 571b to 576b, the surface of the aperture stop 562, the surfaces 114a and 114b, and the imaging surface 533a, respectively. The respective columns are similar to the columns in FIG. 5.

In the present specification, it is assumed that surface numbers from 501 to 504 are sequentially assigned to the surfaces 571a, 571b, 572a, and 572b. It is assumed that surface numbers from 505 to 516 are sequentially assigned to the surface of the aperture stop 562, the surfaces 573a, 573b, 574a, 574b, 575a, 575b, 576a, 576b, 114a, and 114b, and the imaging surface 533a.

Note that, although not described, the curvature radius R, the surface interval D, the refractive index Nd, and the Abbe number Vd of each of the surfaces 571a to 576a are values illustrated in the table of FIG. 29. The curvature radius R and the surface interval D of each of the surfaces 571b to 576b are values illustrated in the table of FIG. 29.

Since the surface of the aperture stop 562 and the surfaces 114a and 114b are planar, the curvature radius R corresponding to the surface numbers SurNum of 505, 514, and 515 is infinite. Note that, although not described, the surface interval D between the surface of the aperture stop 562 and the surface 114b, and the surface interval D, the refractive index Nd, and the Abbe number Vd of the surface 114a are respective values illustrated in the table of FIG. 29.

The curvature radius R of the imaging surface 533a having the surface number SurNum of 516 is −45.909. Since there is no surface to which the surface number SurNum of 517 is assigned after 516, the surface interval D is 0.

### <Example of Aspherical Data of Each Surface of Lens>

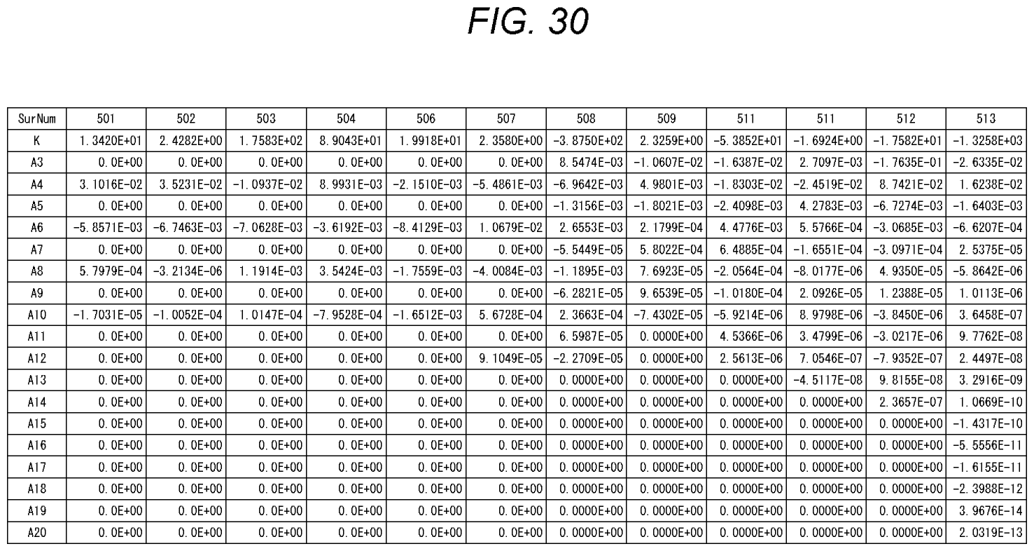

FIG. 30 is a table illustrating an example of aspherical data of the surfaces 571a to 576a and the surfaces 571b to 576b.

Rows in the table of FIG. 30 are respectively similar to the rows in the table of FIG. 6. The respective columns correspond to the surfaces 571a, 571b, 572a, 572b, 573a, 573b, 574a, 574b, 575a, 575b, 576a, and 576b in order from the left.

Note that, although not described, the conic coefficient K and the third-order aspherical coefficient A3 to 20th-order aspherical coefficient A20 of each of the surfaces 571a to 576a and the surfaces 571b to 576b are values illustrated in the table of FIG. 30.

### <Examples of Spherical Aberration, Field Curvature, and Distortion Aberration>

FIG. 31 is a graph illustrating an example of spherical aberration, field curvature, and distortion aberration generated in the imaging lens 516.

A of FIG. 31 is a graph illustrating spherical aberration for each wavelength of light having wavelengths of 486.1300 nm, 587.5600 nm, and 656.2700 nm, generated in the imaging lens 516. B of FIG. 31 is a graph illustrating a field curvature of light having the wavelength of 587.5600 nm, generated in the imaging lens 516. C of FIG. 31 is a graph illustrating distortion aberration of light having the wavelength of 587.5600 nm, generated in the imaging lens 516.

### <Example of Lateral Aberration>

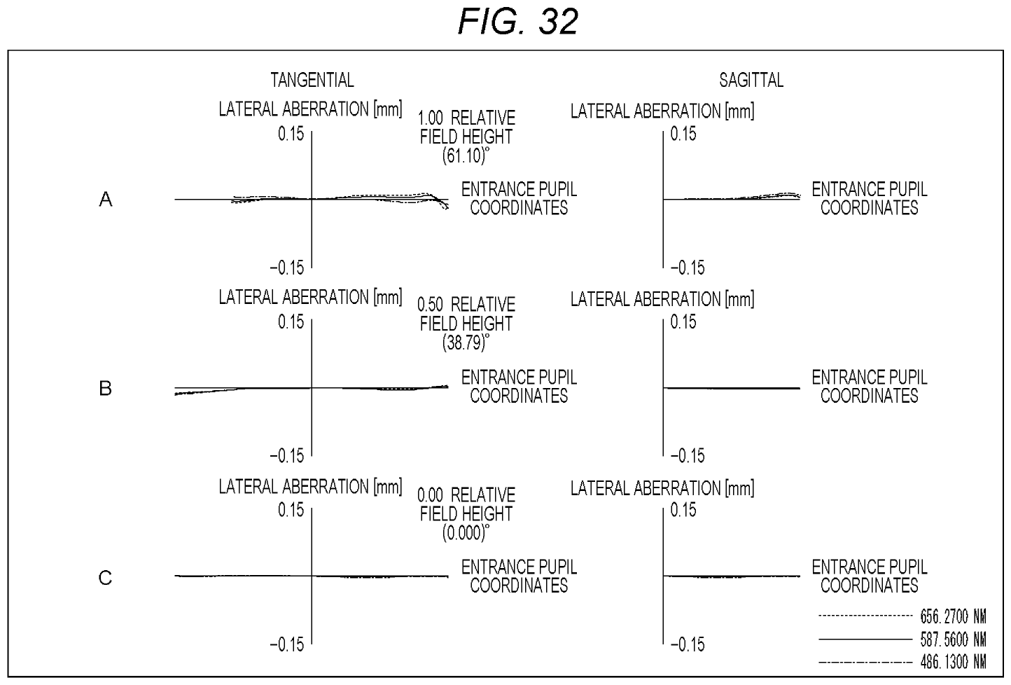

FIG. 32 is a graph illustrating an example of lateral aberration generated in the imaging lens 516.

FIG. 32 is a graph illustrating lateral aberration for each wavelength of light having wavelengths of 486.1300 nm, 587.5600 nm, and 656.2700 nm, generated in the imaging lens 516 in FIG. 27.

Specifically, the graphs on the left side in A to C of FIG. 32 represent the lateral aberration in the tangential direction at positions (positions of image heights in a case where half angles of view are 61.10°, 38.79°, and) 0° where the image heights are 1.00 mm, 0.50 mm, and 0.00 mm, respectively. The graphs on the right side in A to C of FIG. 32 represent lateral aberration in the sagittal direction at positions where the image heights are 1.00 mm, 0.50 mm, and 0.00 mm, respectively.

As illustrated in FIGS. 31 and 32, favorable aberration correction is performed in the imaging lens 516, and thus the imaging lens 516 has favorable imaging quality.

### 6. Sixth Embodiment

### <Configuration Example of Imaging Lens>

A sixth embodiment of an imaging device to which the present technology is applied is different from the imaging device 100 in FIG. 2 in terms of an imaging lens and an imaging surface, and the other configurations are similar to those of the imaging device 100. Therefore, the following description focuses on the imaging lens and the imaging surface.

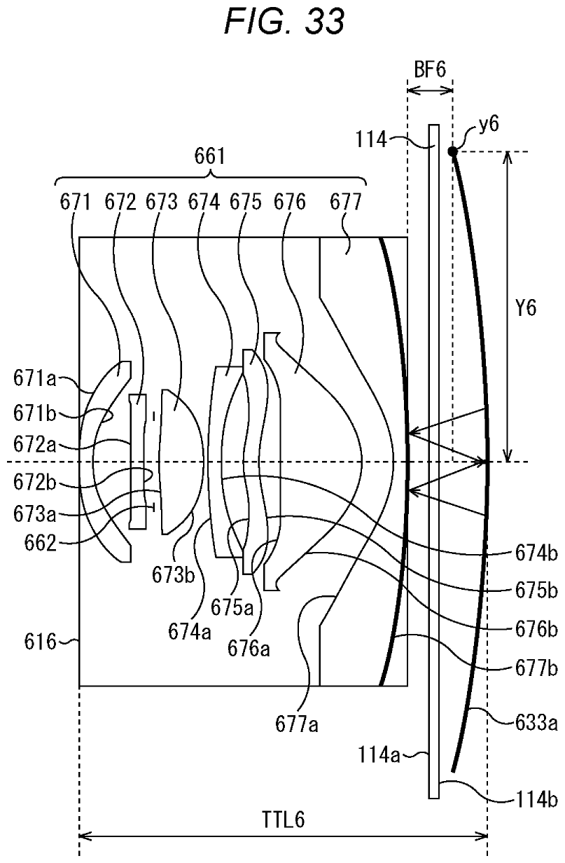

FIG. 33 is a cross-sectional view illustrating a configuration example of an imaging lens in a sixth embodiment of an imaging device to which the present technology is applied.

An imaging lens 616 in FIG. 33 includes a lens group 661 and an aperture stop 662.

The lens group 661 includes seven aspherical lenses 671 to 677. The seven lenses 671 to 677 are disposed in order from the object side toward the imaging surface 633a side. The lens 671 has a surface 671a on the object side and a surface 671b on the imaging surface 633a side.

Similarly to the lens 671, the lenses 672 to 677 also have surfaces 672a and 672b, surfaces 673a and 673b, surfaces 674a and 674b, surfaces 675a and 675b, surfaces 676a and 676b, and surfaces 677a and 677b, respectively.

The surfaces 671a to 677a and 671b to 676b are aspherical surfaces. The surface 677b (final surface) on the imaging surface 633a side of the lens 677 closest to the imaging surface 633a among the lenses 671 to 677 is a spherical surface, and has a shape that tilts toward the object side with increasing distance from the optical axis. The aperture stop 662 is disposed between the lenses 672 and 673, and limits light incident to the lens 673 from the lens 672. Similarly to the imaging surface 133a, the imaging surface 633a is curved concavely toward the object side.

The light incident to the imaging lens 616 from an object is emitted via the lenses 671 to 677 and the infrared cut filter 114, and is collected on the imaging surface 633a.

Note that, hereinafter, the overall optical length of the imaging lens 616, which is a distance on the optical axis from the surface 671a (foremost surface) closest to the object side of the lens 671 closest to the object side among the lenses 671 to 677 to the imaging surface 633a, will be referred to as TTL6. A distance on the optical axis from a vertex on the optical axis of the surface 677b to a position y6 of the maximum image height Y6 of the imaging surface 633a, that is, a back focus of the imaging lens 616, will be referred to as BF6.

### <Example of Various Setting Values of Entire Imaging Lens>

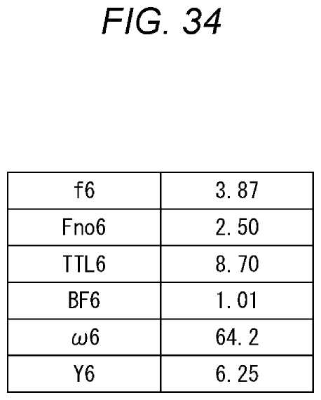

FIG. 34 is a table illustrating examples of various setting values of the entire imaging lens 616.

As illustrated in FIG. 34, a focal length f6 of the entire imaging lens 616 is 3.87 mm. An F value Fno6 of the imaging lens 616 is 2.50 and is 2.5 or less. The overall optical length TTL6 is 8.70 mm and the back focus BF6 is 1.01 mm. A maximum half angle of view ω6 of the imaging lens 616 is 64.2 degrees. That is, the maximum angle of view 2ω6 of the imaging lens 616 is 128.4 degrees and is 90 degrees or more. The maximum image height Y6 is 6.25 mm.

### <Examples of Various Setting Values of Each Lens, Aperture Stop, Imaging Surface, and Infrared Cut Filter>

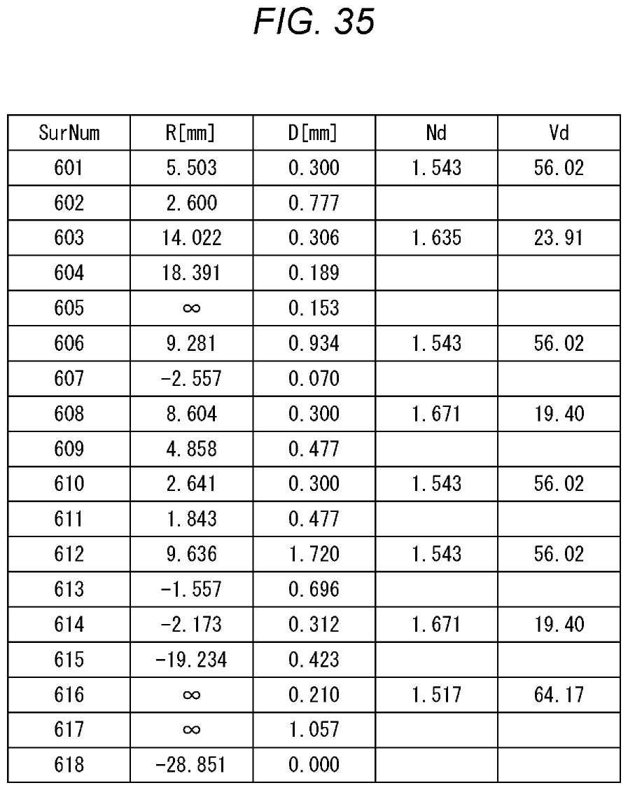

FIG. 35 is a table illustrating examples of various setting values of the lenses 671 to 677, the aperture stop 662, the infrared cut filter 114, and the imaging surface 633a.

The second and subsequent rows from the top in the table of FIG. 35 correspond to the surfaces 671a to 677a, the surfaces 671b to 677b, the surface of the aperture stop 662, the surfaces 114a and 114b, and the imaging surface 633a, respectively. The respective columns are similar to the columns in FIG. 5.

In the present specification, it is assumed that surface numbers from 601 to 604 are sequentially assigned to the surfaces 671a, 671b, 672a, and 672b. It is assumed that surface numbers from 605 to 618 are sequentially assigned to the surface of the aperture stop 662, the surfaces 673a, 673b, 674a, 674b, 675a, 675b, 676a, 676b, 677a, 677b, 114a, and 114b, and the imaging surface 633a.

Note that, although not described, the curvature radius R, the surface interval D, the refractive index Nd, and the Abbe number Vd of each of the surfaces 671a to 677a are values illustrated in the table of FIG. 35. The curvature radius R and the surface interval D of each of the surfaces 671b to 677b are values illustrated in the table of FIG. 35.

Since the surface of the aperture stop 662 and the surfaces 114a and 114b are planar, the curvature radius R corresponding to the surface numbers SurNum of 605, 616, and 617 is infinite. Note that, although not described, the surface interval D between the surface of the aperture stop 662 and the surface 114b, and the surface interval D, the refractive index Nd, and the Abbe number Vd of the surface 114a are values illustrated in the table of FIG. 35.

The curvature radius R of the imaging surface 633a having the surface number SurNum of 618 is −28.851. Since there is no surface to which the surface number SurNum of 617 is assigned after 616, the surface interval D is 0.

### <Example of Aspherical Data of Each Surface of Lens>

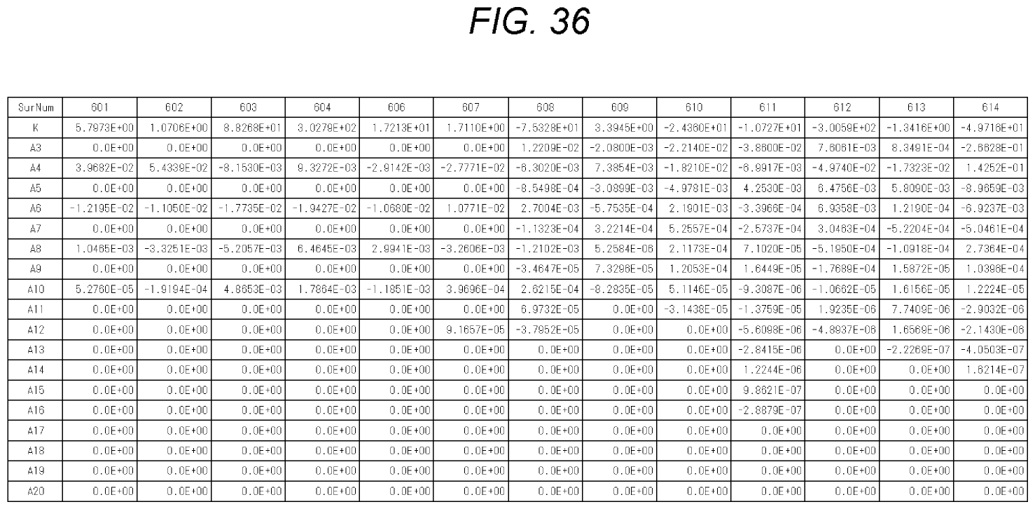

FIG. 36 is a table illustrating an example of aspherical data of the surfaces 671a to 677a and the surfaces 671b to 676b.

Rows in the table of FIG. 36 are respectively similar to the rows in the table of FIG. 6. The respective columns correspond to the surfaces 671a, 671b, 672a, 672b, 673a, 673b, 674a, 674b, 675a, 675b, 676a, 676b, and 677a in order from the left.

Note that, although not described, the conic coefficient K and the third-order aspherical coefficient A3 to 20th-order aspherical coefficient A20 of each of the surfaces 671a to 677a and the surfaces 671b to 676b are values illustrated in the table of FIG. 36.

### <Examples of Spherical Aberration, Field Curvature, and Distortion Aberration>

FIG. 37 is a graph illustrating an example of spherical aberration, field curvature, and distortion aberration generated in the imaging lens 616.

A of FIG. 37 is a graph illustrating spherical aberration for each wavelength of light having wavelengths of 486.1300 nm, 587.5600 nm, and 656.2700 nm, generated in the imaging lens 616. B of FIG. 37 is a graph illustrating a field curvature of light having the wavelength of 587.5600 nm, generated in the imaging lens 616. C of FIG. 37 is a graph illustrating distortion aberration of light having the wavelength of 587.5600 nm, generated in the imaging lens 616.

### <Example of Lateral Aberration>

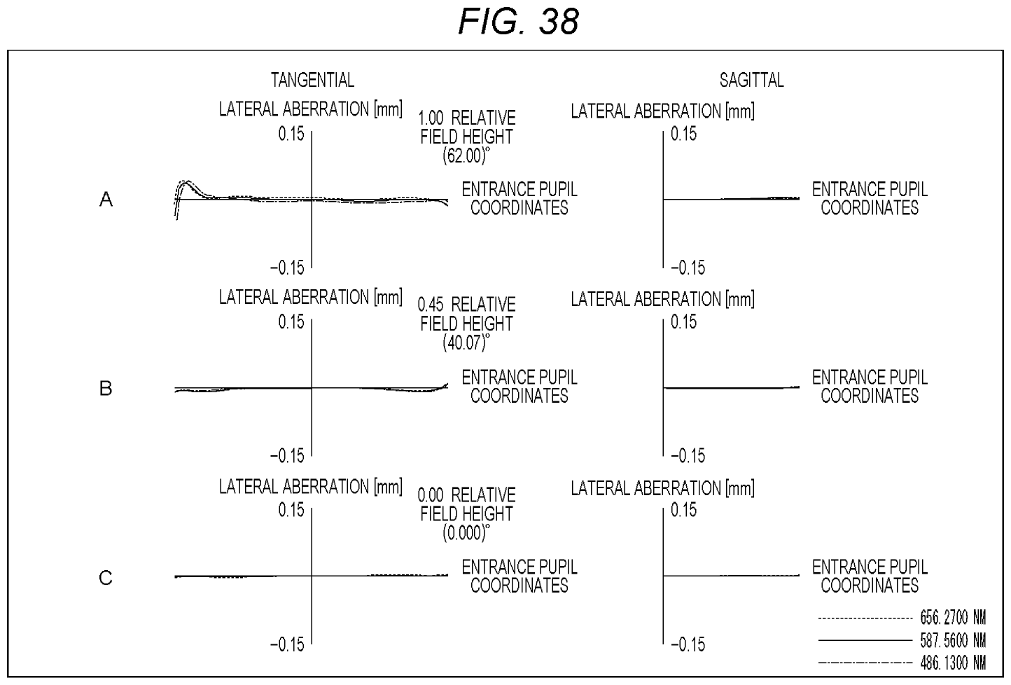

FIG. 38 is a graph illustrating an example of lateral aberration generated in the imaging lens 616.

FIG. 38 is a graph illustrating lateral aberration for each wavelength of light having wavelengths of 486.1300 nm, 587.5600 nm, and 656.2700 nm, generated in the imaging lens 616.

Specifically, the graphs on the left side in A to C of FIG. 38 represent the lateral aberration in the tangential direction at positions (positions of image heights in a case where half angles of view are 62.00°, 40.07°, and) 0° where the image heights are 1.00 mm, 0.45 mm, and 0.00 mm, respectively. The graphs on the right side in A to C of FIG. 38 represent lateral aberration in the sagittal direction at positions where the image heights are 1.00 mm, 0.45 mm, and 0.00 mm, respectively.

As illustrated in FIGS. 37 and 38, favorable aberration correction is performed in the imaging lens 616, and thus the imaging lens 616 has favorable imaging quality.

### 7. Seventh Embodiment

### <Configuration Example of Imaging Lens>

A seventh embodiment of an imaging device to which the present technology is applied is different from the imaging device 100 in FIG. 2 in terms of an imaging lens and an imaging surface, and the other configurations are similar to those of the imaging device 100. Therefore, the following description focuses on the imaging lens and the imaging surface.

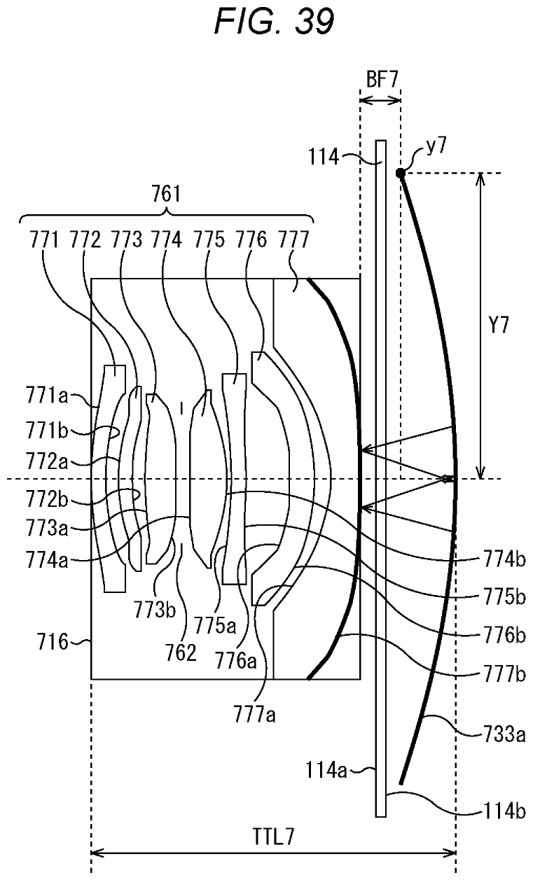

FIG. 39 is a cross-sectional view illustrating a configuration example of an imaging lens in a seventh embodiment of an imaging device to which the present technology is applied.

An imaging lens 716 in FIG. 39 includes a lens group 761 and an aperture stop 762.

The lens group 761 includes seven aspherical lenses 771 to 777. The seven lenses 771 to 777 are disposed in order from the object side toward the imaging surface 733a side. The lens 771 has a surface 771a on the object side and a surface 771b on the imaging surface 733a side.

Similarly to the lens 771, the lenses 772 to 777 also have surfaces 772a and 772b, surfaces 773a and 773b, surfaces 774a and 774b, surfaces 775a and 775b, surfaces 776a and 776b, and surfaces 777a and 777b, respectively.

The surfaces 771a to 777a and 771b to 777b are aspherical surfaces. The surface 777b (final surface) on the imaging surface 733a side of the lens 777 closest to the imaging surface 733a among the lenses 771 to 777 is an aspherical surface in which a sign of surface power is not inverted with increasing distance from the optical axis, and has a shape that tilts toward the object side with increasing distance from the optical axis. The aperture stop 762 is disposed between the lenses 773 and 774, and limits light incident to the lens 774 from the lens 773. Similarly to the imaging surface 133a, the imaging surface 733a is curved concavely toward the object side.

The light incident to the imaging lens 716 from an object is emitted via the lenses 771 to 777 and the infrared cut filter 114, and is collected on the imaging surface 733a.

Note that, hereinafter, the overall optical length of the imaging lens 716, which is a distance on the optical axis from the surface 771a (foremost surface) closest to the object side of the lens 771 closest to the object side among the lenses 771 to 777 to the imaging surface 733a, will be referred to as TTL7. A distance on the optical axis from a vertex on the optical axis of the surface 777b to a position y7 of the maximum image height Y7 of the imaging surface 733a, that is, a back focus of the imaging lens 716, will be referred to as BF7.

### <Example of Various Setting Values of Entire Imaging Lens>

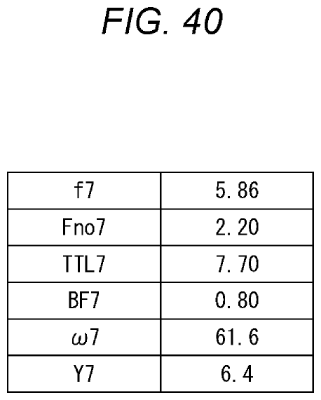

FIG. 40 is a table illustrating examples of various setting values of the entire imaging lens 716.

As illustrated in FIG. 40, a focal length f7 of the entire imaging lens 716 is 5.86 mm. An F value Fno7 of the imaging lens 716 is 2.20 and is 2.5 or less. The overall optical length TTL7 is 7.70 mm and the back focus BF7 is 0.80 mm. A maximum half angle of view ω7 of the imaging lens 716 is 61.6 degrees. That is, the maximum angle of view 2ω7 of the imaging lens 716 is 123.2 degrees and is 90 degrees or more. The maximum image height Y7 is 6.4 mm.

### <Examples of Various Setting Values of Each Lens, Aperture Stop, Imaging Surface, and Infrared Cut Filter>

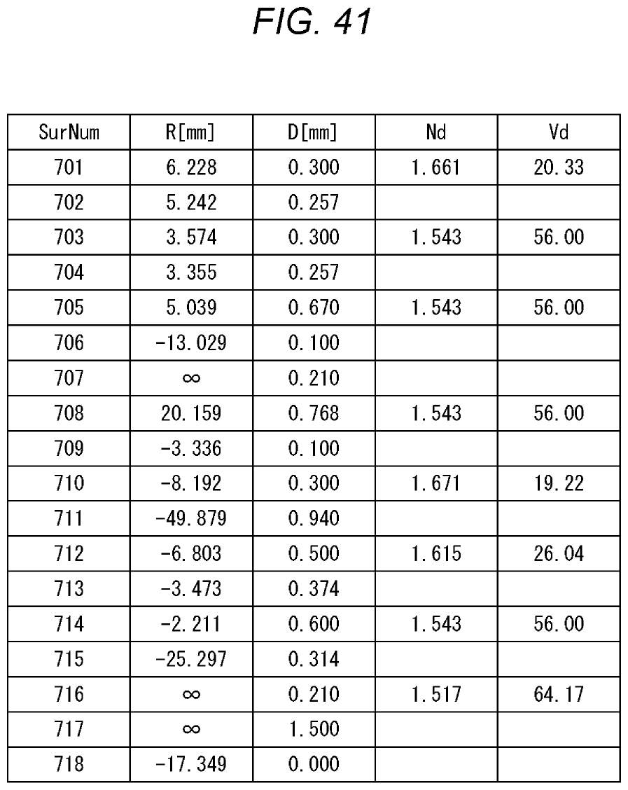

FIG. 41 is a table illustrating examples of various setting values of the lenses 771 to 777, the aperture stop 762, the infrared cut filter 114, and the imaging surface 733a.

The second and subsequent rows from the top in the table of FIG. 41 correspond to the surfaces 771a to 777a, the surfaces 771b to 777b, the surface of the aperture stop 762, the surfaces 114a and 114b, and the imaging surface 733a, respectively. The respective columns are similar to the columns in FIG. 5.

In the present specification, it is assumed that surface numbers from 701 to 706 are sequentially assigned to the surfaces 771a, 771b, 772a, 772b, 773a, and 773b. It is assumed that surface numbers from 707 to 718 are sequentially assigned to the surface of the aperture stop 762, the surfaces 774a, 774b, 775a, 775b, 776a, 776b, 777a, 777b, 114a, and 114b, and the imaging surface 733a.

Note that, although not described, the curvature radius R, the surface interval D, the refractive index Nd, and the Abbe number Vd of each of the surfaces 771a to 777a are values illustrated in the table of FIG. 41. The curvature radius R and the surface interval D of each of the surfaces 771b to 777b are values illustrated in the table of FIG. 41.

Since the surface of the aperture stop 762 and the surfaces 114a and 114b are planar, the curvature radius R corresponding to the surface numbers SurNum of 707, 716, and 717 is infinite. Note that, although not described, the surface interval D between the surface of the aperture stop 762 and the surface 114b, and the surface interval D, the refractive index Nd, and the Abbe number Vd of the surface 114a are values illustrated in the table of FIG. 41.

The curvature radius R of the imaging surface 733a having the surface number SurNum of 718 is −17.349. Since there is no surface to which the surface number SurNum of 718 is assigned after 717, the surface interval D is 0.

### <Example of Aspherical Data of Each Surface of Lens>

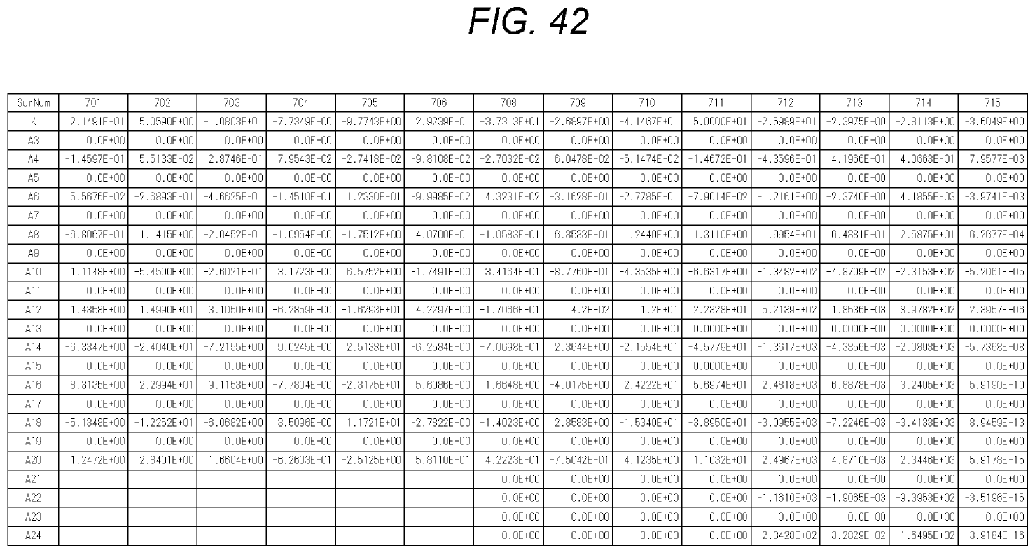

FIG. 42 is a table illustrating an example of aspherical data of the surfaces 771a to 777a and the surfaces 771b to 777b.

Rows in the table of FIG. 42 are respectively similar to the rows in the table of FIG. 12. The respective columns correspond to the surfaces 771a, 771b, 772a, 772b, 773a, 773b, 774a, 774b, 775a, 775b, 776a, 776b, 777a, and 777b in order from the left.

Note that, although not described, the conic coefficient K and the third-order aspherical coefficient A3 to 20th-order aspherical coefficient A20 of each of the surfaces 771a to 773a and the surfaces 771b to 773b are values illustrated in the table of FIG. 42. The conic coefficient K and the third-order aspherical coefficient A3 to 24th-order aspherical coefficient A24 of each of the surfaces 774a to 777a and the surfaces 774b to 777b are values illustrated in the table of FIG. 42.

### <Examples of Spherical Aberration, Field Curvature, and Distortion Aberration>

FIG. 43 is a graph illustrating an example of spherical aberration, field curvature, and distortion aberration generated in the imaging lens 716.

A of FIG. 43 is a graph illustrating spherical aberration for each wavelength of light having wavelengths of 486.1327 nm, 587.5618 nm, and 656.2725 nm, generated in the imaging lens 716. B of FIG. 43 is a graph illustrating a field curvature of light having the wavelength of 587.5618 nm, generated in the imaging lens 716. C of FIG. 43 is a graph illustrating distortion aberration of light having the wavelength of 587.5618 nm, generated in the imaging lens 716.

### <Example of Lateral Aberration>

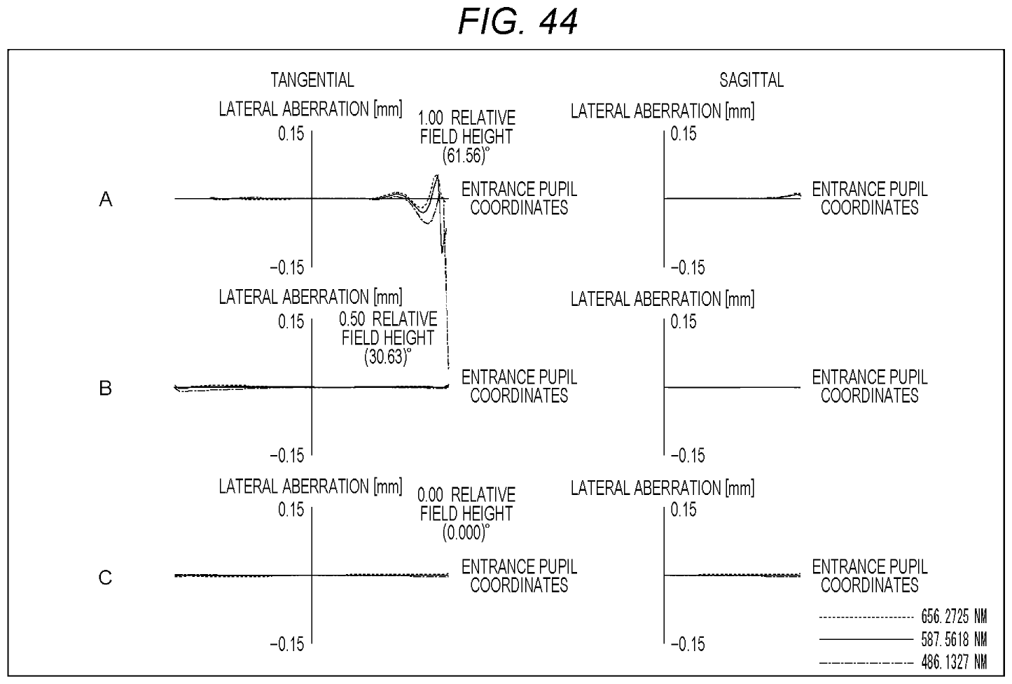

FIG. 44 is a graph illustrating an example of lateral aberration generated in the imaging lens 716.

FIG. 44 is a graph illustrating lateral aberration for each wavelength of light having wavelengths of 486.1327 nm, 587.5618 nm, and 656.2725 nm, generated in the imaging lens 716.

Specifically, the graphs on the left side in A to C of FIG. 44 represent the lateral aberration in the tangential direction at positions (positions of image heights in a case where half angles of view are 61.56°, 30.63°, and) 0° where the image heights are 1.00 mm, 0.50 mm, and 0.00 mm, respectively. The graphs on the right side in A to C of FIG. 44 represent lateral aberration in the sagittal direction at positions where the image heights are 1.00 mm, 0.50 mm, and 0.00 mm, respectively.

As illustrated in FIGS. 43 and 44, favorable aberration correction is performed in the imaging lens 716, and thus the imaging lens 716 has favorable imaging quality.

### 8. Eighth Embodiment

### <Configuration Example of Imaging Lens>

An imaging device according to an eighth embodiment to which the present technology is applied is different from the imaging device 100 in FIG. 2 in terms of an imaging lens and an imaging surface, and the other configurations are similar to those of the imaging device 100.

Therefore, the following description focuses on the imaging lens and the imaging surface.

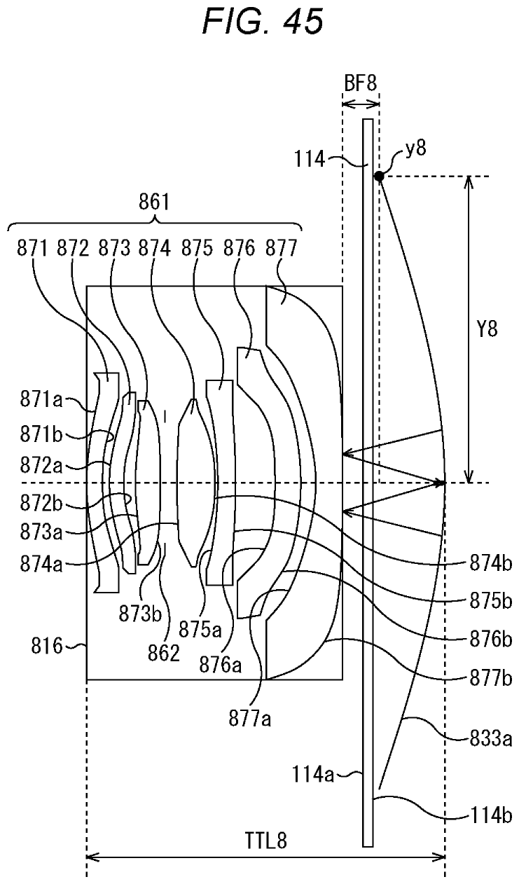

FIG. 45 is a cross-sectional view illustrating a configuration example of an imaging lens in an eighth embodiment of an imaging device to which the present technology is applied.

An imaging lens 816 in FIG. 45 includes a lens group 861 and an aperture stop 862.

The lens group 861 includes seven aspherical lenses 871 to 877. The seven lenses 871 to 877 are disposed in order from the object side toward the imaging surface 833a side. The lens 871 has a surface 871a on the object side and a surface 871b on the imaging surface 833a side.

Similarly to the lens 871, the lenses 872 to 877 also have surfaces 872a and 872b, surfaces 873a and 873b, surfaces 874a and 874b, surfaces 875a and 875b, surfaces 876a and 876b, and surfaces 877a and 877b, respectively.

The surfaces 871a to 877a and 871b to 877b are aspherical surfaces. The surface 877b (final surface) on the imaging surface 833a side of the lens 877 closest to the imaging surface 833a among the lenses 871 to 877 is an aspherical surface in which a sign of surface power is not inverted with increasing distance from the optical axis, and has a shape that tilts toward the object side with increasing distance from the optical axis. The aperture stop 862 is disposed between the lenses 873 and 874, and limits light incident to the lens 874 from the lens 873. The imaging surface 833a is an aspherical surface curved concavely toward the object side.

The light incident to the imaging lens 816 from an object is emitted via the lenses 871 to 877 and the infrared cut filter 114, and is collected on the imaging surface 833a.

Note that, hereinafter, the overall optical length of the imaging lens 816, which is a distance on the optical axis from the surface 871a (foremost surface) closest to the object side of the lens 871 closest to the object side among the lenses 871 to 877 to the imaging surface 833a, will be referred to as TTL8. A distance on the optical axis from a vertex on the optical axis of the surface 877b to a position y8 of the maximum image height Y8 of the imaging surface 833a, that is, a back focus of the imaging lens 816, will be referred to as BF8.

### <Example of Various Setting Values of Entire Imaging Lens>

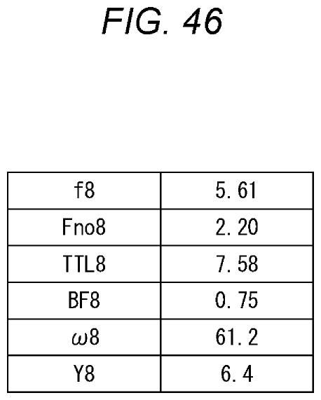

FIG. 46 is a table illustrating examples of various setting values of the entire imaging lens 816.

As illustrated in FIG. 46, a focal length f8 of the entire imaging lens 816 is 5.61 mm. An F value Fno8 of the imaging lens 816 is 2.20 and is 2.5 or less. The overall optical length TTL8 is 7.58 mm and the back focus BF8 is 0.75 mm. A maximum half angle of view ω8 of the imaging lens 816 is 61.2 degrees. That is, the maximum angle of view 2ω8 of the imaging lens 816 is 122.4 degrees and is 90 degrees or more. The maximum image height Y8 is 6.4 mm.

### <Examples of Various Setting Values of Each Lens, Aperture Stop, Imaging Surface, and Infrared Cut Filter>

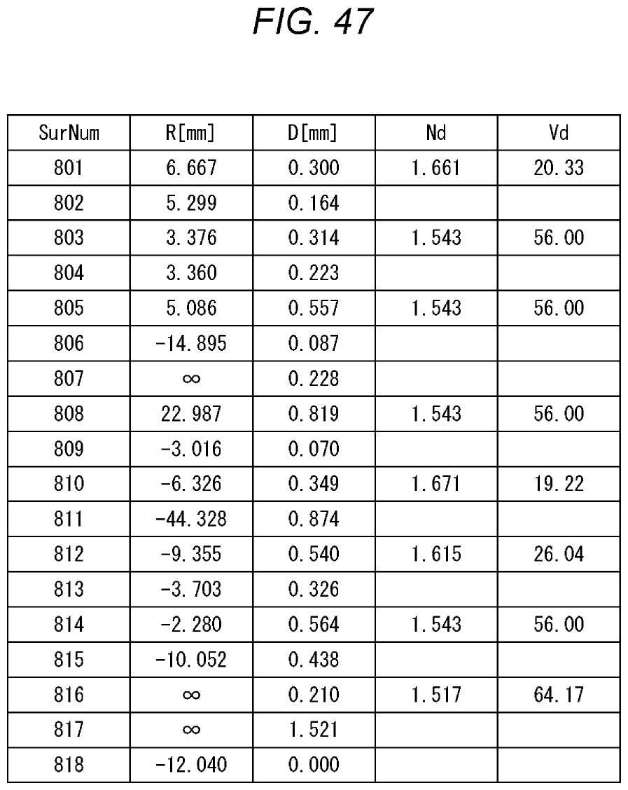

FIG. 47 is a table illustrating examples of various setting values of the lenses 871 to 877, the aperture stop 862, the infrared cut filter 114, and the imaging surface 833a.

The second and subsequent rows from the top in the table of FIG. 47 correspond to the surfaces 871a to 877a, the surfaces 871b to 877b, the surface of the aperture stop 862, the surfaces 114a and 114b, and the imaging surface 833a, respectively. The respective columns are similar to the columns in FIG. 5.

In the present specification, it is assumed that surface numbers from 801 to 803 are sequentially assigned to the surfaces 871a, 871b, 872a, 872b, 873a, and 873b. It is assumed that surface numbers from 804 to 818 are sequentially assigned to the surface of the aperture stop 862, the surfaces 874a, 874b, 875a, 875b, 876a, 876b, 877a, 877b, 114a, and 114b, and the imaging surface 833a.

Note that, although not described, the curvature radius R, the surface interval D, the refractive index Nd, and the Abbe number Vd of each of the surfaces 871a to 877a are values illustrated in the table of FIG. 47. The curvature radius R and the surface interval D of each of the surfaces 871b to 877b are values illustrated in the table of FIG. 47.

Since the surface of the aperture stop 862 and the surfaces 114a and 114b are planar, the curvature radius R corresponding to the surface numbers SurNum of 807, 816, and 817 is infinite. Note that, although not described, the surface interval D between the surface of the aperture stop 862 and the surface 114b, and the surface interval D, the refractive index Nd, and the Abbe number Vd of the surface 114a are values illustrated in the table of FIG. 47.

The curvature radius R of the imaging surface 833a having the surface number SurNum of 818 is −12.040. Since there is no surface to which the surface number SurNum of 818 is assigned after 817, the surface interval D is 0.

### <Example of Aspherical Data of Each Surface of Lens and Imaging Surface>

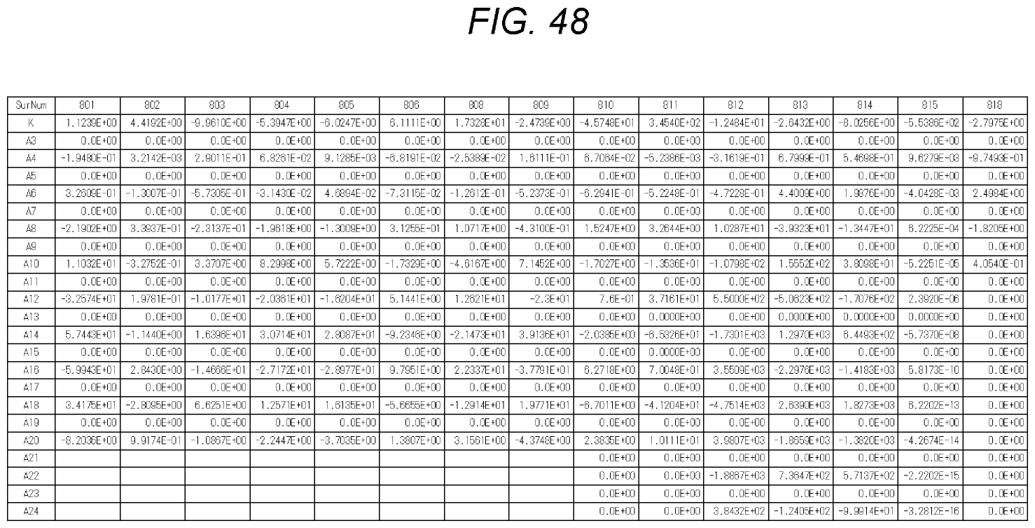

FIG. 48 is a table illustrating an example of aspherical data of the surfaces 871a to 877a, the surfaces 871b to 877b, and the imaging surface 833a.

Rows in the table of FIG. 48 are respectively similar to the rows in the table of FIG. 12. The respective columns correspond to the surfaces 871a, 871b, 872a, 872b, 873a, 873b, 874a, 874b, 875a, 875b, 876a, 876b, 877a, and 877b, and the imaging surface 833a in order from the left.

Note that, although not described, the conic coefficient K and the third-order aspherical coefficient A3 to 20th-order aspherical coefficient A20 of each of the surfaces 871a to 874a and the surfaces 871b to 874b are values illustrated in the table of FIG. 48. The conic coefficient K and the third-order aspherical coefficient A3 to 24th-order aspherical coefficient A24 of each of the surfaces 875a to 877a and the surfaces 875b to 877b and the imaging surface 833a are values illustrated in the table of FIG. 48.

### <Examples of Spherical Aberration, Field Curvature, and Distortion Aberration>

FIG. 49 is a graph illustrating an example of spherical aberration, field curvature, and distortion aberration generated in the imaging lens 816.

A of FIG. 49 is a graph illustrating spherical aberration for each wavelength of light having wavelengths of 486.1327 nm, 587.5618 nm, and 656.2725 nm, generated in the imaging lens 816. B of FIG. 49 is a graph illustrating a field curvature of light having the wavelength of 587.5618 nm, generated in the imaging lens 816. C of FIG. 49 is a graph illustrating distortion aberration of light having the wavelength of 587.5618 nm, generated in the imaging lens 816 in FIG. 45.

### <Example of Lateral Aberration>

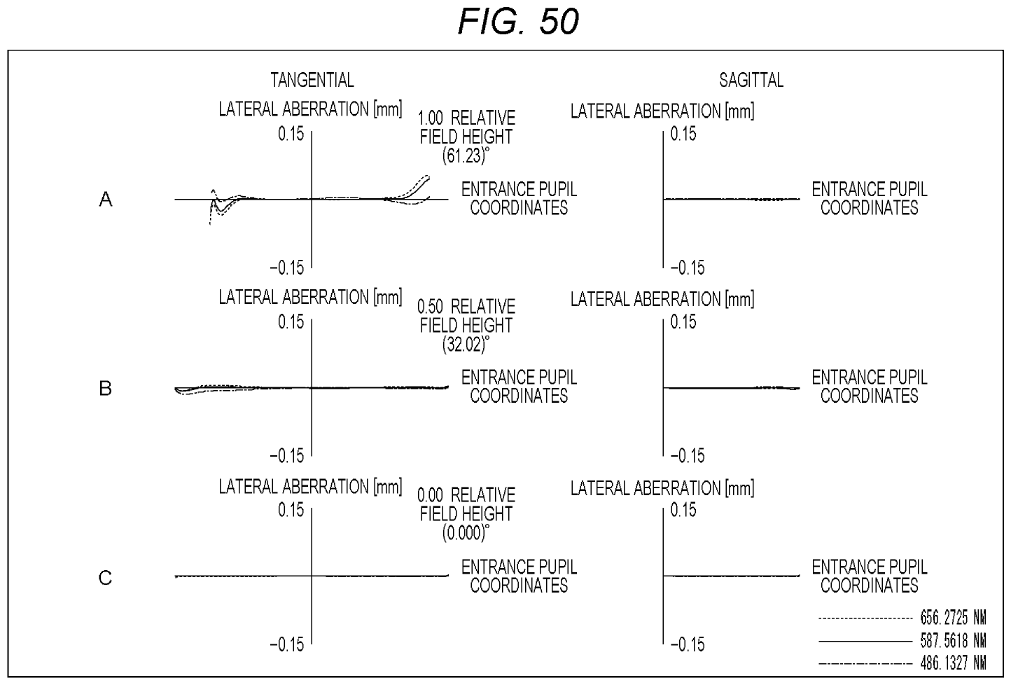

FIG. 50 is a graph illustrating an example of lateral aberration generated in the imaging lens 816.

FIG. 50 is a graph illustrating lateral aberration for each wavelength of light having wavelengths of 486.1327 nm, 587.5618 nm, and 656.2725 nm, generated in the imaging lens 816.

Specifically, the graphs on the left side in A to C of FIG. 50 represent the lateral aberration in the tangential direction at positions (positions of image heights in a case where half angles of view are 61.23°, 32.02°, and) 0° where the image heights are 1.00 mm, 0.50 mm, and 0.00 mm, respectively. The graphs on the right side in A to C of FIG. 50 represent lateral aberration in the sagittal direction at positions where the image heights are 1.00 mm, 0.50 mm, and 0.00 mm, respectively.

As illustrated in FIGS. 49 and 50, favorable aberration correction is performed in the imaging lens 816, and thus the imaging lens 816 has favorable imaging quality.

As described above, in the imaging lens 116, since the imaging surface 133a is curved concavely toward the object side, the position of the aperture stop 162 and the center of curvature of the imaging surface 133a can be brought close to each other. Therefore, the imaging lens 116 is also advantageous in terms of improving an ambient light amount and relaxing a light incident angle on the imaging surface 133a in addition to various aberration corrections. The same applies to the imaging lenses 216, 316, 416, 516, 616, 716, and 816.

In the imaging lens 116, since the number of lenses 171 to 177 configuring the lens group 161 is six or more, the imaging lens 116 can achieve both a large aperture with the F value Fno1 of 2.5 or less and an aperture angle.

The same applies to the imaging lenses 216, 316, 416, 516, 616, 716, and 816.

Note that, in the imaging lens 116, since the number of lenses 171 to 177 configuring the lens group 161 is seven or more, it is possible to further perform favorable aberration correction on a screen peripheral portion.

The same applies to the imaging lenses 216, 316, 416, 616, 716, and 816.

### <Example of Parameter>

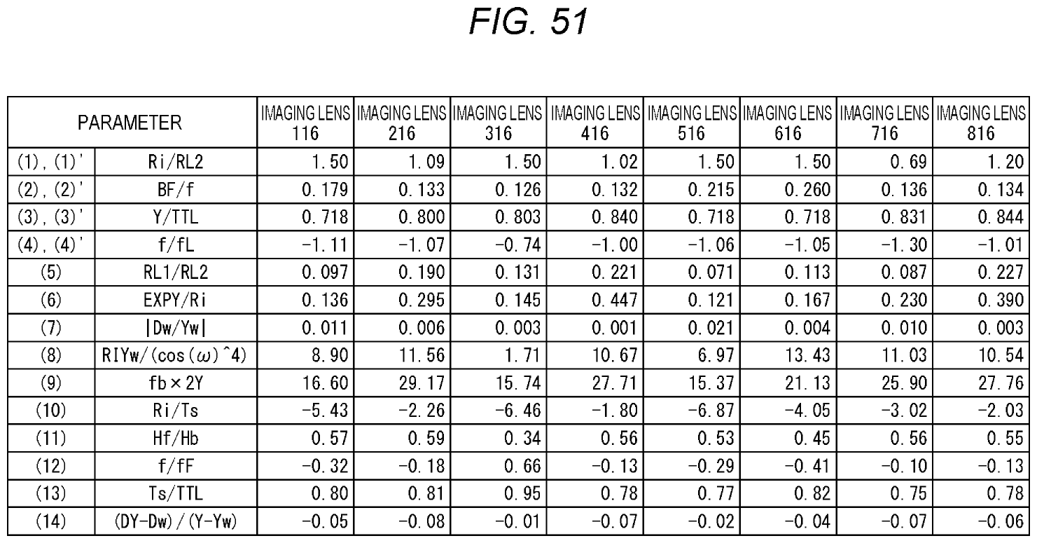

FIG. 51 is a table illustrating values of various parameters in the imaging lens 116 (216, 316, 416, 516, 616, 716, and 816).

In the table of FIG. 51, the second and subsequent rows from the top respectively correspond to Ri/RL2, BF/f, Y/TTL, f/fL, RL1/RL2, EXPY/Ri, |Dw/Yw|, RIYw/(cos (ω)⁴), fb×2Y, Ri/Ts, Hf/Hb, f/fF, Ts/TTL, and (DY−Dw)/(Y−Yw) in order from the top. The second and subsequent columns from the left respectively correspond to the imaging lenses 116, 216, 316, 416, 516, 616, 716, and 816 in order from the left.

Note that Ri is a curvature radius R of the imaging surface 133a (233a, 333a, 433a, 533a, 633a, 733a, and 833a). RL2 is a curvature radius R of the surface 177b (277b, 377b, 477b, 576b, 677b, 777b, and 877b). BF is a generic term for the back foci BF1 to BF8, and f is a generic term for the focal lengths f1 to f8. Y is a generic term for the maximum image heights Y1 to Y8, and TTL is a generic term for the overall optical lengths TTL1 to TTL8. fL is a focal length of lens 177 (277, 377, 477, 576, 677, 777, and 877).

RL1 is the curvature radius R of the surface 177a (277a, 377a, 477a, 576a, 677a, 777a, and 877a). EXPY is an exit pupil position of the maximum image height ray. Dw is optical distortion in a case where the half angle of view is 40 degrees, and Yw is an image height in a case where the half angle of view is 40 degrees. RIYw is an ambient light amount ratio with respect to the center of the imaging surface 133a (233a, 333a, 433a, 533a, 633a, 733a, and 833a) in a case where the half angle of view is 40 degrees. ω is a generic term for the maximum half angles of view ω1 to ω8.

fb is a distance on the optical axis from the surface 177b (277b, 377b, 477b, 576b, 677b, 777b, and 877b) to the imaging surface 133a (233a, 333a, 433a, 533a, 633a, 733a, and 833a). Ts is a distance on the optical axis from the aperture stop 162 (262, 362, 462, 562, 662, 762, and 862) to the imaging surface 133a (233a, 333a, 433a, 533a, 633a, 733a, and 833a).

Hf is the maximum effective radius of the surface 171a (271a, 371a, 471a, 571a, 671a, 771a, and 871a). Hb is the maximum effective radius of the surface 177b (277b, 377b, 477b, 576b, 677b, 777b, and 877b). fF is a focal length of the lens 171 (271, 371, 471, 571, 671, 771, and 871). DY is optical distortion in a case where an image height is the maximum image height.

As illustrated in the table of FIG. 51, in the imaging lens 116 (216, 316, 416, 516, 616, 716, and 816), Ri/RL2 satisfies the following conditional expressions (1) and (1)′.

$$0.5 \leq Ri / RL 2 \leq 1.5 \qquad ( 1 )$$

$$0.65 \leq Ri / RL 2 \leq 1.5 \qquad {( 1 )}^{′}$$

The conditional expressions (1) and (1)′ define a relationship between the curvature radius R of the imaging surface 133a (233a, 333a, 433a, 533a, 633a, 733a, and 833a) and the curvature radius R of the surface 177b (277b, 377b, 477b, 576b, 677b, 777b, and 877b). A range satisfying the conditional expression (1)′ is narrower than a range satisfying the conditional expression (1).

When Ri/RL2 exceeds the upper limit value of the conditional expression (1), the imaging surface 133a (233a, 333a, 433a, 533a, 633a, 733a, and 833a) approaches a plane. Therefore, it is difficult to correct spherical aberration and a light beam incident angle on the imaging surface 133a (233a, 333a, 433a, 533a, 633a, 733a, and 833a). As a result, a resolution and an ambient light amount ratio of a captured image deteriorate.

On the other hand, when Ri/RL2 is less than the lower limit value of the conditional expression (1), the curvature radius Ri becomes too small, and an inclination amount of the imaging surface 133a (233a, 333a, 433a, 533a, 633a, 733a, and 833a) toward the object side becomes large. Therefore, it is difficult to secure the back focus BF. Since the imaging surface 133a (233a, 333a, 433a, 533a, 633a, 733a, and 833a) is curved, it is important to secure the back focus BF in order to avoid physical interference between the infrared cut filter 114 and the imaging surface 133a. Note that it is more desirable that Ri/RL satisfies the conditional expression (1)′.

As illustrated in the table of FIG. 51, in the imaging lens 116 (216, 316, 416, 516, 616, 716, and 816), BF/f satisfies the following conditional expressions (2) and (2)′.

$$0.1 < BF / f < 0.3 \qquad ( 2 )$$

$$0.12 < BF / f < 0 \text{.265} \qquad {( 2 )}^{′}$$

The conditional expressions (2) and (2)′ are conditional expressions for securing an appropriate amount of the back focus BF. A range satisfying the conditional expression (2)′ is narrower than a range satisfying the conditional expression (2).

When BF/f exceeds the upper limit value of the conditional expression (2), the back focus BF becomes longer than necessary. Therefore, the overall optical length TTL becomes long, and it is difficult to reduce the height of the imaging lens 116 (216, 316, 416, 516, 616, 716, and 816).

On the other hand, when BF/f is less than the lower limit value of the conditional expression (2), the focal length f becomes long, and it is difficult to widen an angle of the imaging lens 116 (216, 316, 416, 516, 616, 716, and 816). As a result, the back focus BF is shortened.

Therefore, the intensity of the ghost light due to reflection between the surface 177b (277b, 377b, 477b, 576b, 677b, and 777b) and the imaging surface 133a (233a, 333a, 433a, 533a, 633a, 733a, and 833a) increases. Note that it is more desirable that BF/f satisfies the conditional expression (2)′.

In a case where the conditional expressions (1) and (2) are satisfied, the air interval between the surface 177b (277b, 377b, 477b, 576b, 677b, and 777b) and the imaging surface 133a (233a, 333a, 433a, 533a, 633a, 733a, and 833a) is equal to or more than a certain value.

Therefore, it is easy to secure the back focus BF and the manufacturing margin. As a result, the overall optical length TTL can be shortened.

Furthermore, it is possible to curb the intensity of ghost light due to reflection from the surface 177b (277b, 377b, 477b, 576b, 677b, and 777b) and the imaging surface 133a (233a, 333a, 433a, 533a, 633a, 733a, and 833a). As illustrated in the table of FIG. 51, in the imaging lens 116 (216, 316, 416, 516, 616, 716, and 816), Y/TTL satisfies the following conditional expression (3).

$$Y / TTL > 0.7 \qquad ( 3 )$$

$$0.7 < Y / TTL < 1. \qquad {( 3 )}^{′}$$

The conditional expressions (3) and (3)′ define the overall optical length TTL. A range satisfying the conditional expression (3)′ is narrower than a range satisfying the conditional expression (3).

When Y/TTL exceeds the upper limit value of the conditional expression (3), it is difficult to accommodate the imaging device 100 in a desired casing of a mounting apparatus that is an apparatus on which the imaging device 100 is mounted. As a result, the usability and design of the mounting apparatus are impaired, or the size thereof is enlarged.

On the other hand, when Y/TTL is less than the lower limit value of the conditional expression (3), an amount of curvature of the imaging element 133 is too large.

Therefore, it becomes difficult to manufacture the imaging element 133. In addition, it is difficult to perform aberration correction utilizing the curvature of the imaging surface 133a (233a, 333a, 433a, 533a, 633a, 733a, and 833a), and a desired resolution cannot be obtained in a captured image. Note that it is more desirable that Y/TTL satisfies the conditional expression (3)′.

As illustrated in the table of FIG. 51, in the imaging lens 116 (216, 316, 416, 516, 616, 716, and 816), f/fL satisfies the following conditional expressions (4) and (4)′.

$$f / fL < - 0.6 \qquad ( 4 )$$

$$- 1.5 < f / fL < - 0.7 \qquad {( 4 )}^{′}$$

The conditional expressions (4) and (4)′ define the focal length fL of the lens 177 (277, 377, 477, 576, 677, 777, and 877). A range satisfying the conditional expression (4)′ is narrower than a range satisfying the conditional expression (4).

When f/fL exceeds the upper limit value of the conditional expression (4), the refractive power of the lens 177 (277, 377, 477, 576, 677, 777, and 877) becomes too strong, and it is difficult to correct the distortion aberration.

On the other hand, when f/fL is less than the lower limit value of the conditional expression (4), it is difficult to sufficiently perform aberration correction in the lens 177 (277, 377, 477, 576, 677, 777, and 877). Furthermore, a light beam incident angle on the imaging surface 133a (233a, 333a, 433a, 533a, 633a, 733a, and 833a) increases, and a resolution and an ambient light amount ratio of a captured image deteriorate. Note that it is more desirable that f/fL satisfies the conditional expression (4)′.

As illustrated in the table of FIG. 51, in the imaging lens 116 (216, 316, 416, 516, 616, 716, and 816), RL1/RL2 satisfies the following conditional expression (5).

$$0.05 \leq RL 1 / RL 2 \leq 0.3 \qquad ( 5 )$$

The conditional expression (5) defines the curvature radii R of the surface 177a (277a, 377a, 477a, 576a, 677a, 777a, and 877a) and the surface 177b (277b, 377b, 477b, 576b, 677b, 777b, and 877b).

In a case where the conditional expression (5) is satisfied, ghost light due to reflection between the surface 177b (277b, 377b, 477b, 576b, 677b, 777b, and 877b) and the imaging surface 133a (233a, 333a, 433a, 533a, 633a, 733a, and 833a) can be curbed.

On the other hand, when RL1/RL2 exceeds the upper limit value of the conditional expression (5), the curvature radii R of the surface 177a (277a, 377a, 477a, 576a, 677a, 777a, and 877a) and the imaging surface 133a (233a, 333a, 433a, 533a, 633a, 733a, and 833a) are too close.

Therefore, ghost light is not diverged and is collected with high intensity.

On the other hand, when RL1/RL2 is less than the lower limit value of the conditional expression (5), the optical power of the lens 177 (277, 377, 477, 576, 677, 777, and 877) becomes too high, and it is difficult to correct distortion aberration and astigmatism. In addition, processing of the lens 177 (277, 377, 477, 576, 677, 777, and 877) is also difficult.

As illustrated in the table of FIG. 51, in the imaging lens 116 (216, 316, 416, 516, 616, 716, and 816), EXPY/Ri satisfies the following conditional expression (6).

$$0.01 \leq EXPY / Ri \leq 0.45 \qquad ( 6 )$$

The conditional expression (6) defines the exit pupil, thereby defining a light beam incident angle on the imaging surface 133a (233a, 333a, 433a, 533a, 633a, 733a, and 833a).

When EXPY/Ri exceeds the upper limit value of the conditional expression (6), an amount of curvature of the imaging element 133 is too large, it is difficult to manufacture the imaging device 100, or the overall optical length TTL increases. On the other hand, when EXPY/Ri is less than the lower limit value of the conditional expression (6), pupil correction using a microlens provided on a pixel cannot be appropriately performed, and as a result, an amount of light incident to the imaging element 133 decreases, and an SN ratio of a captured image deteriorates.

As illustrated in the table of FIG. 51, |Dw/Yw| satisfies the following conditional expression (7) in the imaging lens 116 (216, 316, 416, 516, 616, 716, and 816).

$$0.001 \leq \vert Dw / Yw \vert \leq 0.08 \qquad ( 7 )$$

The conditional expression (7) defines optical distortion in a case where an angle of view is within 80 degrees at which an imaging frequency is the highest. When |Dw/Yw| exceeds the upper limit value of the conditional expression (7), it is necessary to correct the distortion aberration in the signal processing unit 105 and the like at the subsequent stage, and as a result, a resolution of a captured image deteriorates and the power consumption increases. On the other hand, when |Dw/Yw| is less than the lower limit value of the conditional expression (7), it is difficult to manufacture a shape of the imaging lens 116 (216, 316, 416, 516, 616, 716, and 816), or the number of lenses necessary for correcting the distortion aberration increases.

As illustrated in the table of FIG. 51, in the imaging lens 116 (216, 316, 416, 516, 616, 716, and 816), RIYw/(cos (ω)⁴) satisfies the following conditional expression (8).

$$1.2 \leq RIYw / ( {cos ( ω )}^{4} ) \leq 35 \qquad ( 8 )$$

The conditional expression (8) defines an ambient light amount ratio in a case where an angle of view is within 80 degrees at which an imaging frequency is the highest.

When RIYw/(cos (ω)⁴) exceeds the upper limit value of the conditional expression (8), the overall optical length TTL becomes extremely large, and thus it is difficult to accommodate the imaging device 100 in a desired casing of a mounting apparatus. On the other hand, when RIYw/(cos (ω)⁴) is less than the lower limit value of the conditional expression (8), signal noise when light amount correction is performed in a peripheral portion of a captured image increases. As a result, the image quality in a dark place greatly deteriorates in the captured image having an angle of view with the highest imaging frequency.

As illustrated in the table of FIG. 51, in the imaging lens 116 (216, 316, 416, 516, 616, 716, and 816), fb×2Y satisfies the following conditional expression (9).

$$9. 7 \leq fb \times 2 Y \leq 29.4 \qquad ( 9 )$$

When fb×2Y exceeds the upper limit value of the conditional expression (9), the negative optical power of the lens 171 (271, 371, 471, 571, 671, 771, and 871) becomes strong, and it is difficult to correct the distortion aberration. On the other hand, when fb×2Y is less than the lower limit value of the conditional expression (9), a shape of each component of the imaging device 100 is complicated, and it is difficult to manufacture the imaging device 100. In addition, there is an increasing risk that the imaging lens 116 (216, 316, 416, 516, 616, 716, and 816), the infrared cut filter 114, and the imaging element 133 are damaged at the time of focus adjustment or drop impact.

As illustrated in the table of FIG. 51, in the imaging lens 116 (216, 316, 416, 516, 616, 716, and 816), Ri/Ts satisfies the following conditional expression (10).

$$- 50 \leq Ri / Ts \leq - 1.7 \qquad ( 10 )$$

When Ri/Ts exceeds the upper limit value of the conditional expression (10), an amount of curvature of the imaging surface 133a (233a, 333a, 433a, 533a, 633a, 733a, and 833a) is too large. Therefore, defects such as cracks and cracks in the imaging element 133 increase, and it becomes difficult to manufacture the imaging device 100. On the other hand, when Ri/Ts is less than the lower limit value of the conditional expression (10), the effect due to the curvature of the imaging surface 133a (233a, 333a, 433a, 533a, 633a, 733a, and 833a) cannot be sufficiently obtained, and as a result, the overall optical length TTL increases.

As illustrated in the table of FIG. 51, in the imaging lens 116 (216, 316, 416, 516, 616, 716, and 816), Hf/Hb satisfies the following conditional expression (11).

$$0.47 5 \leq Hf / Hb \leq 0.68 \qquad ( 11 )$$

When Hf/Hb exceeds the upper limit value of the conditional expression (11), the overall optical length TTL increases, and an occupied area of the imaging lens 116 (216, 316, 416, 516, 616, 716, and 816) in a mounting apparatus becomes too large. Therefore, it is difficult to dispose a peripheral member and a protective glass in the mounting apparatus. On the other hand, when Hf/Hb is less than the lower limit value of the conditional expression (11), the imaging lens 116 (216, 316, 416, 516, 616, 716, and 816) becomes a so-called telephoto lens.

Therefore, with the ultra-wide angle, it becomes difficult to secure an ambient light amount and a back focus.

As illustrated in the table of FIG. 51, in the imaging lens 116 (216, 316, 416, 516, 616, 716, and 816), f/fF satisfies the following conditional expression (12).

$$- 0.35 \leq f / fF \leq 0.73 \qquad ( 12 )$$

When f/fF exceeds the upper limit value of the conditional expression (12), the imaging lens 116 (216, 316, 416, 516, 616, 716, and 816) becomes a so-called telephoto lens. Therefore, the focal length f becomes long, and it is difficult to achieve wide angle. In addition, it is difficult to extend the back focus BF.

On the other hand, when f/fF is less than the lower limit value of the conditional expression (12), the distortion aberration increases, and image quality of a captured image remarkably deteriorates. Although the deterioration in the image quality can be curbed by correcting distortion aberration in the signal processing unit 105 and the like at the subsequent stage, in this case, deterioration in a resolution of the captured image and an increase in power consumption occur.

As illustrated in the table of FIG. 51, fs/TTL satisfies the following conditional expression (13) in the imaging lens 116 (216, 316, 416, 516, 616, 716, and 816).

$$0.73 \leq Ts / TTL \leq 0.9 \qquad ( 13 )$$

When fs/TTL exceeds the upper limit value of the conditional expression (13), it becomes difficult to secure the ambient light amount and the back focus BF due to the ultra-wide angle. On the other hand, when fs/TTL is less than the lower limit value of the conditional expression (13), the overall optical length TTL becomes extremely large. Alternatively, pupil correction by a microlens provided on a pixel cannot be appropriately performed, and as a result, an SN ratio of a captured image deteriorates due to an insufficient amount of light incident to the imaging element 133.

As illustrated in the table of FIG. 51, in the imaging lens 116 (216, 316, 416, 516, 616, 716, and 816), (DY−Dw)/(Y−Yw) satisfies the following conditional expression (14).

$$- 0.16 \leq ( DY - Dw ) / ( Y - Yw ) \leq 0.16 \qquad ( 14 )$$

When (DY−Dw)/(Y−Yw) exceeds the upper limit value or is less than the lower limit value of the conditional expression (14), distortion aberration in the ultra-wide angle region becomes too large, and high-frequency information of a subject disappears in a captured image.

Therefore, even in a case where the distortion aberration is corrected by the signal processing unit 105 or the like at the subsequent stage, a peripheral resolution of the captured image remarkably deteriorates. In addition, a difference in peripheral image quality level between the wide-angle region and the ultra-wide-angle region becomes too large.

As described above, the imaging lens 116 includes the lens group 161 including the lenses 171 to 177, which are seven aspherical lenses, that form an optical image of an object on the imaging surface 133a curved concavely toward the object side. The surface 177b is an aspherical surface in which a sign of surface power is not inverted with increasing distance from the optical axis, and has a shape that tilts toward the object side with increasing distance from the optical axis. Then, the imaging lens 116 satisfies the conditional expression (2). Therefore, the intensity of ghost light due to reflection of the surface 177b and the imaging surface 133a can be curbed. As a result, deterioration in image quality of a captured image due to the ghost light can be curbed. The same applies to the imaging lenses 216, 316, 416, 516, 616, 716, and 816.

Note that the infrared cut filter 114 may be curved. In this case, it is easy to secure a distance between the infrared cut filter 114 and the lens 177 (277, 377, 477, 576, 677, 777, and 877). Therefore, the overall optical length TTL can be shortened.

A shape of the imaging surface 133a (233a, 333a, 433a, 533a, 633a, 733a, and 833a) may be any shape such as a free-form surface in addition to a spherical surface or an aspherical surface for convenience of design or manufacturing, but is desirably a spherical surface that is generally easy to manufacture.

The maximum angles of view 2ω1 to 2ω8 are desirably 93 degrees or more and 145 degrees or less.

A nanostructure may be provided on the imaging surface 133a (233a, 333a, 433a, 533a, 633a, 733a, and 833a). As this nanostructure, for example, there is a nanostructure having a pupil correction function of efficiently allowing light incident to the imaging surface 133a (233a, 333a, 433a, 533a, 633a, 733a, and 833a) to enter the pixel. Examples of the nanostructure include a nanostructure having a color separation function as a substitute for a color filter, a nanostructure having an antireflection function excellent in angle characteristics, and a nanostructure having a function of expanding a focal depth by parallel arrangement of minimum lenses. In general, since the nanostructure has low light use efficiency at the time of oblique incidence, it is preferable to combine the nanostructure with the curved imaging surface 133a (233a, 333a, 433a, 533a, 633a, 733a, and 833a).

The nanostructure having a pupil correction function is desirably formed from the central portion to the intermediate region of the imaging region of the imaging surface 133a (233a, 333a, 433a, 533a, 633a, 733a, and 833a). The intermediate region may be appropriately set according to the purpose of use, and may be, for example, an imaging region in a case where the half angle of view is 40 degrees.

The nanostructure having a color separation function is desirably formed in a peripheral region of the imaging surface 133a (233a, 333a, 433a, 533a, 633a, 733a, and 833a). The peripheral region may be appropriately set according to the purpose of use, and may be, for example, an imaging region in a case where the half angle of view is 60 degrees.

Since the nanostructure having a pupil correction function is formed from the central portion to the intermediate region and the nanostructure having a color separation function is formed in the peripheral region, both the resolution of the intermediate region and the light use efficiency of the peripheral region can be improved. In a case where nanostructures having different functions are formed for each region, the nanostructures having different functions can be integrally formed according to a semiconductor process, so that it is possible to manufacture the nanostructures at a large area and at a low cost. Unnecessary light or deterioration in a resolution caused by the nanostructure and an image signal of a boundary portion of the region in a case where and the nanostructure having a different function for each region are formed can be corrected in the signal processing unit 105 or the like at the subsequent stage.

### <10. Application Example to Electronic Apparatus>

The present technology can be applied to, for example, a digital still camera, a digital video camera, a mobile terminal device such as a mobile phone or a smartphone having an imaging function, and various electronic apparatuses such as a monitor and a personal computer.

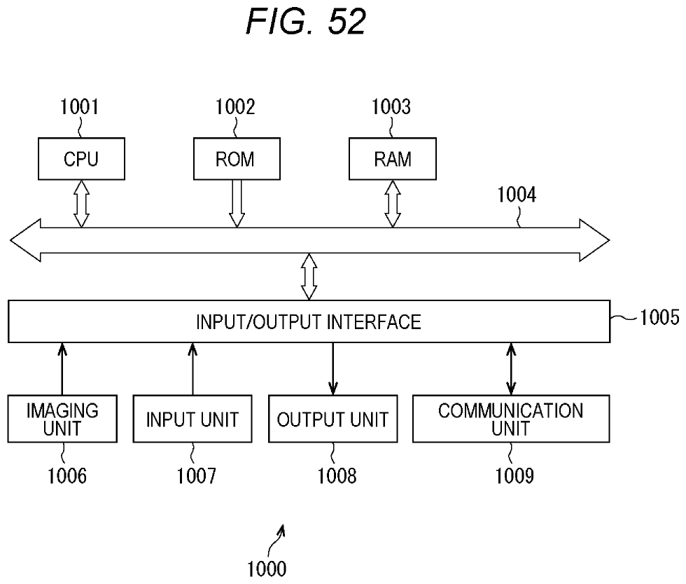

FIG. 52 is a block diagram illustrating a hardware configuration example of a smartphone as an electronic apparatus to which the present technology is applied.

In a smartphone 1000, a central processing unit (CPU) 1001, a read only memory (ROM) 1002, and a random access memory (RAM) 1003 are mutually connected via a bus 1004.

An input/output interface 1005 is further connected to the bus 1004. An imaging unit 1006, an input unit 1007, an output unit 1008, and a communication unit 1009 are connected to the input/output interface 1005.

The imaging unit 1006 includes the above-described imaging device 100 and the like. The imaging unit 1006 images a subject and acquires an image. This image is stored in the RAM 1003 or displayed on the output unit 1008. The input unit 1007 includes a touch pad which is a position input device configuring a touch panel, a microphone, and the like. The output unit 1008 includes a liquid crystal panel configuring a touch panel, a speaker, and the like. The communication unit 1009 includes a network interface and the like.

Also in the smartphone 1000 configured as described above, the above-described effects can be achieved by applying the imaging device 100 as the imaging unit 1006. That is, it is possible to curb deterioration in image quality of a captured image due to ghost light.

### <11. Usage Example of Imaging Device>

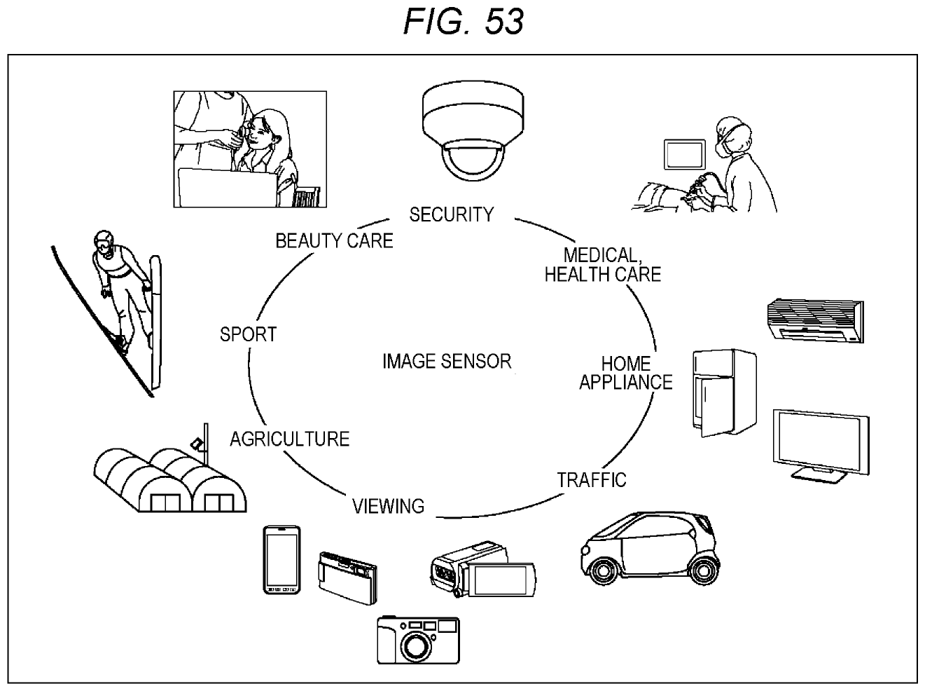

FIG. 53 is a diagram illustrating a usage example of using the above-described imaging device 100.

The above-described imaging device 100 can be used, for example, in various cases of sensing light such as visible light, infrared light, ultraviolet light, and X-rays as described below.
A device that captures an image to be used for viewing, such as a digital camera and a portable device with a camera function.
A device for traffic purpose such as an in-vehicle sensor which takes images of the front, rear, surroundings, interior and the like of an automobile, a surveillance camera for monitoring traveling vehicles and roads, and a ranging sensor which measures a distance between vehicles and the like for safe driving such as automatic stop, recognition of a driver's condition and the like.
A device for home appliance such as a television, a refrigerator, and an air conditioner that images a user's gesture and performs device operation according to the gesture
A device for medical and health care use such as an endoscope and a device that performs angiography by receiving infrared light
A device for security use such as a security monitoring camera and an individual authentication camera
A device used for beauty care, such as a skin measuring instrument for photographing skin, and a microscope for photographing the scalp
A device used for sport, such as an action camera or a wearable camera for sports applications or the like
A device used for agriculture, such as a camera for monitoring a condition of a field or crop.

### <12. Application Example to Endoscopic Surgical System>

Technology (present technology) according to the present disclosure is applicable to various products. For example, the technology according to the present disclosure may be applied to an endoscopic surgery system.

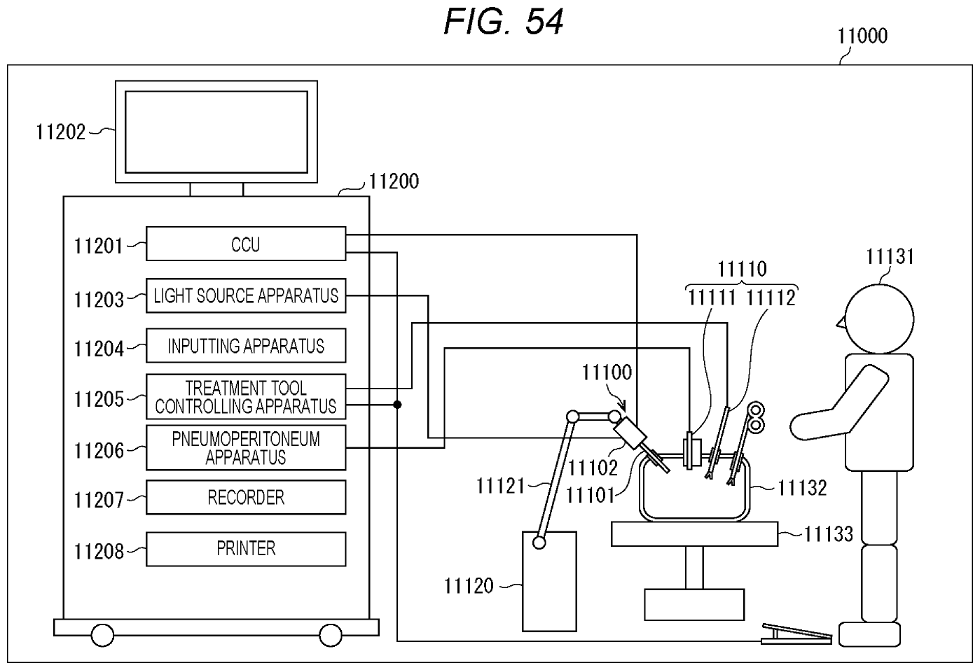

FIG. 54 is a diagram showing an example of a schematic configuration of an endoscopic surgery system to which the technology of the present disclosure (present technology) can be applied.

FIG. 54 illustrates a state in which an operator (doctor) 11131 is performing surgery on a patient 11132 on a patient bed 11133 using an endoscopic surgery system 11000. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type.

However, the endoscope 11100 may otherwise be included as a flexible endoscope having the lens barrel of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an imaging element are provided in the inside of the camera head 11102 such that reflected light (observation light) from the observation target is collected on the imaging element by the optical system.

The observation light is photo-electrically converted by the imaging element to generate an electric signal corresponding to the observation light, namely, an image signal corresponding to an observation image. The image signal is transmitted as RAW data to a camera control unit (CCU) 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal length or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203.

Further, in this case, if laser beams from the respective RGB laser light sources are irradiated time-divisionally on an observation target and driving of the imaging elements of the camera head 11102 are controlled in synchronism with the irradiation timings. Then images individually corresponding to the R, G and B colors can be also picked up time-divisionally. With this method, a color image can be obtained even if color filters are not provided to the imaging element.

Further, the light source apparatus 11203 may be controlled such that the intensity of light to be outputted is changed for each predetermined time. By controlling driving of the imaging element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed.

Alternatively, in the special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

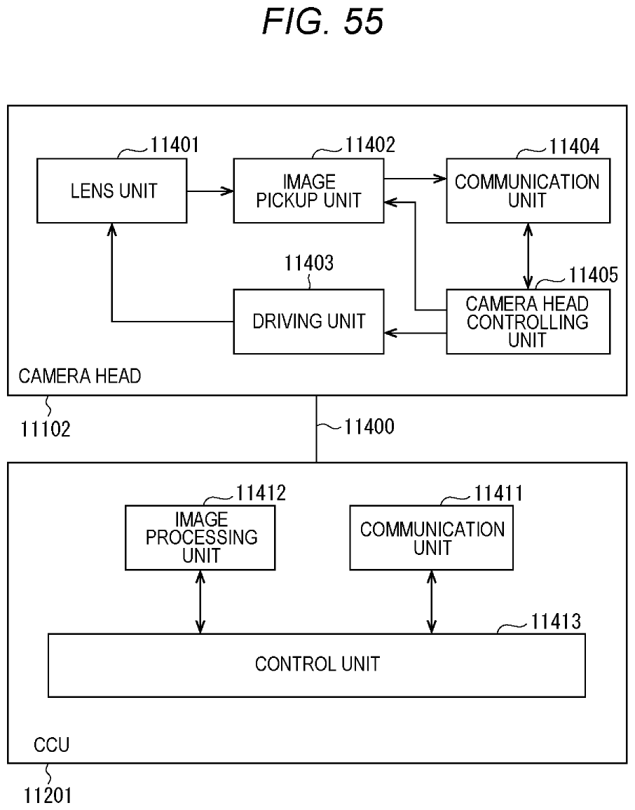

FIG. 55 is a block diagram illustrating an example of functional configurations of the camera head 11102 and the CCU 11201 illustrated in FIG. 54.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101.

Observation light taken in from a distal end of the lens barrel 11101 is guided to the camera head 11102 and introduced into the lens unit 11401. The lens unit 11401 includes a combination of a plurality of lenses including a zoom lens and a focusing lens.

The image pickup unit 11402 includes an imaging element.

The number of imaging elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the imaging elements, and the image signals may be synthesized to obtain a color image. Alternatively, the image pickup unit 11402 may include a pair of imaging elements for acquiring right-eye and left-eye image signals corresponding to three-dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual imaging elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405.

Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes, for example, the information regarding the imaging condition such as information specifying a frame rate of the captured image, information specifying an exposure value at the time of imaging, and/or information specifying the magnification and focus of the captured image.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition.

Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

An example of the endoscopic surgical system to which the technology according to the present disclosure can be applied has been described above. The technology according to the present disclosure can be applied to the lens unit 11401, the image pickup unit 11402, and the like among the above-described configurations.

Specifically, the imaging device 100 described above can be applied to the lens unit 11401, the image pickup unit 11402, and the driving unit 11403. By applying the technology according to the present disclosure to the lens unit 11401 and the image pickup unit 11402, it is possible to curb deterioration in image quality of a captured image due to ghost light. As a result, a high-quality surgical site image enables a surgeon to reliably confirm a surgical site, for example.

Note that, here, the endoscopic surgical system has been described as an example, but the technology according to the present disclosure may be applied to, for example, a microscopic surgical system or the like.

### <13. Application Example to Mobile Object>

Technology (present technology) according to the present disclosure is applicable to various products. For example, the technology according to the present disclosure may be implemented as a device mounted on any type of mobile object such as an automobile, an electric vehicle, a hybrid electric vehicle, a motorcycle, a bicycle, a personal mobility, an airplane, a drone, a ship, or a robot.

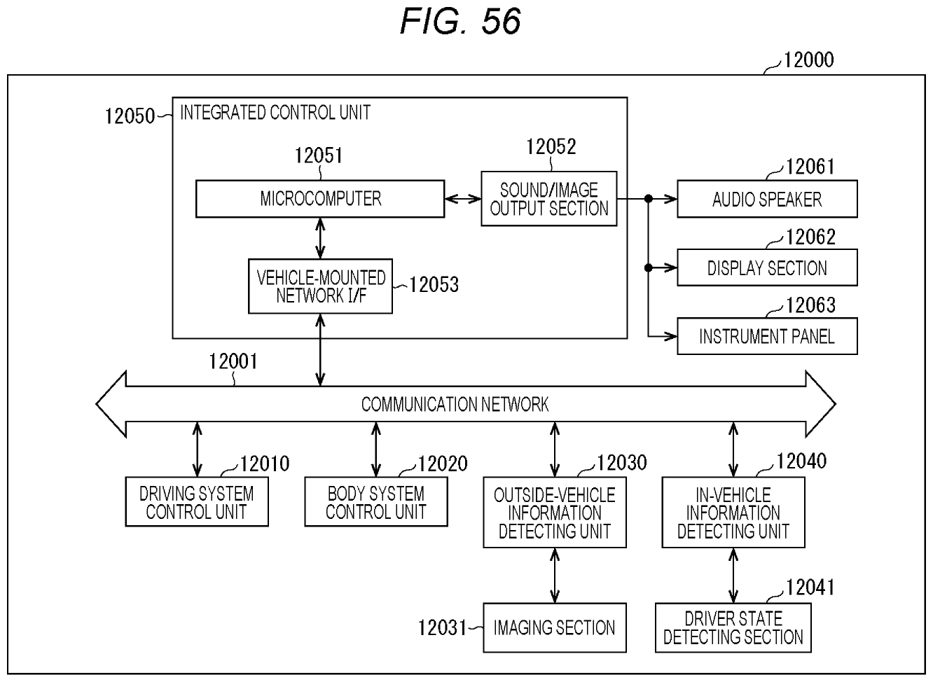

FIG. 56 is a block diagram illustrating a schematic configuration example of a vehicle control system which is an example of a moving body control system to which the technology according to the present disclosure can be applied.

The vehicle control system 12000 includes a plurality of electronic control units connected to each other via a communication network 12001. In the example depicted in FIG. 56, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls operations of devices related to a driving system of the vehicle in accordance with various kinds of programs. For example, the driving system control unit 12010 functions as a control device for a driving force generating device for generating a driving force of the vehicle, such as an internal combustion engine, a driving motor, or the like, a driving force transmitting mechanism for transmitting the driving force to wheels, a steering mechanism for adjusting a steering angle of the vehicle, a braking device for generating a braking force of the vehicle, and the like.

The body system control unit 12020 controls operations of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light.

The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041 includes, for example, a camera that images the driver. On the basis of detection information input from the driver state detecting section 12041, the in-vehicle information detecting unit 12040 may calculate a degree of fatigue of the driver or a degree of concentration of the driver, or may discriminate whether the driver is dozing.

The microcomputer 12051 can calculate a control target value for the driving force generating device, the steering mechanism, or the braking device on the basis of the information about the inside or outside of the vehicle obtained by the outside-vehicle information detecting unit 12030 or the in-vehicle information detecting unit 12040, and can output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

Furthermore, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle obtained by the outside-vehicle information detecting unit 12030. For example, the microcomputer 12051 can perform cooperative control intended to prevent a glare by controlling the headlamp to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 56, an audio speaker 12061, a display section 12062, and an instrument panel 12063 are depicted as the output device. The display section 12062 may, for example, include at least one of an on-board display and a head-up display.

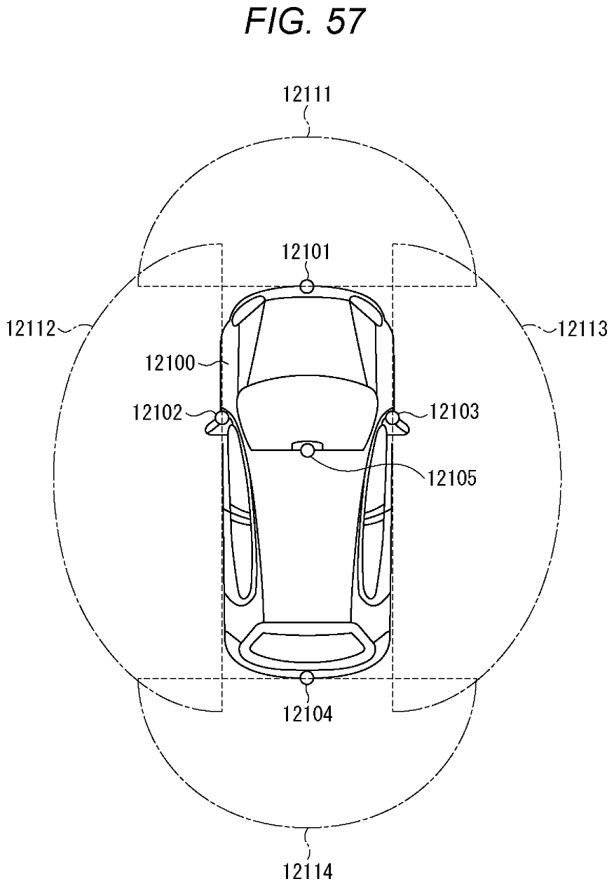

FIG. 57 is a diagram illustrating an example of an installation position of the imaging section 12031.

In FIG. 57, a vehicle 12100 includes imaging sections 12101, 12102, 12103, 12104, and 12105 as the imaging section 12031.

The imaging sections 12101, 12102, 12103, 12104, 12105 are provided, for example, at positions such as a front nose, a side mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102, 12103 provided at the side mirrors obtain mainly images of the sides of the vehicle 12100. The imaging section 12104 provided to the rear bumper or the back door obtains mainly an image of the rear of the vehicle 12100. The forward images obtained by the imaging sections 12101 and 12105 are used mainly to detect a preceding vehicle, a pedestrian, an obstacle, a traffic signal, a traffic sign, a lane, or the like.

Note that FIG. 57 illustrates an example of photographing ranges of the imaging sections 12101 to 12104. An imaging range 12111 represents the imaging range of the imaging section 12101 provided to the front nose.

Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/h). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually.

Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technique according to the present disclosure can be applied to the imaging section 12031 and the like in the configuration described above. Specifically, the imaging device 100 described above can be applied to the imaging section 12031. By applying the technology according to the present disclosure to the imaging section 12031, it is possible to curb deterioration in image quality of a captured image due to ghost light. As a result, a captured image with high image quality can be obtained, and thus, for example, safety and comfort of a driver can be improved.

An embodiment of the present technology is not limited to the above-described embodiment, and various modifications can be made without departing from the scope of the present technology.

The effects described in the present specification are merely examples and are not limited, and effects other than those described in the present specification may be provided.

The present technology can have the following configurations.

(1)

An imaging lens including:
a lens group including six or more lenses including at least one aspherical lens that forms an optical image of an object on an imaging surface curved concavely toward an object side,
in which a final surface that is a surface on an imaging surface side of a final lens that is a lens closest to the imaging surface side in the lens group is a spherical surface or an aspherical surface in which a sign of surface power is not inverted with increasing distance from an optical axis,
a shape of the final surface is a shape that tilts toward the object side with increasing distance from the optical axis, and
when a distance on the optical axis from a vertex on the optical axis of the final surface to a position of a maximum image height of the imaging surface is denoted by BF, and a focal length of the entire imaging lens is denoted by f,
0.1<BF/f<0.3 is satisfied.
   (2)

The imaging lens according to the above (1), in which when a curvature radius of the imaging surface is denoted by Ri and a curvature radius of the final surface is denoted by RL2,
0.5≤ Ri/RL2≤1.5 is satisfied.
   (3)

The imaging lens according to the above (1) or (2), in which
when the maximum image height is denoted by Y, and an overall optical length that is a distance on the optical axis from a foremost surface that is a surface on the object side of a lens closest to the object side in the lens group to the imaging surface is denoted by TTL, Y/TTL>0.7 is satisfied.
   (4)

The imaging lens according to any one of the above (1) to (3), in which
a maximum angle of view is 90 degrees or more and an F value is 2.5 or less.
   (5)

The imaging lens according to according to any one of the above (1) to (4), in which
when a focal length of the entire imaging lens is denoted by f and a focal length of the final lens is denoted by fL,
f/fL<−0.6 is satisfied.
   (6)

The imaging lens according to any one of the above (1) to (5), in which
when a curvature radius of a surface of the final lens on the object side is denoted by RL1 and a curvature radius of the final surface is denoted by RL2,
0.05≤RL1/RL2≤0.3 is satisfied.
   (7)

The imaging lens according to any one of the above (1) to (6), in which
when an exit pupil position of a maximum image height ray is denoted by EXPY and a curvature radius of the imaging surface is denoted by Ri,
0.01≤ EXPY/Ri≤0.45 is satisfied.
   (8)

The imaging lens according to any one of the above (1) to (7), in which
when optical distortion in a case where a half angle of view is 40 degrees is denoted by Dw, and an image height in a case where the half angle of view is 40 degrees is denoted by Yw,
0.001≤|Dw/Yw|≤0.08 is satisfied.
   (9)

The imaging lens according to any one of the above (1) to (8), in which
when an ambient light amount ratio with respect to a center of the imaging surface in a case where a half angle of view is 40 degrees is denoted by RIYw, and a maximum half angle of view is denoted by ω,
1.2≤RIYw/(cos (ω)⁴)≤35 is satisfied.
   (10)

The imaging lens according to any one of the above (1) to (9), in which
when a distance on the optical axis from the final surface to the imaging surface is denoted by fb and the maximum image height is denoted by Y,
9.7≤fb×2Y≤29.4 is satisfied.
   (11)

The imaging lens according to any one of the above (1) to (10), further including:
an aperture stop,
in which, when a curvature radius of the imaging surface is denoted by Ri and a distance on the optical axis from the aperture stop to the imaging surface is denoted by Ts,
−50≤Ri/Ts≤−1.7 is satisfied.
   (12)

The imaging lens according to any one of the above (1) to (11), in which
when a maximum effective radius of a foremost surface that is a surface on the object side of a lens closest to the object side in the lens group is denoted by Hf and a maximum effective radius of the final surface is denoted by Hb,
0.475≤ Hf/Hb≤0.68 is satisfied.
   (13)

The imaging lens according to any one of the above (1) to (12), in which
when a focal length of the entire imaging lens is denoted by f, and a focal length of a lens closest to the object side in the lens group is denoted by fF,
−0.35≤ f/fF≤0.73 is satisfied.
   (14)

The imaging lens according to any one of the above (1) to (13), further including:
an aperture stop,
in which, when a distance on the optical axis from the aperture stop to the imaging surface is denoted by Ts, and an overall optical length that is a distance on the optical axis from a foremost surface that is a surface on the object side of a lens closest to the object side in the lens group to the imaging surface is denoted by TTL,
0.73≤ Ts/TTL≤0.9 is satisfied.
   (15)

The imaging lens according to any one of the above (1) to (14), in which
when optical distortion in a case where an image height is the maximum image height is denoted by DY, optical distortion in a case where a half angle of view is 40 degrees is denoted by Dw, the maximum image height is denoted by Y, and an image height in a case where the half angle of view is 40 degrees is denoted by Yw,
−0.16≤ (DY-Dw)/(Y-Yw)≤0.16 is satisfied.
   (16)

An imaging device including:
an imaging lens that has a lens group including six or more lenses including at least one aspherical lens that forms an optical image of an object on an imaging surface curved concavely toward an object side; and
an imaging element that has the imaging surface and converts the optical image formed on the imaging surface into an electric signal,
in which a final surface that is a surface on an imaging surface side of a final lens that is a lens closest to the imaging surface side in the lens group is a spherical surface or an aspherical surface in which a sign of surface power is not inverted with increasing distance from an optical axis,
a shape of the final surface is a shape that tilts toward the object side with increasing distance from the optical axis, and
when a distance on the optical axis from a vertex on the optical axis of the final surface to a position of a maximum image height of the imaging surface is denoted by BF, and a focal length of the entire imaging lens is denoted by f,
0.1<BF/f<0.3 is satisfied.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 Imaging device
116 Imaging lens
133 Imaging element
133a Imaging surface
161 Lens group
162 Aperture stop
171 Lens
171a Surface
172 to 177 Lens
177b Surface
216 Imaging lens
233a Imaging surface
261 Lens group
262 Aperture stop
271 Lens
271a Surface
272 to 277 Lens
277b Surface
316 Imaging lens
333a Imaging surface
361 Lens group
362 Aperture stop
371 Lens
371a Surface
372 to 377 Lens
377b Surface
416 Imaging lens
433a Imaging surface
461 Lens group
462 Aperture stop
471 Lens
471a Surface
472 to 477 Lens
477b Surface
516 Imaging lens
533a Imaging surface
561 Lens group
562 Aperture stop
571 Lens
571a Surface
572 to 576 Lens
576b Surface
616 Imaging lens
633a Imaging surface
661 Lens group
662 Aperture stop
671 Lens
671a Surface
672 to 677 Lens
677b Surface
716 Imaging lens
733a Imaging surface
761 Lens group
762 Aperture stop
771 Lens
771a Surface
772 to 777 Lens
777b Surface
816 Imaging lens
833a Imaging surface
861 Lens group
862 Aperture stop
871 Lens
871a Surface
872 to 877 Lens
877b Surface

What is claimed is:

1. An imaging lens, comprising:
a lens group including six or more lenses including at least one aspherical lens that forms an optical image of an object on an imaging surface curved concavely toward an object side,
wherein a final surface that is a surface on an imaging surface side of a final lens that is a lens closest to the imaging surface side in the lens group is a spherical surface or an aspherical surface in which a sign of surface power is not inverted with increasing distance from an optical axis,
a shape of the final surface is a shape that tilts toward the object side with increasing distance from the optical axis, and
when a distance on the optical axis from a vertex on the optical axis of the final surface to a position of a maximum image height of the imaging surface is denoted by BF, and a focal length of the entire imaging lens is denoted by f,
0.1<BF/f<0.3 is satisfied.

2. The imaging lens according to claim 1, wherein
when a curvature radius of the imaging surface is denoted by Ri and a curvature radius of the final surface is denoted by RL2,
0.5≤Ri/RL2≤1.5 is satisfied.

3. The imaging lens according to claim 1, wherein
when the maximum image height is denoted by Y, and an overall optical length that is a distance on the optical axis from a foremost surface that is a surface on the object side of a lens closest to the object side in the lens group to the imaging surface is denoted by TTL,
Y/TTL>0.7 is satisfied.

4. The imaging lens according to claim 1, wherein
a maximum angle of view is 90 degrees or more and an F value is 2.5 or less.

5. The imaging lens according to claim 1, wherein
when a focal length of the entire imaging lens is denoted by f and a focal length of the final lens is denoted by fL,
f/fL<−0.6 is satisfied.

6. The imaging lens according to claim 1, wherein
when a curvature radius of a surface of the final lens on the object side is denoted by RL1 and a curvature radius of the final surface is denoted by RL2,
0.05≤RL1/RL2≤0.3 is satisfied.

7. The imaging lens according to claim 1, wherein
when an exit pupil position of a maximum image height ray is denoted by EXPY and a curvature radius of the imaging surface is denoted by Ri,
0.01≤ EXPY/Ri≤0.45 is satisfied.

8. The imaging lens according to claim 1, wherein
when optical distortion in a case where a half angle of view is 40 degrees is denoted by Dw, and an image height in a case where the half angle of view is 40 degrees is denoted by Yw,
0.001≤|Dw/Yw|≤0.08 is satisfied.

9. The imaging lens according to claim 1, wherein
when an ambient light amount ratio with respect to a center of the imaging surface in a case where a half angle of view is 40 degrees is denoted by RIYw, and a maximum half angle of view is denoted by ω,
1.2≤RIYw/(cos (ω)⁴)≤35 is satisfied.

10. The imaging lens according to claim 1, wherein
when a distance on the optical axis from the final surface to the imaging surface is denoted by fb and the maximum image height is denoted by Y,
9.7≤fb×2Y≤29.4 is satisfied.

11. The imaging lens according to claim 1, further comprising:
an aperture stop,
wherein, when a curvature radius of the imaging surface is denoted by Ri and a distance on the optical axis from the aperture stop to the imaging surface is denoted by Ts,
−50≤Ri/Ts≤−1.7 is satisfied.

12. The imaging lens according to claim 1, wherein
when a maximum effective radius of a foremost surface that is a surface on the object side of a lens closest to the object side in the lens group is denoted by Hf and a maximum effective radius of the final surface is denoted by Hb,
0.475≤Hf/Hb≤0.68 is satisfied.

13. The imaging lens according to claim 1, wherein
when a focal length of the entire imaging lens is denoted by f, and a focal length of a lens closest to the object side in the lens group is denoted by fF,
−0.35≤f/fF≤0.73 is satisfied.

14. The imaging lens according to claim 1, further comprising:
an aperture stop,
wherein, when a distance on the optical axis from the aperture stop to the imaging surface is denoted by Ts, and an overall optical length that is a distance on the optical axis from a foremost surface that is a surface on the object side of a lens closest to the object side in the lens group to the imaging surface is denoted by TTL,
0.73≤Ts/TTL≤0.9 is satisfied.

15. The imaging lens according to claim 1, wherein
when optical distortion in a case where an image height is the maximum image height is denoted by DY, optical distortion in a case where a half angle of view is 40 degrees is denoted by Dw, the maximum image height is denoted by Y, and an image height in a case where the half angle of view is 40 degrees is denoted by Yw,
−0.16≤(DY−Dw)/(Y−Yw)≤0.16 is satisfied.

16. An imaging device, comprising:
an imaging lens that has a lens group including six or more lenses including at least one aspherical lens that forms an optical image of an object on an imaging surface curved concavely toward an object side; and
an imaging element that has the imaging surface and converts the optical image formed on the imaging surface into an electric signal,
wherein a final surface that is a surface on an imaging surface side of a final lens that is a lens closest to the imaging surface side in the lens group is a spherical surface or an aspherical surface in which a sign of surface power is not inverted with increasing distance from an optical axis,
a shape of the final surface is a shape that tilts toward the object side with increasing distance from the optical axis, and
when a distance on the optical axis from a vertex on the optical axis of the final surface to a position of a maximum image height of the imaging surface is denoted by BF, and a focal length of the entire imaging lens is denoted by f,
0.1<BF/f<0.3 is satisfied.
